(19) United States
(12) Patent Application Publication
(10) Pub. No.: US 2019/0026786 A1
(43) Pub. Date: Jan. 24, 2019

(54) Platform for Managing Social Media Content Throughout an Organization

(71) Applicant: SOCI, Inc., San Diego, CA (US)

(72) Inventors: Afif George Khoury, San Diego, CA (US); Alo Sarv, San Diego, CA (US)

(21) Appl. No.: 16/040,380

(22) Filed: Jul. 19, 2018

Related U.S. Application Data
(60) Provisional application No. 62/534,608, filed on Jul. 19, 2017.

(51) Int. Cl. G06Q 30/02; G06Q 50/00; H04L 29/08

(52) U.S. Cl. CPC G06Q 30/0271; H04L 67/22; G06Q 30/0277; G06Q 50/01

(57) ABSTRACT

This disclosure includes implementations of methods, apparatuses, systems, and computer program products related to facilitating the evaluation, generation, and distribution of web content. Particularly, this disclosure is directed to implementations of apparatuses, systems, their methods of use, and computer program products related to generating online content, facilitating its efficient distribution, the monitoring and evaluating of its effectiveness, including the scoring of such web content, the reporting of the same, as wells the assessment and maintenance of the online presence of web-based content providers, such as commercial entities, publishers, advertisers, market influencers, and other interested third parties.

### CROSS REFERENCE TO RELATED APPLICATIONS

This application claims priority to and the benefit of U.S. Provisional Application No. 62/534,608 filed on Jul. 19, 2017, titled “Platform for Managing Social Media Content Throughout an Organization”, which is hereby incorporated by reference in its entirety.

### TECHNICAL FIELD

The subject matter described herein relates to the generating and distributing of online, e.g., web, content.

### BACKGROUND

Online content may include emails, websites, messages, blogs, articles, posts, images, animations, and all forms of social media content, as well as other forms of communication posted to internet pages. Such online content often contain information relevant to the commercial activities, social standing, reputation, and/or general interests of companies, organizations, their consumers, advertisers, and other internet influencers and users (herein collectively “Users”).

In many instances the content employed in such online communications by said Users include content that serves the purpose of evaluating one or more of the User's engagement with a commercial entity, and are often made in an online community and/or to one or more other Users. The referenced engagement may be an evaluation that may be made in a plurality of different forms, which engagements may be virtual, e.g., online, or actual, e.g., an in person engagement. As such, this content is often useful to the subject of the evaluation especially when that subject is a commercial entity, market influencer, or other interested party.

In fact, the ability to collect, evaluate, weight, and respond to such content, as well as to communicate with its author, would be very useful to the commercial entity and/or other third parties. This is particularly useful to the commercial entity when they are the one producing and pushing online content, and other users are commenting on and/or evaluating that content, such as online. Particularly, there are many known social media platforms, and on many of these platforms, the performance of online content in generating user interest may be evaluated. Such evaluations may be made in many different forms. For instance, consumer interests may be represented by, for example, “views”, “comments,” “shares,” “retweets”, “favorites,” “ratings,” “rankings,” commentary, blog posts, and the like. This interest, or asserted disinterest, is more particularly useful to a content provider, such as a commercial entity and/or market influencer, when it is published, posted, or otherwise made available, such as online, in response to content pushed by the commercial entity, influencer, or other user.

Another useful factor for consideration in these instances would be an evaluation as to the relative importance of the consumer commentary to the content pushing organization especially with regard to its ability to influence others with respect to their engagement in commercial activity with respect to that content provider. Such evaluations would be particularly useful if based on one or more relevant metrics and/or standardized. For instance, the standardization of such metrics associating user experience with pushed web content, such as with respect to the performance of that content across the internet and an accurate assessment of its ability to influence others would also be useful. Such advancement in the publishing and evaluating of online content would make comparison of similar web content more relevant and therefore more useful. Outside of the devices, systems, and their methods of use as provided herein, such advancements do not exist.

### SUMMARY

This disclosure includes implementations of methods, apparatuses, systems, and computer program products related to facilitating the evaluation, generation, and distribution of web content. Particularly, this disclosure is directed to implementations of apparatuses, systems, their methods of use, and computer program products related to generating online content, facilitating its efficient distribution, the monitoring and evaluating of its effectiveness, including the scoring of such web content, the reporting of the same, as wells the assessment and maintenance of the online presence of web-based content providers, such as commercial entities, publishers, advertisers, market influencers, and other interested third parties.

In various instances, the disclosure is directed to collecting, evaluating, automatically generating, and providing top scoring content to users of the system for their use in generating their own content, such as to increase, or at least maintain, their interest with their target demographics. For instance, in some implementations, the disclosure is directed to providing the top scoring content to users of the system for reference in generating their own original successful online content. In some implementations, the evaluating, e.g., scoring, is provided by empirical algorithms that accurately measure the performance of a web content collection in terms of a specific set of metrics relating to the web content collection, and likewise, such empirical algorithms can be employed in identifying well performing content for the generating of online communication content, which content can then be distributed, such as online.

In one aspect, the present disclosure is directed a method, such as a method that includes retrieving, e.g., in connection with executing a score content generator, a web content collection. In one implementation, the retrieving can include querying a website providing potential web content for collection, and in certain instances, the querying may include a filter and/or restriction where the retrieved web content collection corresponds to the filter and/or restriction. The restriction can include: a keyword filter, a character and/or number filter, a language filter, a text-recognition filter, an image recognition filter, a sentiment filter, a geolocation filter, an antonym filter, a chronological filter, and/or the like. Hence, in certain instances, data representing content, and/or metadata, may be identified and collected, such as from a website.

In some implementations, the collecting, scoring, generating, and distributing of online content is provided by empirical algorithms that may be implemented by an artificial intelligence (A/I) module. For instance, such content collection, generation, and distribution, as well as the evaluation of its effectiveness, may be based on a variety of determined factors and accurate measurements, or the predictions thereof, so as to produce and distribute content determined to be relevant to the recipients thereof, such as based on one or more specific sets of metrics relating to various User calculated preferences.

Consequently, in one aspect, an online content collection, evaluation, communication generation, and distribution system is provided, such as for the purpose of generating one or more online communications for electronic distribution, e.g., over the internet, to one or more target recipients. Such as where the communication is formulated in a manner determined to be of use to the target, and/or may be specifically crafted for the purpose of keeping the content provider relevant with respect to one or more parameters of interest to the target. Particularly, the present system is of particular usefulness when the content generator is a commercial entity offering goods or service for sale, and the target is a potential consumer of those goods and/or services.

The web content collection may include content, data, and metadata associated with a webpage and/or published content items, as a whole, specific content items, and/or may include metadata associated with the web page and/or content collection. The data and/or metadata may include one or more metrics characterizing (i) the webpage, (ii) the content items, and (iii) a portion of the web content collection. Once the data and/or metadata has been collected, the method may include executing a scored content generator, and based on the metrics, a content and/or webpage item performance score may be calculated for each of the viewed webpages and/or retrieved content items. In various instances, each webpage and/or content item performance score may characterize a level of user interaction with the webpage and/or content items. In particular instances, data and/or metadata encapsulating the webpage and/or content item performance scores may be collected and stored in a content library, and/or provided, e.g., to a computing system, such as a server, which server system may then use the content to generate a communication, such as an online advertisement.

Particularly, in one implementation, the scoring and content generator can search stored and/or previously-scored content items, and based on the searching, display the stored content items along with the score associated with each of the content items. Likewise, once displayed, the content, e.g., scored content, can be selected, e.g., by the system or a user of the system, such as based on the score, for use in a communication, which communication can then be generated and distributed by the system to one or more recipients. Accordingly, in certain implementations, the collected and/or retrieved content items may form part of one or more messages, communications, and/or webpages.

In various instances, the method further includes calculating, by at least one data processor executing the scored content generator, a content, a message, a communication, and/or a page performance score, such as based on the content item and/or page performance scores associated with viewed webpages and/or the retrieved content items. Also, data encapsulating the content, messaging, communication, and/or page performance score can be provided to a centralized server of system. The calculating of the performance score can further be based on various different metrics including: a number and/or time of content and page views, viewer sentiment in response to the content, engagement with the content and/or webpage, re-posting or sending of content, the number of times the content is used, the size of the content or page, or a number, frequency, and/or consistency of the content items, such as on the page.

In yet another implementation, where the retrieved content items are collected from one or more sources, such as a webpage and/or social media medium, the method can further include calculating, by at least one data processor executing the scored content generator, a website or social media performance score. The content and/or website performance score can be based on the content item performance scores associated with the individual retrieved content items. Data encapsulating the content and/or website performance score can be provided to the system server. As indicated above, the calculating of the content and/or website performance score can be based on one of a number of different metrics. As indicated, in various instances, the retrieved web content collection can be filtered to include and/or exclude various content items from the collection and/or score. The filtering can be performed by a content filter and/or a web page filter, where the content and/or page filter may include at least one of a keyword filter, a character and/or number filter, a language filter, a sentiment filet, a trending and/or velocity filter, a geolocation filter, an antonym filter, and/or a chronological filter.

In another implementation, a scored webpage and/or content collection can be generated for presentation at a user interface of the system, so as to allow a user of the system to view the scored webpage and/or content, such as for evaluation and selection for generating a message and/or communication. In particular instances, the scored webpage and/or content collection, display, and selection of the same can include one or more content items that received the highest final content item scores, which may be organized and/or selected based on that score. Specifically, the presentation and the selection of the content items can be based on the content item performance scores. Hence, in certain instances, the method may include one or more of loading at least a portion of the collected data into a memory, storing at least a portion of the collected data, providing the data for display, and/or transmitting at least a portion of the data, e.g., via a server of the system.

Accordingly, in various instances, the data and/or metadata encapsulating the scored web content collection, as well as the selected content items themselves can be provided, such as for viewing to one or more servers of the system. In various instances, the selected content items from the collected and/or scored data can be modified, e.g., edited, by a user. For instance, the scored content items can be modified with respect to form and content, and can be selected for use in the generation of a new communication, such as by being integrated into a communication template. In various instances, the content items from the scored web content collection can be provided to one or more servers of the system, such as for distribution and/or publication, e.g., during a time period when, for instance, based on data and/or metadata collected from the system, and/or when a predetermined condition is satisfied. In particular instances, the predetermined condition can be a peak-traffic window for user traffic to one or more web and/or media pages.

In various instances, the calculating can include determining at least one parameter based on the collected data and/or metadata, and/or characteristics or metrics pertaining thereto. The data, metadata, and the identified content can characterize information about the webpage, the content items, and the collection, and for example, can include: line count, page count, memory size, addresses, HTML tags, traffic statistics, views, and/or titles. In particular instances, at least one pre-determined factor can be applied to the at least one parameter, such as a pre-determined factor characterizing a relative weighting of the at least one parameter. Also a raw content item performance score can be calculated, such as based on parameters and pre-determined factors by applying a weighting to the parameters.

In particular instances, the weighting can characterize a content-type dependent scaling of a pre-weighted raw content item performance score. The content item performance score can be calculated by applying a mapping function to the raw content item performance score, where the content item performance score is between a maximum value and a minimum value. The at least one parameter can be a numerical value representing a user sentiment, such as one or more of: a “like,” “dislike,” “tweet,” “retweet,” “favorite,” “+1,” “view,” “unique view,” “fan,” “follow,” “viral posting,” “paid posting,” “storyteller posting,” “click,” “hide,” “comment,” or “share” determined from the second metadata. The parameters can correspond to the web content collection when retrieved from social networking websites.

In various instances, the method includes retrieving, by executing a scored content generator, web content collection. The web content collection may include a first and/or second and/or third data and/or metadata, which may be associated with one or more of the content to be collected, the process of web content collection as a whole, and/or the one or more webpages from which the data is collected. The data and/or metadata may also include one or more metrics, such as where the metrics characterize (i) the pages, (ii) content, and/or (iii) at least a portion of the web content collection process. The method may further include the executing of a scored content generator, and based on the metrics, a page and/or content performance score may be calculated for each of the retrieved pages and/or content. In such an instance, each page and/or content performance score may characterize a level of user interaction with the page and/or the content. Data encapsulating the content and/or page performance scores may be provided to the server system.

In another aspect, the disclosure is directed to a system for generating and distributing online content. Hence, in one embodiment, the system may be configured as a pipeline of one or more processing engines, which processing engines are configured for receiving data in one form, evaluating that data in accordance with one or more relevancy or other factors, so as to generate a result, which result is then passed on to a further processing engine, which further processing engine in turn evaluates the input results data, processes it according to its respective parameters, so as to produce modified results data that then gets transferred further down the chain of processing engines. It is to be understood that although the series of processing engines may be configured to interact collectively so as to produce results, each engine may function independently of the others, such as based on the type of data being collected and/or the use to which it is being put.

Accordingly, in one embodiment, an all in one social media generation and management system is provided. For instance, the system may include one or more servers, such as where the server is configured to include, or is otherwise comprised of a set of processing engines or modules, which processing modules may include one or more of a content and engagement generator, an asset manager, a customer care unit, a reputation management system, a new customer identifier and/or locater, an advertisement generator, and a competitive analysis module. Specifically, in various embodiments, the server may be a cloud based server having a network and/or wireless internet connection so as to communicate with one or more recipient computing devices, which computing device may be a client computer, a recipient computer, a desktop computer, laptop computer, a tablet computing device, or other mobile computing device such as a cellular phone having online or other computing functionalities.

In particular embodiments, the server comprises, or is otherwise associated with, either directly or indirectly, with a content collector, evaluator, and/or generator. For instance, the system may be configured for monitoring online postings, behaviors, and/or other activities so as to determine their relevancy to a given user of the system, such as a commercial entity desiring to gauge consumer interests in their offerings. Particularly, the system may include a suitably configured data-collector, such as a suitably configured application programming interface (API), web-crawler, skimmer, or other internet content collection mechanism, which is configured for identifying content of interest to a user of the system, such as by keyword, text, and/or image recognition data, address data, such as physical address, virtual address, and/or web-address or URL data, metadata, other data of interest to a user, and the like. Data pertinent to a user may be identified by the system, evaluated in accordance with one or more user selectable, or automatically determined, parameters, in accordance with the methods disclosed above, and once identified and determined to be relevant may be collected and stored, such as in a content repository communicably connected to the communications server, from which repository one or more further communications may be generated. Once collected, the data may then be formatted and/or modified, and/or otherwise be made available as communication content, such as a communication asset, which may be selected for inclusion into a communication template for use in the generation of a communication, such as by a suitably configured communications builder of the system.

Accordingly, the server may also include an asset management module, such as including a social media management infrastructure, for instance, for managing the communications within and throughout an organization, as well as communications from the organization to its consumers, followers, or other interested parties. For example, many mid-size to large or super large businesses may be comprised of large business units, may have franchisee relationships, and/or be part of a large conglomerate of business interests, where communications throughout the organization and/or between related parties need to be regulated for consistency and effectiveness of messaging. Such messaging may be generated automatically by a communication generator of the system, or by a user thereof, in which case the system may include a communication builder along with one or more of a communication viewer, content procurer and/or evaluator, a mass publication module, various campaign tools, a communications monitor and/or responder, a workflow manager, a reputation manager, and/or an analytics and reporting module. Once the communication has been generated, the asset manager may include an evaluation engine so as to evaluate the communication content and/or the effectiveness of its messaging; may include a distribution engine, to direct the flow of communication; may include a scheduler module, to schedule when the messaging is to be published, sent, or otherwise distributed; and may include a customer care and/or reputation monitor, so as to monitor the reputation, e.g., the narrative(s), being conducted about one or more users of the system.

As indicated, the one or more servers may include or otherwise be associated with a customer care and/or reputation management module. For instance, the system may include a customer care engine, which customer care engine may be configured for monitoring various online communities, e.g., social media platforms, for comments, posts, or other online publications, which mention the user of interests and/or pertain to the services or goods provided thereby, and once identified the comments, etc. may be collected and fed into a suitably configured evaluator whereby the context and content of the comments can be evaluated, weighed, and/or scored, such as for relevancy to the user and/or their commercial activity, and/or their online presence. In a manner such as this, a leads generator and/or a new customer locator may be provided, which locator may identify online commentators by whose comments, or other social media interactions, and the like, pertain to the goods or services being offered by a user, e.g., a commercial retailer, of the system that when identified can be flagged for engagement by that user, such as for generating a communication, such as a promotion or advertisement or other suitable communication that may be generated and/or sent to the original commentator, such as for the purpose of enhancing the reputation of the commercial retailer and/or for the purposes of engaging in a commercial or other transaction.

A communication and/or advertisement engine may also be included. For instance, in particular embodiments, a content and/or communications generator is provided. Particularly, in one embodiment, a content and/or communication generation system is provided, such as for generating content for incorporation into a communication. The communication can be configured for internal use, such as within an organization, such as to one or more different sub-units or employees within the organization, or it may be configured for delivery to one or more organizations or persons outside of the organization. In various instances, the communication may be configured for being posted or published, such as on or at a social media platform. In certain embodiments, the communication may be an advertisement, such as an advertisement that may be generated automatically, at real-time, and on the fly, such as to promote the commercial interests of the information content generator, e.g., by the commercial entity. In various instances, the content and/or communication generation system may include a communications and/or advertisement generation server.

The server may include or otherwise be in communication with a communications repository, which repository may receive and store content, such as media related content, which content may be used for building transaction related communications. Hence, the repository may further receive and store communications templates, which template may be in any form useful for inter-, intra-, and cross-business communications, as well as communications directed to customers, consumers, market influencers, and/or the general public. Thus, the communication may be in the form of a memorandum, a letter, an email, a post, a comment, a TWEET®, a review, a response to a review, a sentiment, a like, a dislike, an upvote, or other form by which a communication may be sent via a social media platform, and the like.

The server may also include a communications and/or advertisement building engine, which communications builder may be configured for accessing the communications repository and/or for generating a project viewer, which viewer may be configured for allowing a user of the system to build a communication, such as by providing a dashboard by which one or more of the communication template and/or the communications assets may be viewed, selected, configured for integration one into the other, and may include field indicators prompting the user for entering text or images so as to generate the communication. The project viewer may not only be used for creating communications, such as from scratch, e.g., using a template, but it may also be used to edit such communications. Accordingly, the project viewer may include a graphical user interface, e.g., dashboard, which includes controls for effectuating the building of the communication, e.g., for the viewing and selecting of the template, assets, adding in text to text fields, editing one or more of these fields, and the like. Although the project builder may be configured for allowing the manual input of directives for generating a communication, such as via the project viewer, in alternative embodiments, the project builder may be configured for automatically generating a communication, such as via direction from the A/I module of the system, whereby the system itself may select a template of interest and one or more communication assets for incorporation thereby, and/or may generate requisite text to be entered into various text fields of the template.

In particular embodiments, the auto generation configuration of the project builder may be configured for generating real-time communications, such as advertisements, on the fly, such as upon activation of one or more pre-defined triggers, such as upon receipt by the system of a keyword or key text or key image, interest or disinterest sentiment, a geographic indicator, or other online interactor. For instance, the communications building system of the disclosure may include a compiler, such as for effectuating the integration of the communications assets, images, texts, and other data into the respective fields of the template, so as to build the final form of the communication, e.g., advertisement. As such, the compiler may be communicably associated with one or more of the project builder, project viewer, formatter, and/or distributor.

Hence, the communications building system may also include a formatter such as for selecting and formatting the communication, e.g., the online communication, in an electronic format that can be automatically formatted, distributed, rendered, and/or viewed, such as in a distribution format based on one or more of data pertaining to one or more keywords, addresses, and/or other data received by the system, such as directly input from a potential communication recipient and/or based on data skimmed off of that (or other) persons social media or reviewing postings. Likewise, the communications building system may also include a distribution program for performing the delivery, such as for the targeted broadcasting, of the online communication over the Internet to the recipient, or to the social media platform of the recipient such as for posting thereby.

For instance, the distribution may be configured for delivery to one or more specific users, such as within an organization or outside of it, or for general distribution to the public at large, such as by posting on to a social media platform. Further, the distribution may be automatic, for delivery determined so as to be optimized by the system, or it may be determined and/or effectuated by a user of the system. For example, the distribution may be set so it is only effectuated after approval by a user of the system. Specifically, one or more prior authorizations may be elicited and/or required. Particularly, an aspect of the system may be an authorization module, which authorization module may function to send or otherwise deliver a communication to one or more levels within an organization for approval prior to distribution. Further still, as explained in greater detail below, in various embodiments the system may be configured for broadcasting the communication, such as to a plurality of users, all at once or periodically, over certain selected time periods.

In another aspect, the system may include a smart scheduler engine. For instance, once a communication, e.g., an email, post, or advertisement, etc., has been generated, the smart scheduler may then determine when the best time for targeted delivery will be. Such scheduling may be based on one of a number of different parameters, such as a determined peak-time demand, e.g., for the determined market, for the target demographic, for the targeted business opportunity and the like. Additionally, a workflow management module may also be included so as to regulate, modulate, suggest, and/or schedule the various workflow parameters of the system, which parameters may be set up by the system itself, e.g., automatically, such as via the A/I module of the system, or may be set up by a user of the system.

For instance, one or more campaigns, such as a marketing, advertising, reputation, customer enhancement, new customer procurement, social media campaign, or other campaign may be initiated, objectives may be determined, tasks assigned and scheduled, approvals set up, schedules structured, and general workflow assignments may be established so as to effectuate the campaign. Particularly, such campaigns can include one or more of identifying the need for a campaign, identifying the type of the campaign, identifying the goals of the campaign, generating the means and mode of the campaign, generating the campaign details and messaging, building the communications and the target demographics, audience, and timing for the campaign, as well as assigning tasks, scheduling the timing for completion of the campaign, and then implementing the steps for effectuating the campaign.

An additional aspect of the system is an approval module that is configured for allowing a system administrator or business owner to approve a communication before it is sent. For instance, as described above with respect to the scheduler, the system may include an approval engine that is configured for implementing an approval protocol, such as in response from initiation from the scheduler. As indicated, the approval module may be configured so as to reflect the hierarchy of the organization employing the system, such that level of position within the company and/or job function may determine whether and to what extent a proposed outgoing communication may be sent out with or without approval, such as where the higher up in the hierarchy the less review (approvals) is necessary. Likewise, the more related the function of one's job is to controlling communications, the more authority they will have in not needing approval before sending out communications, and the more they will have control over what others seek to communicate.

Particularly, where a large organization has several regional and local franchisees, each of which may be seeking to communicate with regional or local consumers, the system may require approval of these communications by the central headquarters, and/or by a communications unit of the organization and/or advertising agency, and the like, prior to be distributed. Such approvals may be initiated based on rules set by the system, which may require approval of communications being transmitted when certain conditions apply, such as when a communication is being sent too soon or too long in response to a negative review, when certain explicit words are being used, when the communication is in response to a low consumer review, when a business unit is low performing, or when a business unit's reputation falls below a pre-set level, such as below 85%, 80%, 75%, 70%, 65%, 60%, and the like, and in response to other such metrics, as discussed herein. Further, as indicated above, the system may monitor online content, such as social media, including review sites, where comments by consumers are made, the system may flag those comments, collect them, e.g., via a suitably configured API or web-crawler, and present them to the user for response thereby, which once a response has been crafted may then be forwarded to the correct business unit for approval, if required.

For instance, in various instances, the system may be configured for establishing a connection, such as a pipeline, to a social media and/or review website (collectively: “social media”), which can be established through seeking and being granted an invitation for access, and/or receiving a token thereby evidencing access has been granted. However, once granted both data and metadata and other information (collectively “data”), may be collected via this access point with relation to the identified users of interest, such as directly, via use of keywords, etc., and without having to search the posted content indirectly. Likewise, as indicated above, in various instances, such comments, posts, and reviews can be collected, aggregated, and ranked prior to being presented to the user, such as via the dashboard at the user interface, and in such manner the user can scroll through the comments and reviews and thereby selected pre-fabricated or compose new communications to respond thereto, such as by swiping on the display screen. Particularly, the system may be configured to form a pipeline with a social media website, maybe granted login access, and as such may then collect data posted on that website.

Hence, the system may be configured to access a social media pipeline, e.g., via a suitably configured API, on behalf of Company A, and can then have direct access to any information pertaining to that company via the established pipeline. In various instances, the system may establish its own API connection, or may seek access via the company's own API connection. In particular instances, the system, once granted access, with the appropriate authorizations and authentication, may take control of an organizations presence on one or more of these social media webpages, begin collecting data thereon, and may then likewise begin to control the communications thereon with respect to the company.

A further aspect of the disclosure is determining the effectiveness of a communication, such as during an advertisement campaign. Accordingly, the system may include an evaluations and/or analytics module, for instance, where the evaluations module is configured for evaluating the effectiveness of a communication, such as when the communication is being implemented as part of a campaign. As explained below, there are a number of different manners by which such evaluations may be made. These may be determined by audience engagement, customer reviews, consumer commentary, questionnaires, conversions, views, likes, dislikes, up votes, down votes, as well as any other form of user, e.g., consumer, assessments. Particularly, one or more of these characteristics may form a metric by which performance is measured. More particularly, in various embodiments, a communication scorer engine may be included as part of the system, such as where the scorer engine is configured for receiving data, such as data pertaining to a communication, or specific content thereof, for receiving consumer data in response thereto, and evaluating the effectiveness of the communication and/or content, based on the occurrence or non-occurrence of a desired action of the consumer in response to their receipt of the communication.

Accordingly, in one aspect, the disclosure is directed to a method for performing an evaluation of a communication, such as where that evaluation may include the rendering of a score with respect their to, such as with respect to the effectiveness of the communication for eliciting a desired response from the target recipient, e.g., consumer. For example, the method may include one or more sets of processing elements performing one or more of the following steps. Specifically, the steps may include retrieving, e.g., by at least one data processor executing a communications score protocol, e.g., n API or a web-crawler or skimmer, a web content collection.

The web content being collected may include recitation of a keyword, a character, a phrase, texts, such as a business or product name, a business address or URL, a business or product description, a sentiment, a characterization of a consumer relevant to the goods or services of a company, and/or other evaluative communication, and/or may include metadata associated with the web content collection. The data being collected may be with respect to a communication as a whole, a content item thereof, metadata associated therewith, geographical data, and/or other user data associated therewith. Such metadata may include or otherwise be associated with one or more metrics characterizing the communication and/or content items and/or characteristics of the web content collection.

A further step may include calculating, e.g., based on the metrics, a content item performance score for each of the retrieved communication and/or content items that characterize a level of user interaction with the content item. Additionally, data encapsulating the content item performance scores may then be communicated, or otherwise provided to the computing system server. In various embodiments, the retrieved communication may form part or the whole of a single or multiple web pages, and in such an instance, a page performance score may be calculated, such as where the score is based on the content item performance scores associated with one or more of the pages as whole, such as individually or in comparison to one another, or based on various page metrics, such as a number of page views, a page size, a number, frequency and/or consistency of the content items on the page, and/or a number of clicks made per page, time spent on page, and the like.

Further, in certain instances, one or more parameters may be determined from the content or metadata pertaining thereto, and/or one or more pre-determined factors may be applied to the one or more parameters, such as where the pre-determined factor characterizes a relative weighting of the at least one parameter. Hence, the method may include, calculating a raw communication and/or content item performance score that is based on at least one of the parameters and the pre-determined factors, such as by applying the weighting to the parameter, e.g., where the weighting characterizes a content-type dependent scaling of a pre-weighted raw content item performance score, and by calculating the content item performance score, such as by applying a mapping function to the raw content item performance score, such as where the content item performance score may be between a maximum value and a minimum value.

At any instance, during any of these steps and/or processes, the system may generate a report, which report may include one or more evaluations made in relation to one or more metrics of interests. For instance, a report may be generated based on weighing given content, weighing consumer response to content, measuring effectiveness of content, determining trends in consumer sentiment and/or usage, making predictions about consumer activity, trends, and messaging, detailing work flows, scheduling, and/or approvals, reports about lead generation, consumer management, customer care, and the like. Accordingly, as explained below, the system may further include a reports generator for reviewing one or more analytics in relation to one or more metrics of interest, and/or may make one or more predictions about future activity, and as a result thereof may generate a report setting forth the conclusion of the analysis, which report may include one or more suggestions directed to optimizing system functionality, effectiveness, utilization, and/or adoption.

In an interrelated aspect, non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

Computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

These and other aspects will now be described in detail with reference to the following drawings.

FIG. 1 is a diagram illustrating a first iteration of a system for generating an online communication;

FIG. 2 is a diagram illustrating a second iteration of a system for generating an online communication;

FIG. 3 is a diagram illustrating a third iteration of a system for generating an online communication; and

FIG. 4 is a diagram illustrating a fourth iteration of a system for generating an online communication.

### DETAILED DESCRIPTION

This document describes the collection, generation, distribution, and management of online web content. The devices, systems, and methods described herein can be used to collect and generate online web content and communications, for example, advertising, personal or business webpages, blogs, social media posts, etc. The subject matter described herein can be utilized by commercial entities, corporations and companies, service providers, advertisers, publishers, market influencers, and/or other suppliers of web content to produce one or more marketing and/or advertising campaigns, as well as monitoring, managing, defining the efficiency, effectiveness, and workability of the campaign with respect to generating user engagement, thereby accurately determining the cost benefits of the campaign, thus providing guidance for the generation of original web content, such as for the purposes of enhancing customer or follower experience, driving business, and for driving advertising campaigns. Alternatively, web content that is in the public domain, and determined to perform well, can be reproduced, referenced, or otherwise referred to, in the context of promoting or presenting the user's web content.

Particularly, in one aspect, provided herein is an all in one publication and/or social media management system. In certain embodiments, the devices and systems, as well as their use set forth a platform, e.g., a workflow technology platform, that functions in part for the collecting, generating, distributing, monitoring, regulating, and controlling the flow of information, such as within and outside of an organization. Such information may be of any type, such as information pertinent to the running of a business, management of business resources, communications between employees, as well as communications from the business to the marketplace, e.g., its customers.

For instance, such communications may involve a wide variety of types of information, such as based on its contents, sentiments regarding the same, based on conversations being conducted, such as in relationship to a product or service being offered by a business, e.g., over social media, based on a characterization about and/or the reputation of the content provider, e.g., business, based on the generation and/or distribution of one or more advertisements, a report characterizing the same, and the like. The communications to be sent, received, monitored, tracked, collected, and/or analyzed, as disclosed herein below, may be a communication between one or more, or all, of the different departments of an organization, such as of a national brand, which communication may be an internal or external communication, such as between corporate headquarters and all of their different divisions, sub-organizations, local franchisees, and the like, and/or may be a communication between the organization and their customers, or simply between customers, and/or third parties, and the like.

However, prior to the discoveries described herein by the inventors hereof, the flow of such information through an organization and/or to and between customers, remained a difficult problem for many businesses, publishers, advertisers, influencers within the community, and the like. This problem becomes exponentially more complicated with the greater the number of employees and/or divisions within the organization, and/or the greater the number of customers and communications therewith involved. For instance, when the organization is a nation-wide brand having hundreds, thousands, even tens of thousands, or more local franchises, and/or thousands, hundreds of thousands, and/or multiples of millions of customers, the problem becomes simply unmanageable without the advancements provided by the technologies set forth herein.

Particularly, with the advent of various different social media and/or review channels, such as FACEBOOK®, TWITTER®, INSTAGRAM®, FOURSQUARE®, GOOGLE+®, LINKEDIN®, YELP®, TRIP ADVISOR®, and the like, it has become prohibitively complicated for individuals, companies, and their brands to control their messaging downwards through all local communities, across all media channels, and to all of its employees and customers. For example, there are innumerable publishing outlets, including social media pipelines, for posting online content, including those listed above, as well as: online commentaries, news reports, blogs, content provided by individual and/or commercial webpages, etc. all of which can deliver, either individually or in combination, useful content, which content can be collected, organized, aggregated, stored, analyzed, evaluated, and/or scored in accordance with the systems and methods disclosed herein.

As used in this application, web content collection can be considered to be made up of various wed pages and portions thereof, including data fields and images, where each of the pages and/or content containers thereof include one or more content items. Such pages can refer to web pages, groups of web pages, blogs, FACEBOOK®, INSTAGRAM®, SNAPCHAT®, or other social media or review website pages, and/or may include any form of aggregated postings of internet content, RSS feeds, etc. As used in this application, content items can refer to, for example, characters, texts, images, PDFs, JPEGS, GIFS, animations, video, sounds, blog postings, etc. Content items can also be social media posts, for example, FACEBOOK® posts, TWITTER® “tweets”, GOOGLE+® messages, LINKEDIN® messages, PINTEREST® “pins”, INSTAGRAM® posts, etc. as well as comments, reviews thereof, sentiments, or other communications with respect thereto, etc.

It is to be noted that 85% of consumer engagement via the web occurs through such social media pipelines at this local level. Hence, to the extent that local or nationwide brands are employing online resources, such as social media, to engage their consumer base, such engagement may occur at the local or national level. In either instance, the content provider, e.g., business, is typically only really engaging 15% of their consumer base, and more typically, doing nothing to address and/or gain new consumers via use of one or more of these social media and/or review pipelines and/other online publishing avenues.

This is understandable given the complexity involved in controlling such messaging, which makes it very difficult for individual brands to represent themselves as a cohesive, centralized, holistic organization. For example, where a given individual or company has a centralized location serving a single market, it is difficult for that individual or company to present a single, cohesive message to its customers across all the various different review, commentary and social media tools (collectively social media) that are available for conveying the individual's or company's messaging. Specifically, the messaging conveyed by employing one medium, such as FACEBOOK® should be consistent with the messaging conveyed by using other mediums, such as TWITTER®, ETSY®, LINKEDIN®, and the like, this is important in order for the brand's overall messaging to be consistent.

In such instances, the individuals and brands seeking to keep their messaging consistent often employ a variety of employees and/or outside agencies whose job it is to control their messaging across these various messaging media. However, where the organization includes a plurality of locations within a community, and/or several locations within a state, or even a nation or worldwide series of locations, e.g., local franchises serving several different communities, each location will need to control its own local social media relations, and the central brand itself will need to control its messaging on the community, state, and/or nation or worldwide scale. This is necessary, because if a given location does not take ownership of any particular messaging medium, it leaves an opening for some other entity to gain access to that medium thereby allowing for messaging to be put forth that may not be representative of the local company and/or the larger, e.g., national, brand.

Particularly, every location serving a given community will need to control its own FACEBOOK® page, its own TWITTER® account, and so forth, which for nation and/or worldwide companies can amount to tens of thousands to hundreds of thousands of pages and accounts, which get visited and/or viewed daily by consumers. What this means is that for a national brand to have consistent messaging, it must not only control its national communications, it must also monitor and control its local, e.g., franchisee, communications. The costs of such control, even if feasible, which it is not, would be astronomical.

For example, a local brand representative, such as a franchise, or employee thereof, may receive a negative review from a customer, which may be posted on a given host domain. That review may sit there as a negative mark on that medium. In fact, where the local franchisee has not taken control of the posting medium, such as a local FACEBOOK® page, that negative review may be the only communication on that page. For instance, many of the popular social media sites will automatically identify a business and generate a web-presence based on the known information for the local business, such as without that local business owner's knowledge. If this happens, anyone can then take control of the web-page, and post virtually any information about the business they want. Such postings often include derogatory comments about the business and/or posting unflattering photos thereof, which may then be transmitted all over the world substantially instantaneously in such a manner that tens of millions of potential consumers may read the derogatory comments and see the unflattering images, e.g., especially if the post goes “viral”.

Accordingly, if a local business, or other such entity, does not control their social media presence and/or install the appropriate firewalls and permissions, it leaves a door open for someone else to lay claim to the account and thereby controlling the messaging throughout these pipelines. Specifically, because these social mediums want businesses to use their media for advertising purposes, they make it easy for a user to create an account, which makes it easy for business owners to establish a presence in the medium, but also makes it easier for a non-business owner to attempt to take control of that medium, and thereby post negative comments about the individual or business.

Consequently, it is necessary for individuals and companies of all sizes to claim and take control of their social media pipelines, lest someone else take control by posting something about them, such as negative reviews. However, merely claiming the various social media pipelines is not enough, they must also begin to manage and control the messaging on such media. Particularly, once a web presence is established in a given medium, it remains open for others in the community to post on that web page, positive or negative comments, based on their personal experiences or intentions. Hence, not only must a company lay claim to their social mediums, they must also assert control of the messaging of those mediums. More particularly, such ownership is important because in various mediums, once a review has been posted, it may be sent to an entire community of potential consumers, which may then further comment, forward, like, dislike, up or down vote the original post. Hence, without the company controlling such messaging, a wide variety of potential customers may be given a negative impression of the brand.

Therefore, companies of every size need to interact with their local and/or global communities, consistently, cohesively, and often. Particularly, where the home office, e.g., of a national brand, may control the messaging of its global social media pages, it must now also control the messaging of all of its franchisees which may amount to tens of thousands of pages for each social media pipeline, e.g., FACEBOOK®, TWITTER®, INSTAGRAM®, FLICKER®, FOURSQUARE®, PINTEREST®, LINKEDIN®, YELP®, TRIP ADVISOR®, ETSY®, and the like. Hence, a single company may have upwards of 10-20,000 or more reviews a day that it must respond to with a consistent message, which reviews if ignored may cause significant problems to the brand's reputation.

Specifically, where a company used to engage the public on a national level, such as through television advertising, a majority of company/consumer engagements, via social media for businesses, now occurs at the local page level. In fact, a large majority of customers indicate that they are being swayed in their purchase decisions by reviews posted on social media and/or are responsive to the company's messaging thereon. Consequently, the various social media platforms cannot be ignored.

Particularly, these various social media pipelines allow consumers to see and evaluate everything from what is posted, to how long it takes for the company to respond, to what kind of campaigns are being run locally and nationally, what specials and/or coupons are being advertised, what images are being employed. All of these factors regarding the company's online presence will all be evaluated by the consumer, giving them an impression as to what that particular company, e.g., local franchisee, as well as the franchise itself, is all about. All of these communication pipelines create an extremely unique and advantageous means for communicating with the market and reaching its consumers, but consequently creates extremely complicated communications, workflow, approval, and management challenges when trying to convey a consistent, uniform communication and messaging.

For instance, a national organization, such as national insurance or real estate company, may have a national or global presence, which on a nationwide scale may employ upwards of 35,000 agents, each of which may have their own social media pages representing themselves and the brand. The same is true for car dealerships, property management groups, information aggregators, hospitals, dentist, law firms, fast food groups, supermarkets, clothiers, and the like, such as any business or organization that is capable of being scaled and/or distributed on a larger scale, such as to various franchisees. Controlling the messaging throughout such a distributed organization is practically impossible.

Accordingly, it is becoming increasingly necessary for local, statewide, national, and/or global business owners and brands to take ownership of the various social media pipelines, and to control the messaging sent forth across each of these pipelines. Typical solutions for these and other such problems are for the corporate office to claim all of the relevant social media pages, and to then do nothing with them, e.g., leaving them completely blank, or to manage all social media of the franchisees by simply posting on their global boards, and pushing the exact same information down to all other boards of their local franchisees, such that the franchisee only post what the corporate office post.

A problem with this strategy is that it does not allow for a local franchisee to be competitive, with respect to that social medium, in the local market, and/or to cater messaging to its local consumers. Particularly, various of these social media pipelines are constructed such that the more active an owner of the site is, the more present their listing will be on that medium. For instance, the more post a site owner makes, the more the owner is responsive to consumers in that media via such posts, the more varied the owner engages the consumer using the various messaging methodologies provided by that medium, the higher up the business owner's listing will be presented when a consumer enters a search query within that medium looking for goods and services provided for by businesses within the searched category.

For example, when engaging the search function on an online media site, such as FACEBOOK®, a consumer looking to find a location of a nearby business offering a good or service, e.g., a pizza place, may enter the word “Pizza,” and all pizza places within a certain geographical region having a presence on that social medium will be presented as a list of potential providers for the searcher to review. Hence, the business providers who have been the most active on that medium will be presented first and/or higher up on the displayed list of providers.

In such an instance, an active local mom-and-pop shop, who has a very active presence on social media, may be placed higher up on a returned list of providers than a national brand that is not so active. In a manner such as this, a local business can out compete a national brand using that social medium by engaging the medium more, and being positioned higher on a search results list, thereby, resulting in more traffic being directed to the local brand over the national brand, simply because the local brand more effectively employs social media than the national brand.

Another typical solution for this problem is to employ one or more brand messaging professionals to handle the communications within the company as well as with the general public. For instance, depending on the size and resources of the company, a whole department, including several employees, may be necessary to control such messaging. In various instances, outside ad agencies may also be employed for generating and/or managing messaging for company or brand. This, however, becomes prohibitively expensive the larger and the more far reaching the brand becomes, such as where several employees and/or several departments are necessary to adequately controlling the messaging of the organization. And, it is only getting more complicated, and more difficult. For example, only a few years ago there were only 4 million business pages on FACEBOOK® presently there are over 65 million such business pages, with millions of dollars being spent on managing such social media pipelines.

What is provided herein, therefore, is a simple to use, intuitive, communications generator and workflow manager that is capable of being scaled to the size of the business, which manager is capable of handling customer communication and engagement from one platform across any and all social media pipelines, such as for online, e.g., digital, marketing, consumer engagement, and exchange. Particularly, the devices, systems, and methods of the present disclosure, is specifically configured to meet these and other such long felt needs in the art, in a manner, such that a single user can leverage the system platform and service a plurality of different companies, e.g., horizontal leverage, and can also manage a wide variety of the communications tasks for each company, e.g., vertical leverage. More particularly, in various instances, the devices, systems, and methods disclosed herein are useful for aggregating the pipelines of various social media channels for a consistent, centralized communications distribution in a single, intuitive platform.

Accordingly, in one aspect, provided herein is an all in one online, e.g., social media, and communications management system. The devices, systems, and their methods of use disclosed herein set forth a platform, e.g., a workflow technology platform, that functions in part for the collecting, monitoring, regulating, and controlling of the flow of information. An advantage of the present devices, systems, and methods presented herein is that they are configured for presenting an easy to use, intuitive platform by which one or more, e.g., all, of the various social media platforms may be engaged, managed, and controlled, such as by a single dashboard representation, e.g., at a graphical user interface.

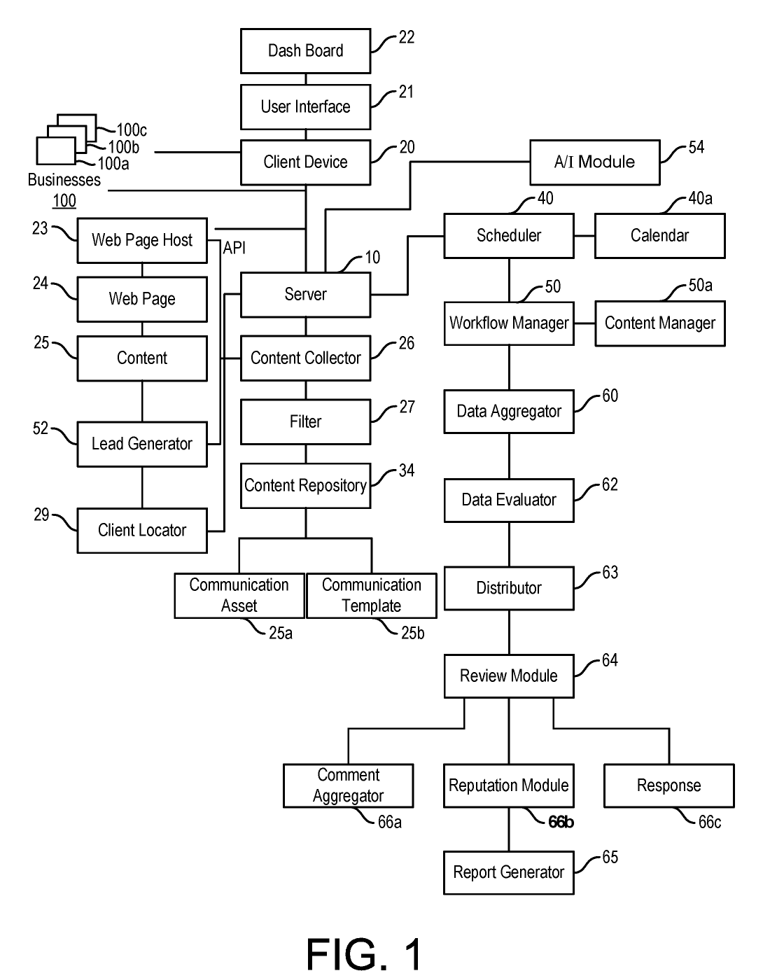

Specifically, as can be seen with respect to FIG. 1, the devices, systems, and methods disclosed herein present a graphical user interface 21, such as a dashboard 22, that has been configured to aggregate one or more social media pipelines 23, as well as logins thereto, over one or more businesses 100, which businesses may be separated geographically from one another, whereby the various social media pipelines 23 may be logged into or otherwise accessed and engaged with by a user, such as a communications director, merely logging into and/or engaging with the dashboard 22.

Accordingly, presented herein are intuitive tools that allow a user, through a single platform medium, e.g., a dashboard 22, to engage with and post on a selection of social media pipelines 23, all at the same, or separate designated, times. More specifically, the dashboard 22 herein presented, includes a list of user operable tools, such as a content or communications generator 32 having a communications viewer 32a and/or a communications builder 32b, which allow a user to view, generate, edit, and cater its communications and messaging 250, which communications 250 can then be published upon a wide variety of user selectable social media pipelines 23, including but not limited to FACEBOOK®, TWITTER®, INSTAGRAM®, FOUR SQUARE®, FLCKR®, PINTEREST®, LINKIEDIN®, YELP®, TRIP ADVISOR®, ETSY®, and the like. In various instances, such tools may also include one or more of a content manager 30, scheduler 40, a tasks and/or workflow manager 50, lead generator 52, scalable set of permissions, traffic monitor and/or modulator 54, data aggregator 60 and evaluator 62, review module 64, a comments aggregator 66, reputation 68, and response dashboard 69, an analytics and report generator 70, and other like tool sets.

In various embodiments, the tools set forth herein may be employed to not only post user generated content 25, but may be engaged with in such a manner so as to actually help the user generate a communication 250 out of that content 25. In various instances, the system 1 may even be configured for automatically generating and/or posting the communication 250.

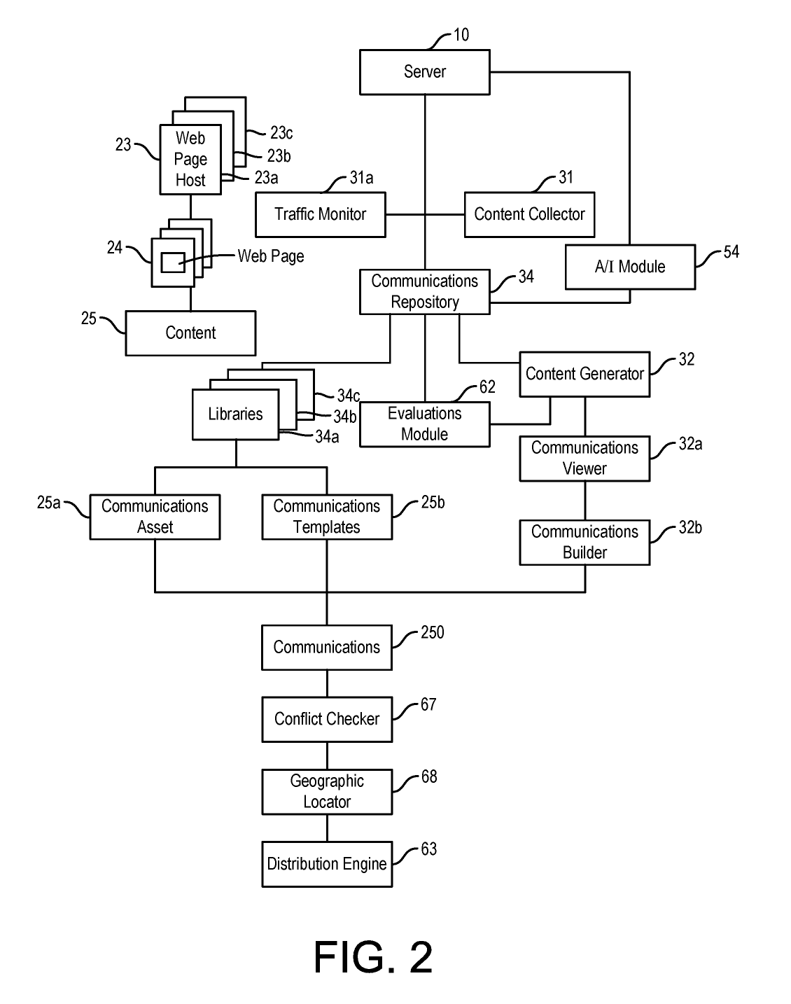

Particularly, in one aspect, as can be seen with respect to FIG. 2, the system 1 may include a content collector 31, a content builder 32, and a content evaluator 62 that are configured for working together to collect and evaluate data that may be used for generating messaging 250. The content builder or generator 32 may be associated with a communications repository 34, which repository may include a library of data storage files 34a, 34b, 34c, etc. for storing communication content 25, such as one or more communication assets 25a and/or one or more communication templates 25b together which may be integrated one into the other so as to generate a communication 250.

For instance, in these, and other such manners, user content 25 may be collected, aggregated, edited, and/or otherwise catered into a communication 250, which communication can then be distributed, such as by being targeted to a specific market segment. Specifically, once a communication 250 has been produced by the system it can then be sent from, and/or be managed by a centralized hub 1, via the cloud, to one or more, e.g., all, of the associated media pipelines of a business or a series of businesses, e.g., throughout all of the social media pipelines 23 of all the businesses of a business organization 100.

In certain embodiments, the platform system 1 may be adapted for searching within and outside of the system for content 25, which has either previously been generated and/or used within the system 1, or is capable of being generated and/or used within the system 1. For example, user generated data 25a, 25b may be used to produce messaging 250. Alternatively, outside data 25, e.g., that has previously been generated outside of the system, may be searched, collected, evaluated, and be re-formatted for use within the system 1, such as for messaging and/or advertisement 250 generation. In either instance, the system may include a communications repository 34 for storing communication data 25, which data may be employed in developing the messaging 250 of a company 100, such as in the engagement of an advertisement campaign and/or simply for consumer notification and/or education.

Specifically, once generated and/or otherwise received, potentially useable content 25 may be subjected to a formalized evaluator module 62 that is configured for pulling content from the communications repository 34, e.g., previously generated data or data collected from the world-wide-web, and evaluating its content for usefulness in generating a communication 250 for a user of the system 1. Such content 25 may be evaluated against a variety of different metrics, such as those applicable for use within the system, in accordance with one or more user selectable parameters, and/or system determined indicators set forth herein. For instance, content and/or messaging 25 may be evaluated based on its ability to generate one or more responses in a target demographic, such as to generate positive sentiments, likes, upvotes, posts, re-posts, tweets, re-tweets, clicks, conversions, sales, engagement, trends, velocity, and the like.

Particularly, while the performance of web content is typically difficult to quantify, some platforms provide metrics associated with their web content that allow users to self-report their level of engagement, for example “likes,” “dislikes,” etc. Such performance evaluation is useful because it can reflect more objective measures, such as reach, engagement, comments, shares, etc. of pages and/or individual pieces of web content. It can be assumed that the general level of user engagement is proportional to the appropriate metric, however an accurate representation often defies simple mathematical relationships.

The success of this web content and/or the pertinent websites in generating user interest can depend on many factors such as the type of site the web content comes from, the user base, how the web content is used on a website, and the like. Accordingly, presented herein is an empirical formulation representing the performance of the web content and its collection that may be based on the metrics associated with the web content collection. Such a formulation can be presented in the form of scores assigned to selected web content as well as providing top scoring examples of web content to users.

Accordingly, in various instances, the communications 250 of a company 100 may be controlled by a web-based server system 1. Such communications may include communications that are meant to be communicated within the same company, or between different companies, and/or may include the communications between a company and the public market. In various instances, the web-based communications system 1 may be accessed and employed by different companies, where both companies are using the system. In such an instance, the communications 250 of two more companies 100 may be evaluated one against the other.

For example, company A may receive 10 engagements and pay $100 for each, while company B may receive 100 engagements and pay $10 for each. The total spend for each company, e.g., the performance ratio, is the same. The question then becomes one of conversion, which of the engagements lead to actual conversions into purchases, and what is the value achieved, e.g., collectively, for those purchases. The system, therefore, can be configured for evaluating both content 25 and company 100 performance, along various metrics, and determining which are more effective for the determined purposes.

Once evaluated the content 25 may be stored, or re-stored, in the repository 34, such as based on the strength of the evaluation. For instance, content to be stored in the repository 34 may be stored in a library of files or folders, 34a, 34b, 34c, such as based on the weighted strength of the content for use in the creation of communications 250, which weighted score may be determined by the evaluator module 62. These files 34a, 34b, 34c may be filled and organized in accordance with a number of different principles, such as based on strength and/or particulars of content and type, date/time used, user engagement, velocity, region specifics, user sentiment, created communications vs. mere suggested content to be built into a communication, approved vs. dis-approved or to-be-approved folders, and the like.

As explained below, these folders 34a, 34b, 34c may be made accessible throughout the organization 100, based on approvals, job function, regional location, status within the organization, and the like. For instance, the system 1 may include a review and approvals module 64 for allowing the review and approval of communication content 25 as well as the resulting communications 250 generated out of that content 25. In this manner, those down the organizational chain looking for communications 250 and content 25 can access files of the appropriate level and employ the content 25 therein for their communications protocols, knowing it has been pre-approved for the given region and/or purposes. Likewise, anything created and used, e.g., as a communication and/or advertisement 250, can be annotated and saved, with a description of its use and/or effectiveness, in the library 34. Further, any content 25 used or to be used may be tagged and/or flagged based on its pertinent categories of use and effectiveness, so as to make the content 25 easily searchable, reviewable, and/or selected for use, such as via a drag and drop menu, and/or may be made easily shareable.

As indicated above, in various embodiments, the web content collection may be implemented by a suitably configured content collector 31, which content collector 31 is adapted for searching online content, such as via the World Wide Web, identifying one or more webpages 24 and/or posts 23, and further identifying content of interest 25 to be retrieved therefrom. Accordingly, the web collection may be made up of pages, such as where each of the pages may have one or more content items 25. These pages can refer to web pages, groups of web pages, blogs, FACEBOOK®, TWITTER® or other social media site pages, aggregated postings of internet content, RSS feeds, etc.

Likewise, the content items 25 can refer to, for example, characters, text, images, animations, video, sounds, recordings, blog postings, etc. Content items can also be social media posts, for example, FACEBOOK® posts, TWITTER® “tweets”, GOOGLE PLUS® messages, LINKEDIN® messages, PINTEREST® “pins”, INSTAGRAM® posts, etc. as well as comments, reviews, etc. In particular embodiments, the evaluation generator 62 can facilitate a search, via the library 34, of previously scored pages and the various content items stored in the communications repository 34 or other connected computing systems. Based on the searching, a portion of the collected, stored, and/or previously-scored content items can be displayed, e.g., via a generated communication viewer 32a, such for use in generating an online communication 250. Accordingly, the search performed in connection with the content collection engine can return, for example, full or partial posts or other scored web content or pages, characters, keywords, images, animations, excerpts, etc. as well as the score associated with the returned search items.

Consequently, in various embodiments, the web content collection may be made up of pages, such as where each of the pages may have one or more content items. The pages can refer to web pages, groups of web pages, blogs, FACEBOOK®, TWITTER® or other social media site pages, aggregated postings of internet content, RSS feeds, etc. Likewise, the content items can refer to, for example, characters, text, images, animations, video, sounds, recordings, blog postings, etc. Content items can also be social media posts, for example, FACEBOOK® posts, TWITTER® “tweets”, GOOGLE PLUS® messages, LINKEDIN® messages, PINTEREST® “pins”, INSTAGRAM® posts, etc. as well as comments, reviews, etc. In particular embodiments, the evaluation generator 62 can facilitate a search, via the library 34, of previously scored pages and the various content items stored in the communications repository 34 or other connected computing systems. Based on the searching, a portion of the stored and/or previously-scored content items can be displayed, e.g., via a generated communication viewer 32a.

The search can return, for example, full or partial posts or other scored web content or pages, characters, keywords, images, animations, excerpts, etc. as well as the score associated with the returned search items. In some implementations, web content may not be stored by the system described herein, for example, the system may only retain listings, descriptions, or links to successful web content. The deliberate avoidance of archiving the web content can be performed to comply with the privacy or usage policies of the web content providers. In some instances, in identifying successful web content, a large body of data can be searched and/or collected. For instance, in certain embodiments, to retrieve a web content collection, such as for analysis, the content generator 32 can query providers of web content 23 using platform specific API's, a web-crawler, skimmer, or other mechanism of data collection 31 so as to obtain pages, content items, feeds, streams, etc. Other forms of browsing, crawling, or data-mining can also be used to obtain or analyze pages or content items.

Particularly, in various embodiments, once collected, the evaluator module 62 may then evaluate that data in accordance with the selected parameters to determine its usability as content 25 for generating messaging that may be employed by the system 1 so as to reach consumers and/or potential customers, such as via one or more social media platforms. Such evaluation may include one or more of reviewing content 25 for relevance, e.g., based on consumer published or surveyed response thereto; evaluating the content 25 for suitability, e.g., based on known or identified features of the potential targets; evaluating for effectiveness, e.g., based on correspondence with other effective messaging of the class or type; evaluating based on sentiment or velocity, such as based on voting, retweets, likes, what is trending, and the like; and/or evaluated on a wide host of other parameters. In any of these instances, the content may be evaluated and scored, and based on that score the content 25 can be tagged or otherwise be flagged for later presentation and/or use as messaging and/or communications content.

More particularly, the system 1 may include an evaluation processing engine 62, which processing engine may be associated with the content generator 32, and may be configured for evaluating the collected content, ranking the content, e.g., based on a determined relevance to the user, e.g., so as to determine what content has already been generated, what content should be collected, what communications have been generated and/or distributed, what communications should be generated, and/or how useful that communication and/or the content thereof may be to the organization, its associates, the business owner, their customers, and/or their followers.

For instance, various social factors may be employed so as to determine various relevant factors that may be collected, analyzed, and/or otherwise considered to determine an appropriate weighting of identifiable, relevant content factors, e.g., for the generation of a communication and/or for the generation of a score for the communication and/or its content, such as a social score matrix. For example, comments or other posts made by online users, such as users of social media, may be identified, collected, considered for relevance factors, evaluated, and used to set the parameters of one or more filters of the system for appropriately collecting and weighting collected data.

Other data may also be collected and considered, such as metadata, which may be obtained from collected information, e.g., via a suitably configured API, and used in the weighting mechanism for determining a relevancy score. For instance, in certain embodiments, a first and a second metadata may be collected and analyzed, such as for scoring collected content 25, so as to facilitate its use for building new communications 100, such as based on its content score. The first metadata and the second metadata can characterize information about the web content collection, the content items, as well as the pages from which the content was collected, for example by describing: line count, page count, memory size, addresses, HTML tags, traffic statistics, views, and/or titles. Such content may be collected from innumerable platforms for web content collection. For example, FACEBOOK, TWITTER, LINKEDIN, GOOGLE PLUS, PINTEREST, INSTAGRAM, blogs, individual and/or commercial webpages, etc. can provide, either individually or in combination, a web content collection to be analyzed and scored, such as by the evaluator 62.

For instance, the system may include an evaluator module 62, where the evaluator can be configured for determining high score webpages and/or content 25 thereof. Particularly, the evaluating module 62 may include one or more processing engines configured for applying one or more scoring algorithms to provide a raw score for each of the pages and/or content items retrieved by the web content collection. In certain instances, to determine the highest scoring content items as quickly as possible, a subset of the web content collection items 25 can be ordered before or after scoring the subset of the web content collection. The ordering can be based on, for example, a fan base, metadata, a relevance score, website viewership, create date, keyword, sentiment, category, or any other metrics believed to be a good indicator of high scoring web content.

Metrics associated with a webpage, e.g., a webpage from which a content item was derived, may include, for example, size of the fan base or viewership, identity of the page, etc. Other metrics can include, for example, the use or lack of certain characters in the text (e.g. question marks, exclamation points, etc.) or the use of various media types (e.g. images, animations, patterns, videos, etc.). Such metrics can be used to determine various parameters for use with one or more scoring algorithms employed herein, when calculating a score for a content item 25. Accordingly, in determining a content score the data to be collected may be considered along with one or more metrics characterizing that data. For example, one or more metrics can be used to determine parameters for the scoring algorithms, such as data and metadata that may be used by the scoring engine 62 when calculating a score for a content item 25. Parameters can be a character, a numerical value, or a symbol representing at least one or more of, for example, a “like,” “dislike,” “tweet,” “retweet,” “favorite,” “+1,” “view,” “unique view,” “fan,” “follow,” “viral posting,” “paid posting,” “storyteller posting,” “click,” “hide,” “comment,” or “share” determined from the second metadata.

In various instances, a determined content score can characterize the past performance of the content items 25 in the subset of the retrieved web content collection. To provide a basis for calculating a score for each of the content items 25 of a content collection, the scoring engine 62 can utilize metadata associated with the content item 25 to provide a metric relating to past performance, and/or a metric relating to a predicted future performance, such as a result determined by the A/I module. Other metrics associated with the webpage and/or content items 25 may include, for example, public sentiment, including likes, forwards, post, re-posts, re-tweets, upvotes, positive comments, and the like.

Web content 25 can include many types of metrics that reflect present or past performance. However, the different metrics therefore do not necessarily reflect the same degree of present or past performance. For example, simply “liking” the message/content is easier than writing a comment, so for the messages/content that have mostly comments, just comparing the number of likes of one type of message/content to the number of comments on another type of message/content is not necessarily an accurate comparison. Accordingly, appropriate factors can be applied to the parameters representing the metrics in order to adjust the relative weighting between each of the parameters. Furthermore, the factors can depend on the size and makeup of the user base. For example, if a known user base is more likely to simply “like” something than to write a comment about it, the factor associated with the “like” parameter can be adjusted to reflect this preference. The overall weighting can be determined and applied to the final score. However, in order for the raw score to be compared across platforms and industries, the weighting can be used to bring the content items 25 having inherently different features, for example, traffic, user demographics, etc. into alignment so that they may be accurately normalized and compared to one another.

In some implementations, web content 25 may or may not be stored in a suitably configured repository 34, by the system described herein. For example, in one embodiment, the system 1 may collect and store the identified web content 25, and in another embodiment the system 1 may only retain listings, descriptions, or links to successful web content 25. In various instances, the deliberate avoidance of archiving the web content 25 can be performed to comply with the privacy or usage policies of the web content providers 23. In some instances, in identifying successful web content 25, a large body of data can be searched and/or collected. For instance, in certain embodiments, to retrieve a web content collection, such as for analysis, the content generator 32 can query providers of web content 23 using platform specific API's, a web-crawler, skimmer, or other mechanism of data collection 31 so as to obtain pages, content items, feeds, streams, etc. Other forms of browsing, crawling, or data-mining can also be used to obtain or analyze pages or content items.

There is a vast amount of web content 25 available to be collected, characterized, and scored. Accordingly, the system 1, via the content collector 31, can be configured for sending out queries to online content providers 23, such as FACEBOOK®, TWITTER®, etc. so as to retrieve content 25 therefrom, which content 25 can be whole pages or portions thereof. However, given the vast amount of web content 25 available to be collected, the search query may include one or more restrictions or filters to limit the results of the retrieved web content collection. In particular instances, the retrieved web content collection can correspond to restrictions such as, for example, a keyword restriction, a character and/or number restriction, a language restriction, a geolocation restriction, an antonym restriction, or a chronological restriction. For instance, the filter and/or restrictions can allow the web content collection host site to filter what is returned, for example “return web pages updated within the past month”, or return responses according to a keyword specified in the query, and the like.

Particularly, in various instances, the query can retrieve one or more items from one or more web-pages such as page title, page description, page content, hyperlinks, metadata, etc. to determine what pages or content items to collect and return. Also, the filter submitted via the API or content collector 31 can be applied so as to target identified elements of collection, such as those items that have previously been identified as having high value. The content collection query can be always active, where the content generator is actively searching out for content, e.g., from new and/or specified sources, or sent out at particular times, e.g., by the content generator, or may be passive, where the collection is continuously going on and thereby passively receiving pages or content items, such as from previously authorized pages.

The received web content collection can include content items, pages, postings, blog entries, images, audio, animations, videos, or any other content resulting from the query. The web content collection can also include metadata relating to the pages or content in the web content collection, for example, number of fans, posting dates, “likes,” “comments,” “shares,” etc. Once the web content collection is received, e.g., by the content generator 32, the web content collection can be further filtered by the content generator 32 so as to focus the collection on particular, previously identified content. In various instances, the filtering can be applied either before scoring, after scoring, or both.

For instance, performing a pre-filtering of the identified and/or retrieved (or to be retrieved) web content collection, it can be more likely that web content ultimately determined to be valuable will be identified and/or collected faster. The pre-filtering can be based on viewership, “hits,” “likes,” “shares,” or any sort of metadata or metrics included with the pages or the content items. In certain instances, a filter can be applied to the received web content, such as to exclude one or more of the content items from the web content collection. The filtering can be performed by, for example, a page filter and/or a web content filter or other suitably configured filter. Any number and combination of filters can be applied to the web content collection. These filters can include, for example, a keyword filter, a character number filter, a language filter, a geolocation filter, an antonym filter, a chronological filter, etc.

For example, in one embodiment, the filter may be a keyword filter for performing key word filtering. Particularly, keyword filtering may be used in addition to the content collector so as to return only those pages and/or or the content items containing or relating to the selected keywords. More particularly, the content collector 31 may scour the web for content, while applying the keyword filter in doing so, so as to identify webpages and/or content 25 for collection. Accordingly, in one use model, the web page filter may be employed so as to return those pages containing references to the keyword. Likewise, the content item filter can than be employed so as to filter those pages to retrieve only the content items that refer to the keyword, while discarding content items that do not.

Additional filters can be applied to the pages or the content items, for example, filtering by language, in order to include only particular languages, such as English or Spanish. Filtering can be by location, for example, country, region, city, zip code, or within a certain distance of any of the foregoing. Depending on the number of filters, the query parameters, etc. the querying and filtering of received web content 25 can continue until a specified number of results have been found. At this point, the subset of web content collection can represent ordered, relevant content, in specified language(s), etc. Once filtered and ordered, the resulting subset of the retrieved web content 25 can be further analyzed and scored as useful.

For example, when considering the response of the public to a FACEBOOK® or TWITTER® posts made by a user of the system, and the FACEBOOK® likes or TWITTER® tweets, which results because of those posts, the respective posts and the medium by which they were made can be evaluated along a number of metrics. However, when considering their respective impacts, the effects of these posts have to be normalized one with the other, e.g., against a common standard, whereby the relative impact and/or effectiveness of the post vis a vis the response thereto on the separate media can then be compared. For example, if the number of likes and tweets is considered at one level, such as between the 10,000 and 50,000, one scale for weighting the content score can apply, if the number of likes or tweets is over 50,000, a second or third level may be reached, and one or more other scales can be applied, same for 100,000, 250,000, 500,000, 1M, 5M, 10M, and over, etc. Different scales can also be applied to the different social media's engaged.

Likewise, as indicated above, different weighting can be applied so as to reflect that not all web content and the responses there to receives the same amount or kind of user interactions, even if their general quality is equivalent. For example, pop culture references often receive more likes than obscure artsy references simply by virtue of pop-culture exposure. However, the underlying content items 25 relating to the obscure artsy subject matter can be proportionally more-liked than similar web content for the pop culture reference, and the weighting, scaling, and evaluating can be adjusted to reflect that.

The particular formulas used to calculate any of the factors in the raw score, the factors in the weighted and/or scaled score, or the overall formula of the raw and weighted scores themselves can vary. However it must be stressed that the parameters, the factors, the weightings, or any combination thereof, can be determined, at least in part, by metadata, such as first and second metadata, which may be associated with the web content collection. In this way, a mixture of real data, synthetic data, and pre-determined scaling and/or weighting factors can be combined to provide not only a predictive score, but a score that reflects the particularities of the industry, the social medium being used, and/or the web content being scored.

Accordingly, normalization may be a useful part of the methods of the system herein disclosed. For instance, the normalization of the raw score can be used to provide a content item performance score, which can be a standardized measure of the performance of the content item 25. A mapping function can be applied to the raw score in order to transform the raw score into a content item performance score within a minimum value and a maximum value, for example 0-10, or any other suitable scale. The normalization can also capture a functional relationship such as a linear, exponential, geometric, or logarithmic relationship. For example, with a logarithmic normalization on a 0-10 scale, a final score of 9 can represent 10 times more performance than a final score of 8. The determination of the algorithms, formulas, metrics, weighting coefficients, and normalization methods, disclosed herein, can be empirical or based upon methods such as least-squares fitting, polynomial fitting, matrix algebra, etc., or any combination thereof.

The content item performance score can provide its own unique quality of feedback as it 1) tests the assumptions made in generating and scoring the collection of web content as well as the content itself 25, 2) provides a quantitative comparison of past and/or predicted future performance in each of the content items 25 in the scored web content collection, and 3) provide a “normalization” for the scoring algorithm used to generate the scored web content collection, e.g., if the performance does not generally correspond to what was found by calculating the content item performance score, this could suggest that the algorithms used in calculating the content item performance score need to be adjusted. Once the content item performance score is calculated, e.g., for one or more, e.g., all, of the collected content items 25, first data encapsulating the content item performance score can be provided to the system server 1 or to a third party computing device.

The scored web content collection, as well as its collected items, can be used as a source of web content or as a guide to users that wish to create web content that will perform well. The scored web content collection can be examined for common themes that contribute to generating highly-performing content, where such themes might not be readily discernable without the retrieving, filtering, and scoring techniques described above. For example, upon processing a web content collection restricted by the keyword “X,” then filtered to be written in “English” and posted within the last month, it could be found that the web content that received the ten highest final scores all possessed a given word or phrase or humorous slogan or image. This will provide insight as to how to best determine which content can be selected and used to build one or more communications.

Hence, the insight that the given word, or phrase, or humorous slogans or images might be the most effective way of generating highly performing web content, and can then be used to guide decisions about what to include in future web content, for example, posts, twwets, advertisements, articles, etc. relating to “X” and presented to English speakers. Suppose though, that another filter is added, for example to a geographic region where given sports activities are popular. In this example, if the web content that received the highest final score contained themes relating to the sporting activities, then a geographically tailored approach that includes those themes could be incorporated when seeking to create web content that would be expected to perform well.

Accordingly, various data may be collected by the system, e.g., via an API, or via a web-crawler or other web data collector, and which collection of such data may be based on one or more filters, such as a keyword filter. The keyword filter may be set up so as to identify an online user or company name, an online user or company address, IP address, or other URL locator for the user or company, such that all data posted referring to the key word is examined and/or collected. In additional instances, the data to be collected may include data pertaining to the user and/or the company's fans, followers, other users, commenters, reviewers, the friends and associates thereof, and those others with whom they are related over social media. In such instances, the data to be collected may include the web-addresses, emails, IP addresses, physical addresses, locations, phone numbers, and the like, one or more of which may be formed into a mailing, distribution, or other communications list so as to receive communications from the system for one or more of the purposes detailed herein, such as for the solicitation of positive or negative reviews.

Accordingly, a web of interrelations between multimedia users and/or associated companies may be generated based on the collected data, and their expected response to advertising to the company or its competitors may be determined and ranked, and used as test groups for receiving and responding to various promotional ads, surveys, and other communications, such as via one or more received emails, posts, replies, or other such communications, e.g., via an automatic communications and/or email generator. Such a method may be applied so as to divide the messaging in to types, based on how various recipients of the messaging have reviewed them. For instance, the messaging may be classified as those that increase engagement, increase reputation, respond to consumer questions or concerns, provide content of interest to consumers or followers, create velocity, generate sales, generate clicks, generate conversions, generate leads, enhance a response form a given demographics, and the like.

In a manner such as this, web-users can be identified and ranked based on who is or can be or who is not an advocate of the company, and those who give positive responses to the survey can be thanked and receive discounts or coupons, and likewise with those who respond negatively. In such a manner as this, a sales and/or a reputation enhancement campaign can be engaged in, to improve the sales and/or reputation of a user, e.g., company, of the system, and/or to degrade the reputation of a competitor. Such a campaign can be across all media pipelines, or just a select sub-group thereof, and if problems are identified, e.g., by those responding, the system can be improved with response there to and the respondent can then be emailed a follow up communication. Advocates and detractors can be identified, and each can be sent correspondence to improve the experience of the detractors, and give adulation to the advocates.

Accordingly, in various instances, the system may be configured for performing one or more of the following tasks: determining a first instance of relevant data accessible via the cloud, collecting the data, aggregating the collected data, analyzing the data, weighting the data, e.g., content and/or metadata, and/or scoring the data, such as for making a recommendation as to, and/or for generating, relevant content that the user may then select and/or edit for delivery to their employees, clients, and customers. As indicated above, in various instances, content to be used in a communication can be selected from a library of stored data, such as based on recommendations suggested by the system. Further, once messaging has been sent, published, or otherwise delivered to one of more consumers, a consumer feedback protocol may be initiated so as to generate a response evaluating the effectiveness of the messaging, this response may be direct, such as by asking the consumer to comment on the messaging, or indirectly by collecting data pertaining to the consumer's response to the messaging, such as via the determinable actions they take, e.g., online.

Hence, such collected data, e.g., related to the responses to the messaging, may also be evaluated to better determine relevance and appropriate weighting, e.g., of messaging, and/or for determining what messaging and/or portions thereof may be working as content for organizational communications. For example, messaging that only evokes a response in 10% or less of respondents, will be given less weight than messaging that evokes a response in 50% or more of respondents. Additionally, messaging that receives positive responses will be weighed more than those that receive some proportion of negative response. Of course, such weighting may be proportional to the percentage of positive responses.

Likewise, comments from users who routinely make responses, or otherwise give feedback, or from people who themselves have many followers, may be weighted more or less than responses or feedback from a respondent that does not often give feedback. Additionally, when pulling relevant data from the internet, data from pages having a lot of traffic may be weighted heavier than those pages that do not have as great as amount of traffic. Velocity may also be measured, such as by how many and how fast messaging gets viewed, acted upon, evaluated, and/or trends or fails to trend, which velocity can then be used in a weighting regime. It is to be noted that while the performance of web content is typically difficult to quantify, some media or publishing platforms provide pipelines, or other access points to their platforms, such as via a suitably configured application programming interface (“API”), whereby the system can access various data pertaining to the postings on that platform.

In a manner such as this, one or more metrics, associated with the web content being collected and/or content having been sent, may also be collected, such as from the social media pipeline. The collected metrics may allow a user of the system and/or a target of the communication to self-report their level of engagement with a user company's product, service, or provider thereof. Such self reporting may include any form of seller or buyer feedback as typically expressed in that medium, for example “likes,” “dislikes,” etc. Other data may be collected from such online communication recipient users or followers, e.g., consumers, by tracking their actions and comments across media platforms, and building a profile of the user, which can then be used to better target communications to them and other such users. Other subjective indicators of interest, disinterest, or performance, e.g., of content, may also be used in the evaluation process.

In other instances, interest and/or performance of a communication can be reflected by more objective measures, such as reach, engagement, comments, shares, and/or other actions a user performs to show interest in a given content of a message, etc. such as of webpages or individual pieces of web content 25. It can be assumed that the general level of user engagement is proportional to the appropriate metric, however an accurate representation often defies simple mathematical relationships, and in such instances, a more complex algorithm is employed to determine otherwise difficult relationships to quantify. Also, the success of web content 25, such as presented at a website 23, in generating user interest and/or engagement can depend on many factors such as the type of site the web content comes from, the user base thereof, how the web content is used on a website, the way the web content is packaged, etc. This information can be useful when preparing and/or selecting a given template 25b into which collected web content 25a can be inserted, such as when generating a communication 250. In certain instances, user interest can be measured based on the time spent on a web-page 24, the time a mouse indicator remains over given content, the number of clicks and/or forwards the content receives,

Accordingly, an empirical formulation representing performance of the web content 25 is useful in determining what content to collect, and may be based on the metrics associated with the web content collection, which is one way of addressing this challenge. Such a formulation can be presented in the form of scores assigned to selected web content 25 as well as providing top scoring examples of web content 25 to users, such as when engaging a suitably configured project builder 32b and/or viewer 32a of the system 1, as described herein. In various instances, once evaluated and/or scored and/or accepted, the content 25 can be employed in the generation of one or more communications 250, where generated communications, or content packages, may then be formatted and/or stored 34 for user selection as content 25a in one or more messages 250 to be distributed through the one or more social media pipelines 23, set forth herein, or other such communications media. Accordingly, in one aspect, the system 1 may include a content builder 32 and be configured for evaluating 62 and/or generating data that may be used for messaging.

As can be seen with respect to FIGS. 1 and 2, once generated the communication 250 can be distributed, such as by a suitably configured distribution unit 64 of the system, as described below. In these instances, the system 1 may be configured for delivering the generated content 250, e.g., in the form of an official communication, to and across one or more, e.g., all, media pipelines 23 simultaneously, or it may be delivered sequentially, based on a determined and/or predicted model of optimum usage parameters, where such parameters may include, optimum time of delivery, e.g., with respect to target viewability, optimum format of content, optimum presentation of content, optimum mode of delivery, optimum style of template configuration, optimum choice and presentation of content, and the like.

Such content 25a as well as a template 25b containing the same, its form, and its delivery parameters may be determined by a user of the system, or may be determined based on various algorithms run by the system, e.g., by an artificial intelligence module thereof. Particularly, as described in detail below, the system 1 may include an A/I module, which A/I module may be configured for analyzing (potential) content 25a, determining patterns and trends of recipient activity, and may further be configured for automatically generating content 250 (or suggestions thereof) and/or for determining suggested delivery patterns of communications or messaging containing that content 25.

In a manner such as this, identified content 25a may be automatically generated by the system, and may further be configured for delivery thereby, e.g., based on a number of parameters, such as the demographics of the target, so as to be delivered at a regionally determined peak traffic (e.g., viewing) time(s). Furthermore, as disclosed herein, in various instances, the system 1 may be associated, such as via one or more APIs 12, to one or more social media pipelines 23, and thus, the scheduler 40 may facilitate the posting of a message 250 to one or more of these pipelines 24, simultaneously or iteratively, or may post on a given schedule, such as to hit peak times on the medium and/or in a given region. In this manner, high impactful content 25, catered to the region and medium of delivery, may be identified and delivered at determined peak time for all regions of delivery.

Hence, when a schedule it set, the system 1 may then access the content in the designated library folder 34a, pull the appropriate content 25a, format it, conflict check it 67, and broadcast the messaging in accordance with the set schedule. The scheduler 40 may then work with the evaluator module 62 so as to then send out feedback in a timing that is appropriate for receiving such feedback. As such, the system 1 may be configured for setting up, sending, and receiving follow-up messaging so as to better evaluate the effectiveness of the original messaging.

Accordingly, the system 1 may include a scheduler 40 that is configured for determining an optimal delivery pattern, based on factors relevant to a given market segment for the overall organization, e.g., communication source, or a portion thereof, e.g., a franchisee of the organization. Particularly, the scheduler 40 may be configured to run a diagnostic, either by itself or in conjunction with the A/I module of the system, so as to determine successful communication parameters for the messaging of clients, e.g., consumers, or potential consumers within each region or sub-region serviced by the messaging organization. Additionally, the scheduler 40 may determine when the messaging 250 should go out within that local market so as to attain maximal effectiveness, e.g., viewability, such as during high internet traffic times for that sub-region for a given selected media pipeline. This not only allows for the delivery of communications 250 during times of high traffic within a given region, it also allows messaging to be sent out in bursts, such as where the system 1 configures the messaging and its distribution so as to promote viewability and/or to be able to avoid spam filters employed by the various social media systems via which the messaging is being sent.

The scheduler 40, therefore, may provide access to one or more calendars 40a, thereby providing easy access to working groups, with respect to the distribution of one or more communications, such as when setting up an advertising campaign. Hence, an account administrator may have access to a master calendar 40a into which events or tasks may be entered, and the system 1 may then populate the calendars 40b for others automatically. Hence, in this manner, one calendar 40a can connect to thousands of other calendars 40b, e.g., company wide.

Likewise, access to the scheduled events in a communications campaign can be entered into the calendar 40a and thus be made available to all authorized group members working on the project. Further, as feedback comes in with respect to scheduling or campaign content may also be populated via a calendar 40a of the scheduler 40. In this manner, not all communications 250 will go out at one prescribed event or time, e.g., across all regions, nor will it go out all at once, within a region. Rather, the scheduler 40 will target the messaging 250 within a region in such a manner that generated messages go out at a predicted optimal time for delivery in any given region, e.g., peak traffic time for that region, and the messaging within a region will go out in bursts, e.g., bursts designed to avoid spam filter detection.

The scheduler 40 may schedule the transmission for any day or any tome of the day, as best determined by the system 1, such as with respect to a predetermined posting plan. The distribution or transmitting 63 may be a one-time thing, periodic, or recurring, based on user input or system determination. Further, this may be implemented for a given period such as one work, one month, several months, a year(s), and the like. In various instances, the scheduler 40 may communicate with the content generator 32 so as to ensure that the messaging 250 is rotated, e.g., via the content repository 34 of approved communications, so as to always seems fresh, new, and relevant to its recipients. This may be repeated for any number of selected days, months, years, etc. Likewise, once a communication 250 or content 25 has been rejected, it may be repopulated with approved content 25a, such as from the approved content folder 34a of the repository 34, e.g., of approved content.

Hence, not only is the messaging platform system flexible with respect to the type of data it collects and/or uses to create and/or generate its messaging, the messaging platform is additionally flexible with respect to configuring the system as to how, when, and in what format that messaging 250 is going to be delivered to consumers. As indicated above, the system may be configured in a manner that mirrors the structure of the organization itself. For instance, as indicated above, small or large corporations 100 may have more or less levels of management or authority.

Hence, the present system architecture may include a review module 64 having one or more layers of permission blocks, giving users varying access to system wide functionality, such as based on position or authority within the organization itself. Such permissions may be allocated both vertically and/or horizontally within the organization, such that the higher up in the organization a user is, the more access the user has to the system and its components, and where all members at the same level of authority within the organization, e.g., across different regions, have the same level of permissions. Alternatively, permissions can be set up to better emulate employee function, such that those employees more specifically tasked with being in charge of company communications may have greater access than those employees not so tasked. Accordingly, in this manner, groups of permissions can be set up, e.g., by the review module 64, in any manner adaptable and otherwise suitable to the organization itself.

And, of course, such an architecture is practically infinitely scalable such that as new users join the organization 100, or a specified group thereof, new permissions can be allocated, by the review generator 64 to the new users, which may coincide with an increased cost to use the system. This will allow the system 1 to be configured to mirror the functionality of the corporate structure 100. Likewise, as a single employee may have several different and/or overlapping responsibilities within an organization 100, so too a single user may have overlapping and different permissions, with respect to how they can access and use the communications data of the system 1, such as based on to which groups within the company 100 and/or system architecture the member belongs. As such, as a member of one group the user may have access to a certain level of permissions that may be more or less than the permissions the employee has as a member of another group. Alternatively, the system 1 may be configured such that the permissions follow the user such that the highest level of permissions a user has, such as in a first group, adhere to that user regardless of the group the employee is in.

Another aspect of the system 1 is a traffic monitor and/or modulator 31a that is configured for identifying, monitoring, and/or modulating consumer traffic throughout the system 1 and/or its component parts. For instance, in some embodiments, a system wide monitor is provided, whereby the monitor is configured for assessing traffic on all social media pipelines 23 across all relevant regions of the organization, such as via a suitably configured API 12 associated therewith. In a manner such as this, the system 1 is capable of monitoring traffic, e.g., related to a user of the system, generally across all social media pipelines 23, such as in a horizontal architecture, but also vertically, down from company 100 headquarters to the regional and local franchisee level.

In certain instances, not only can the system 1 monitor traffic, it may also be configured so as to measure traffic, develop trends, and make predictions based not only on the quantity of traffic but also the quality of traffic, such as by itself or in communication with a suitably configured and associated A/I module. For example, the system 1 may be configured for not only measuring the amount of traffic, e.g., at a given time and/or with respect to given web-content, it may further be configured for evaluating the type of traffic, and as mentioned above, determining the effectiveness of viewer content. Specifically, depending on the type of social media pipeline 23 being employed for distributing organizational content 250, consumer responses will be in one form or another, such as direct customer surveys, likes or dislikes, up-votes or down-votes, good comments or bad comments and/or sentiments, good or bad reviews, private comments, shares or forwards or tweets, re-tweets, deletes, reads or non-reads, and the like.

The system 1, therefore, may be configured for determining the medium through which messaging 250 has been distributed, and may further be configured for assessing whether the messaging is generating positive or negative feedback, such as by evaluating the type and quality of the feedback being given by the message recipients, such as, in part by determining the traffic of the content 25. As such, the communication 250 may be evaluated, as a whole, or specific content thereof may be evaluated. Accordingly, once feedback is received and evaluated 62, the system may then employ the results of that evaluation so as to better determine more effective messaging generation, such as by configuring the system 1 to generate more of the type of messaging that is working, and less of the type of messaging that is not working.

Further, the system 1 may be configured for signaling when a trend is determined, and may notify users of the existence of a trend, so as to allow the users, e.g., business owners, advertisers, and the like, to fine tune the messaging to take advantage of an uptrend, by more effectively directing messaging to incorporate the uptrend components of previous messaging, and to curtail messaging, and/or its components that is leading to a down trend, thereby hopefully reversing a down trend. These system wide data, or data subsets thereof, may be related to traffic quantity, quality, velocity, and/or trend assessments, and may be sent periodically to various modules and/or users of the system 1, such as via a suitably configured reporting suite 65 of the system 1, or the trend data may simply be made accessible real-time or at the convenience of the user.

For instance, all of such data, including meta-data, may be pushed to a nation-wide or other global manager, while only certain subsets of data, e.g., region specific data, may be pushed to employees with a more limited permission type, such as regional or local manager. For example, the permissions and/or other filtering involved determines what may be accessed and/or pushed to certain users, e.g., based on what the employee's role is within the company, etc. Such data can be pushed at any desired interval, such as by being sent via the reporting suite to the users email or other account login, such as real time accounting, daily downloads, weekly digest, monthly overview, and the like.

Once received, e.g., by a corporate official who must approve its contents and/or delivery, the communication 250 may be accessed, analyzed, and a decision tree of possible decisions as to how to respond to the data may be provided and/or otherwise displayed to the user, e.g., electronically, so as to make responding to and/or approval of the data simple and efficient. Accordingly, the data may be generated and/or evaluated by region or any subset thereof, or globally, as desired by the user. Of course, the system 1 may also be configured so as to allow the user to immediately re-configure the system 1 and/or its component parts, such as based on the trend and or other evaluation 62 and/or traffic 31a data generated. Hence, once the data has been pushed to one or more users, and/or one or more responses to the data has been generated and/or recommended by the system, the user may then decide what to do with the received data.

Accordingly, with respect to generating and/or approving content and communications in general, the system may also include a workflow manager 50, such as for determining the flow of information and/or communications through the communications platform of the system 1 and across the various media pipelines 23 of the system. Particularly, an aspect of the system 1 is a task management tool 50. For instance, a task management module 50 may be provided wherein the task generator 50 is configured for prompting and/or otherwise engaging a user, such as a business or advertising executive, so as to provoke the user to perform one or more tasks, e.g., creating or approving a communication, based on the received data. Specifically, one or more tasks may be set up to be performed by the various users of the system, such as across or down a chain of command within the organization. Such tasks may require one or more employees to respond to data, respond to messaging or a communication as a whole, to forward the messaging and/or communications to others for their review and/or response, to approve or disapprove responses to the data, to reject it, to publish it, distribute and/or broadcast it, and the like. Hence, multiple layers of responses, reviews, and/or approvals may be set up or otherwise tasked, via the workflow with respect to how to respond to received communications and/or analytical data pertaining thereto.

Accordingly, the system 1 may include an asset manager 34 such that once a communication 34 and/or its content 25a has been received and/or otherwise generated and/or evaluated and scored, e.g., either manually and/or automatically, it may be fed into, or may be used to form, a template 25b for generating messaging 250 relevant to the customers of the business, such as based on customer demographics and/or geographical regions. For instance, once a message 25a or a template 25b for messaging has been generated it may be stored in a database, e.g., a cloud or local based database 34, that the business owner, or one or more sub-owners, e.g., franchisees, may access and use to generate communications 250 and/or to forward communications to their, e.g., local, consumer base. Particularly, the system 1 may be employed so that brand managers, communications directors, and/or advertisers, and the like, may generate content approve media 25a and/or template files 25b, so as to build a library or repository 34 of approved content, which library 34 may be accessible by others within the organization with the appropriate permissions, so as to be used to develop and distribute brand approved messaging 250 throughout the organization, such as for distribution to consumers or customers of the business and/or network of businesses.

Such content may include personally generated and/or system, e.g., automatic, generated content that includes the most up to date images, such as: graphics, automations, videos, and/or written content, such as: messaging, supporting data, articles, posts, posts with graphics, and the like, which content may taggable and/or flagged, and may be organized, e.g., within the repository 34, in a manner such that approved messaging 25a may be searched and employed throughout the organization 100 for the purposes of analyzing data and/or for generating communications 250. In a manner such as this, the communications 250 within a company and/or the communications distributed to its consumer base may be consistent and content approved.

For instance, a first user of the of the system 1, e.g., a system-wide administrator, may cause an approved social media communication file 34a to be generated, which file once generated may be stored in an “approved” communications repository of the system. A secondary user, e.g., a franchisee owner, may then log on to the system 1, access the approved social media file 34a, search and identify one or media files 25a and/or templates 25b, and use one or more of the identified files therein in the messaging the company sends out to its local consumers, such postings may also be tagged prior to distribution, such as for monitoring the success and/or effectiveness of the communication, e.g., for determining and evaluating the level of consumer response to the messaging.

Accordingly, as set forth above, the system 1 may include one or more content repositories or libraries 34 of approved social media content and messages 25a, such messages 25a may include targeted advertising, special promotions, general company information, specific franchisee information, and the like, which content 25a may be downloaded, edited, reconfigured, and published. Once these files have been viewed, edited, and/or published, a new file 34b may be generated including the new messaging, such as a new template 25b and/or media asset for the use of others who can then access the new content of the system. Accordingly, the system 1 allows for easy searching and rapid acquisition of useable content 25a for messaging consumers in a more effective and easily approved way. The system, therefore, may include a media editor that allows a user to not simply access media, e.g., approved media, but to edit it for the purpose of being more applicable, e.g., to their local customers, prior to sending forth messaging on a given social media pipeline.

Additionally, the system may include an auto archiving mechanism for automatically saving collected and/or generated content and messaging, such as by use of keywords, or other metadata, employed therein, and/or for evaluating the effectiveness of the messaging, e.g., based on the number of accesses, the number of views, the number of implementations, the number and/or type of sentiments, e.g., likes, received, and other user engagement data, one or more of which can be used to score the communication and/or its contents. In a manner such as this, the system and/or a user thereof, e.g., administrator, may look through the history of messaging throughout all platforms and/or pipelines, and evaluate the messages, one against the other, so as to make a comparative assessment as to which messaging was more effective and/or why one message was more successful than another, such as based on one or more parameters, such as leading to purchases, a number of comments, up-votes, likes, retweets, and the like. Once scored, the system may prompt other users of the system, inside or outside of the messaging organization, to employ the same messaging, such as based on the overall score of the available message content and/or templates.

For instance, one or more of the libraries 34 and the content 25a, 25b disclosed therein may be viewed, evaluated, scored, and ranked, such as by commercial effectiveness, e.g., for affecting change in consumer behavior, which may then be accounted for by the system in weighting other communications being generated, thereby allowing the user to do more of what is working and less of what is not working. Hence, in various instances, the system is configured for auto-archiving data, such as content 25 and messaging, based on its ranked scoring, so as to be searchable in a manner that displays the most relevant messaging, e.g., with the greatest score, higher in the search results than those with the lowest score, e.g., relevancy score. Accordingly, in view of the above, the communications platform system 1 may be configured to collect, analyze, and/or store data, such as data related to the building of a communication 250, which data may be made accessible to the user of the system in the generating and/or distributing of communications.

For instance, in some embodiments, the system 1 may include one or more of an A/I module 54 and/or workflow manager 50 and/or a smart scheduler 40 and/or scorer 62 to both organize and manage media content 25a, to run one or more analytics on the content 25a, and/or its associated data, and to learn from the analyses and thereby providing suggestions, predictions, and/or rankings of content that can be used in generating and distributing communications. For example, the system 1, or one or more of its components, may be employed to run various analytics on the data of the system to better learn identifiable trends, e.g., on one or more social media pipelines 23, which may then be employed to make the system more intuitive to use, better at generating content 25a, and more efficient at determining peak traffic times, e.g., for scheduling, and optimal demographics when distributing generated content to a targeted demographic. Specifically, once the optimal configurations for generating and/or distributing a communication 250 has been determined, e.g., via the A/I and/or other modules of the system, then the workflow manager 50, together with the scheduler 40, and/or conflict checker 67, can then carry out the implementations necessary for delivery of the communications 250 to the targeted demographics, which delivery may or may not be dependent on one or more approvals as discussed here.

As indicated, another aspect of the disclosure is a review and/or approval module 64, so as to initiate and automate an approval process as disclosed herein. For instance, in various embodiments, the system 1 may be configured so as to require (or not require) an approval process prior to allowing a proposed communication to be sent out. As indicated, the approval system 64 may be implemented in a hierarchical architecture, and in certain embodiments, the hierarchical architecture of the approval module 64 may be such that it models the hierarchical structure of the organization 100 that is running and/or otherwise implementing the system 1. Particularly, the approval module may be communicably associated with one or more of the other modules set forth herein.

Hence, for instance, once a communication 250 has been generated, it may have to be approved prior to being sent forth, the scheduler 40 and workflow manager 50, therefore, may account for the need for approvals prior to scheduling the transmitting of a communication, so as to allow for the appropriate time for approval seeking. The scheduling mechanism 40, therefore, may play a gating role in the transmitting process of a communication, but, the scheduler 40 may send out reminders, e.g., via an email or posting, that a task, e.g., an approval, needs to be completed prior to the distribution of the pending communication.

In a manner such as this, the communications generation 32 and distribution 63 system may implement an internal system of checks and balances, so as to ensure that communications 250 have been appropriately vetted before being transmitted, e.g., ensuring corporate headquarter or local franchisee buy-off prior to distribution, either globally or locally. In various instances, one or more approvals may be necessary for a given communication 250 to go out, such as a middle manager and/or a local franchisee must both approve prior to distribution 63. In various instances, communications 250 for approval may be lined up, and presented at a user interface 22 whereby each proposed communication 250 can be presented, and a user with the appropriate authorization may approve or disapprove the communication 250 via engagement with the user interface, such as by swiping, e.g., left or right, or up or down, such that after each swipe of approval or disapproval, the next communication 250 in the queue is presented at the user interface.

If an approval is not given, in a given instance, a description of why the approval was not given and/or what corrective measures should be implemented in order to achieve the approval in question. In such instance, the system 1 itself may automatically implement the corrective procedures, such as with respect to the content 25a of the proposed communications 250. In various instances, the system 1 may be set up such that once a communication is rejected, the system 1 may automatically select a previously approved communication 250, e.g., from the library 34, and that approved communication 250 may then be sent out, such as with minimal editing, in its place.

A useful feature of the review and approval engine 64 is that it allows a system administrator, e.g., an account and/or communications manager, to control a larger number of accounts than would otherwise be possible. This is useful because prior to the present system 1, communication control would require individual collection and generation of content, individual generation of communications, individual review, individual checking, individual transmission, for each particular account, which for big advertising firms could require tens to hundreds of employees all managing a single account. The present system 1 automates all of these activities, thus reducing the number of employees required for management, thereby conserving resources, enhancing production, and maximizing the usefulness of computing resources. Allowing a single manager to administer a single large corporation or several tens to thousands of companies, which would not otherwise be possible.

Particularly, the leverage now available can be 10 to 1, 100 to 1, 1000 to 1, 10,000 to one, and the like, e.g., all managed from a single user interface of the communications system, such as where a single administrator can now manage the entire platform of the entire media pipelines, of an entire corporation, of an entire market segment, and the like. For instance, the single administrator can utilize the system to generate content and communications, such as advertisements, for all companies, and all users, nationwide that can be easily approved, checked for conflicts, and distributed, automatically, by a single user interface. In some instances, the number of communications being generated, reviewed, checked, and distributed may be from hundreds, to thousands, to tens of thousands per month, which communications may be commercial content, such as advertisements, reports pertaining thereto, emails promoting or following up on promotions, and the like. Without the present system, employing the recited processing engines for performing the disclosed functions could simply not be done, let alone be done using a single interface and/or automatically without substantial human intervention.

Instead, implementing the present system 1, more time may be spent on generating and/or approving content 25a, building up the library 34 and/or library types, 34a, 34b, 34c, and/or strategizing a communications campaign for reaching more potential clients or customers. For example, the account administrator can read the generated reports 65, see what is working, and the system 1 can present a user interface, e.g., dashboard 22, that shows all high scoring content/communications that the user can just swipe through by the sweep of a finger (e.g., to the right or left, up or down) to approve and/or send, thus making their job super easy to monitor and administer.

An additional aspect of the disclosure is a conflict checker 67. Particularly, in various instances, an organization may have sub-units, such as franchisees, that have regional locations that are geographically near to one another, or the system may be serving two different companies but that compete for the same customers, and in such instances, the system 1 may implement a conflicts check 67 protocol so as to ensure that the same messaging does or does not go out that promotes different objectives within the same region. For instance, where two franchisees of a global conglomerate share a common region of influence, the corporate headquarters, or other organizer, may require that the messaging being sent out to customers in those two overlapping regions be the same, e.g., for consistency purposes, and as such the conflicts checker processing engine may then analyze the messaging prior to approval to flag and/or correct any inconsistent or divergent messaging. Alternatively, the directive may be that two units within a similar geographical region may desire to have different messaging, and in such an instance, the conflicts engine may analyze content to ensure there is sufficient dissimilarity between outgoing messages being distributed to the same or similar geographical region.

Particularly, the system 1 may include, as described below, a geographical locator 68, which locator 68 may be configured, such as by an administrator of the system, so as to set boundaries of the various users, whereby each region may be defined and messaging parameters with respect thereto can be set to either increase or decrease similarity in messaging. For instance, if two locations, either of the same organization or different, are X miles from one another, e.g., 2, 4, 5, 10, 15, 20, etc. and they are both employing the system for distributing communications to their respective regions, the system can either ensure that the messaging being put forth is consistent, or that it is different. Particularly, in certain instances, it is desired that messaging from the same or different companies serving the same or similar region is not the same as previous or competing messaging, and the conflict engine assures this does not occur. The conflicts checking 67 can be set for a given period of time, such as within the same day(s), week(s), month(s), etc., such as within 1, 2, 3, 4, 5, 6, or so weeks or months.

And, where conflicts are determined, the conflict engine 67 can direct the project builder 32b or other processing engine of the system to either generate a new communication 250, or to access an already generated and approved message such as from the communications repository 34, so as to automatically resolve the conflict, or can flag the conflicting content 25 and require user intervention to resolve, such as via the approval's module 64. In a manner such as this, all the locations of a brand and/or of competing brands can be managed from a single interface. Particularly, the content 25a can be made similar or changed, and/or the templates 25b can be made the similar or dissimilar, so as to give the communication 250 the same or a different look and feel.

In certain instances, product or service provider locations from the same organization may seek to have complimentary looks and feels for their distributed communications, while product or service provider locations from different, e.g., competing, organizations may seek to have different looks and feels, as well as different content. In various embodiments, the system 1 may include a randomizer, e.g., the communications builder 32, that functions by either generating or pulling approved communications 250, e.g., from an approved folder in the library 34, in a manner that is random such that no two communications within a geographical region are the same. The randomizer can ensure no communications 250 that go out are the same system wide, or may ensure that no communications 250 between companies or within the same company are the same, thereby ensuring that all communications system wide are different as to look, feel, and content.

In certain embodiments, the disclosure is configured for executing one or more processes, such as including an identifying and/or a locating process, such as for identifying an online or social media user and/or their location, such as based on the type and form of the language they use, their spelling, their punctuation, the idioms or phrases they use, the images they post, the subjects they post on, their opinions, and the like, such as by comparing known posts, e.g., identifying posts, of theirs with unknown posts in question. Likewise, their identity and/or location may be determined by their usage of a mobile or desktop computing device used for engaging in such online activities. For instance, location may be determined based on one or more of a device identifier, e.g., RFID, associated with the mobile or desktop electronic device; a user identifier; a user account login, an identification associated with the consumer; and/or a determined geolocation of the mobile electronic device, the geolocation being defined by a geographic area where the consumer is presently or has been engaging in activity, e.g., commercial or communicative activity.

For example, a consumer posting online or performing a transaction, e.g., via a mobile device, may be located and/or tracked by one or more methods, such as by the various transmitters inherent to their mobile device, including but not limited to the use of the device of a radio frequency (RF) transmitter, a cellular transmitter, WIFI, and/or a Bluetooth®, such as a low energy Bluetooth® transmitter unit. The consumer may also be identified based on data the mobile device receives such as via the use of a receiver, such as a satellite based geolocation system or other mechanism for determining the position of an object in three-dimesnsional space. For instance, the consumer may be located via a known geolocation system, such as including one or more technologies such as a Global Navigation Satellite System (GNSS). Exemplary GNSS systems that enable accurate geolocation can include GPS in the United States, Globalnaya navigatsionnaya sputnikovaya sistema (GLONASS) in Russia, Galileo in the European Union, and/or BeiDou System (BDS) in China. In other embodiments, a potential consumer can be located based on the comments they make, the words the use, and the location identifiers they use when posting communications, such as by location markers they reference in their posts or the images they upload.

In a further aspect, the system may be configured so as to generate one or more reports 65 as to how the system 1 and/or its component parts are functioning, as well as how effective the messaging has been across one or more social media pipelines 23, and/or up or down one or more business segments, e.g., down through one or more regions serviced by one or more business units or franchisees 100. Accordingly, because the system 1 may be configured to be multi-tiered, the reporting may be configured in like manner so as to also be multi-tiered, so as to be as general and far encompassing as well as granular and all-encompassing as desired by the one or more users of the system. Such reporting may include an evaluation of the effectiveness of a message across pipelines 23, so as to evaluate the effectiveness of a given social media pipeline, e.g., messaging on that pipeline, or it may be across regions, so as to evaluate the messaging directed to different, e.g., regional, market segments.

Additionally, another aspect of the system 1 is a business analytics module 62 for comparing content 25a and messaging 250 as well as the companies 100 generating and distributing the same, which comparing can be with respect to different metrics, parameters, and/or demographics, and may also be considered and/or evaluated in the reporting function. Different events and marketing campaigns run at different times throughout the year may be compared one with the other. For instance, the system evaluator 62 and/or reporting functionalities 65 may be configured to assess the operations of one or more downstream sub-organizations 100a, 100b, 100c, such as franchisees, or other users, so as to determine which sub-organization (and/or their communications 250) is performing within pre-defined parameters, which are not, and which are on the borderline, and based on which sub-segment of the organization is doing what, different offers and/or promotions and/or messaging may be offered to that organization 100 so as to ensure better conformity, reward strong performers, and/or penalize or support poor performers. For example, if at any given point of time, a global brand is performing relatively well, it may have 25% of its franchisees performing above average, 50% performing average, and 25% performing below average. The system, therefore, may be configured so as to determine and evaluate such performances, and generate messaging to encourage or penalize those low performers, and/or to reward those high performers. Such rewards or punishments may also be communicated to those franchisees performing at the average mark to support and/or encourage above average performance.

Hence, in some embodiments, the system may be configured to evaluate not only a given messaging regime throughout an organization 100, e.g., with respect to messaging its customers, it may additionally be configured, in other embodiments, to evaluate, rank, and/or score the performance of the overall organization 100, or sub-units 100a, 100b, 100c thereof, such as with respect to one or more relevant parameters, such as a given sales matrix, such as with respect to comparing a plurality of the sub-organizations within the larger organization one with the other. Such evaluations may identify trends or actions that are being performed that are having a positive or negative impact on how that sub-organization is performing. For example, actions and/or messaging of a given employee and/or a given sub-organization 100a may be given a score and a rank, e.g., via the evaluator module 62, through the evaluation process, which score and/or rank may then be employed to better determine the system parameters locally and globally. Actions and/or messaging 250 that is working may then be scored and placed into the database 34, such as a template for instructing better practices and/or procedures and/or messaging, and those actions and/or messaging that is not working can be identified and circumscribed so as to prevent others from engaging in actions and/or messaging 250 that has been identified as not being helpful for the organization 100 in meeting their pre-established goals.

Accordingly, in various embodiments, the system 1 may be configured for receiving and aggregating 66a all of the respondent feedback so as to automatically provide a suggested plan of action 66c based on the aggregated review data. In various instances, when it is reported or determined, e.g., by the evaluator engine 42, that given content 25 or communications 250 are not working as well as others, this content 25 or the communication 250 itself and/or the template 25b may be quarantined or expunged from the system 1, such as by being removed from the library 34 or sent to a non-approved folder 34c, and the like.

The system may also include a user feedback and/or comment section 66a so as to allow users of the system 1, and/or users of the brand, to communicate directly with the organization 100 and/or system provider and/or consumers of the brand. For instance, in certain embodiments, the system 1 may be configured for scouring, via the score generator 62, the various social media pipelines 23 for consumer comments 66a, such as with regard to reviews of products, or the company 100 or one of its franchisees 100a generally, and aggregating that data for presentation at a central display 22, e.g., as a dashboard, thereby allowing a user of the system 1 to, at a single display, to respond to consumer concerns and queries, without having to log in to each single social media pipeline 23 individually.

In other instances, the system may include a report generator 65 that is configured to generate a report with respect to the above, which report may be sent to one or more officials or other third parties. Specifically, a dashboard 22 may be employed to organize the data, e.g., messaging content 25a, to be presented to a user, and as such may be segmented along one or more parameters disclosed herein, providing easy access to one or more of the modules of the system, and their contents. In various instances, the data 25 may be filtered and/or formatted for easy viewing by a segment of the dashboard, such as based on importance to the user, such as determined by the A/I module 54 or selected by the user. For example, the system 1 may tag each consumer contact 66a and the medium from which it was obtained, such that when a user of the system replies to a given comment 66c, the system directs the post to the very same medium on which the statement, concern, or query 66a was originally posted.

The system 1, in these and other regards, may also be configured for tracking response times, locations of comments and responses thereto, such as by geographical region and/or business segment, as well as by consumer response to the company response, such as by number of likes or dislikes, retweets, positive or negative comments made, up or down votes, and the like. This data may then be used to score, via the score generator 62, and rank company responses 66c throughout the organization 100, such as on a region by region, or segment by segment, or pipeline 23a by pipeline 23b, or consumer by consumer basis. Accordingly, data to be aggregated and presented by the system 1 may be analyzed, formatted, and reported out in a variety of ways, so as to meet the present needs of a system user, so as to determine the effectiveness of the organization 100 to communicate clearly and consistently with their consumers, determine their consumer's response 66a to their messaging 250, provide feedback and/or suggestion with respect their to, and can perform various analytics with respect to comparing one part of the organization, e.g., one business segment, with that of another. All of these functionalities, and more, may be accomplished by the workflow manager 50, such that the various workflow functionalities and reporting styles remain consistent throughout the organization 100. In a manner such as this, the system 1 may review and evaluate the reputation 64 of a company 100, or other user, utilizing the system 1, so as to ensure and/or correct and/or enhance the reputation 66b and/or well-standing of the company.

Specifically, in various embodiments, as described in greater detail herein below, the system may include a review and reputations module 64, which module is configured for receiving, aggregating, parsing, and/or scoring communications and content about to be posted, as well as for analyzing consumer responses thereto. Specifically, a review database may include a number of content and/or communications that need to be approved by an administrator of the system prior to being allowed to be distributed. The admin, therefore, may engage with the system, e.g., via the dashboard, and may scroll through the content and communications and approve or disapprove them. When the dashboard is presented at a handheld device, this review may simply be a matter of swiping a finger across the touchscreen interface in one direction for approval, and in another direction for disapproval. A tap on the screen interface will allow the reviewer to add comments as to how to change the communication so as to make it acceptable, or as to make it better generally. Consumer reviews and/or comments about the company and its reputation can also be reviewed in this manner, where by tapping on the review screen will allow the reviewer to comment and/or send the review to one or more users of the system for actionable items with respect thereto.

Another aspect of the system is a new client locator 29. Specifically, as indicated above, the system 1 can monitor online comments 25, such as within a given region, e.g., within a given zone of influence of a company or other user of the system, and can collect and flag comments, sentiments, and other data that indicates a poster, e.g., a consumer, within the identified region may be a potential customer of the business, e.g., based on comments they make on a review or social media site.

As indicated above, in various instances, the system 1 via the review and reputation module 64 may be configured for reviewing the communications of or about an organization, such as with respect to their effectiveness, such as in communicating, commercially, and/or economically, such as with respect to a given location or region. For instance, the system 1 may be implemented to review and rank sub-units or local organizations (such as franchisees) within a larger, e.g., global, organization, such as with respect to one or more locations. For example, the communications of a sub-organization may be analyzed and cross referenced with its performance, e.g., sales performance, so as to determine how the sub-organization is competing versus other sub-organizations, e.g., within the same organization, or across organizations.

As indicated above, the communications and performance of an organization may be measured, evaluated, and ranked, by the reputations module 64, and based on that ranking the organizations, and/or sub-units thereof can be compared one against the other along one or more determined metrics. In a manner such as this, one or more problems or achievements in performance may be recognized, and corrective or exemplified measures may be taken by the system. For instance, the evaluation may be made to determine if the organization's communications 250 are a problem or if the organization benefits from them, e.g., in the conducting of their business.

Particularly, in various instances, the various sub-units of a global organization may be compared one against another, in this and other manners, and may be ranked, such as to determine if messaging, or other commercial activities, is making one business unit more effective than another, and/or determining how to model other groups after those groups whose communications and other commercial activities are positively affecting their sales. The reverse is also the same with respect to activities leading to negative consequences between a business unit and the consumers it services. Other metrics besides communications may be used to measure and/or compare one business unit to another, one business unit leader, e.g., one or more mangers, franchises, to another, either individually or collectively, so as to determine how one manager or group ranks or rates against another, e.g., with respect to one or more regions, e.g., a region by region determination, and/or analytics thereof.

More particularly, as discussed herein above, one of the modules of the system 1 may include a review and reputation module 64, which functions to collect communications data across the various social media and review platforms 23. Further, the review and reputation module 64 may be configured for receiving and reviewing data pertaining to the commercial activities of the various business units, and furthermore, the review and reputation module 64 may be configured for analyzing the commercial activity data with the communications data to determine if the communications or other factors are affecting the commercial activities and/or success or lack thereof. Additionally, comparing the various different business units one to another, so as to rank them, and further still to determine what is causing those succeeding in commercial activities, e.g., due to their communications 250 or other commercial activities, to attain such success.

In response thereto, the system 1 can then make suggestions as to and/or may implement measures to increase the success of the lower ranked business units so as to implement the factors leading to the greater success of the successful business units and/or may even make suggestions of identified measures that may be taken to further increase the success of successful business units, such as with respect to their communications. As discussed herein, various aspects of the communications 250 can be analyzed in these regards, for instance, including the content 25a of messaging of or about the business unit and/or their commercial activities and/or management, contents of reviews, response to comments and reviews, time of response, effectiveness of response, effectiveness of corrective measures, the number of responses, number of other engagements, public response 66a to company response 66c, velocity of messaging, extent of reach, who is making the comments and/or responses, virility of communications, which pipeline of communications is working or not working, and the like. All of these metrics can be ordered or otherwise ranked by best to worst.

In a manner such as this, a user of the system 1, such as a business owner and/or administrator can access these rankings, system suggestions, and what this means for the reputation 66b of the business unit(s) and the organization as a whole via a simple user interface provided by the dashboard 22. Additionally, these evaluations may also be viewed over a period of time so as to determine trends in activities, communications, and their effects, and/or to determine why such trends, up or down, is occurring. As indicated herein, the system may make suggestions as to how to change consumer engagement, or may implement such corrective measures automatically. In various instances, this information may be presented in a variety of forms, such as in a table, a graph, a bar graph, a pie chart, a diagram, and the like, where the most relevant data is highlighted, and which will allow the user to change the order of such presentation, such as by selected metric, such as by clicking on the metric.

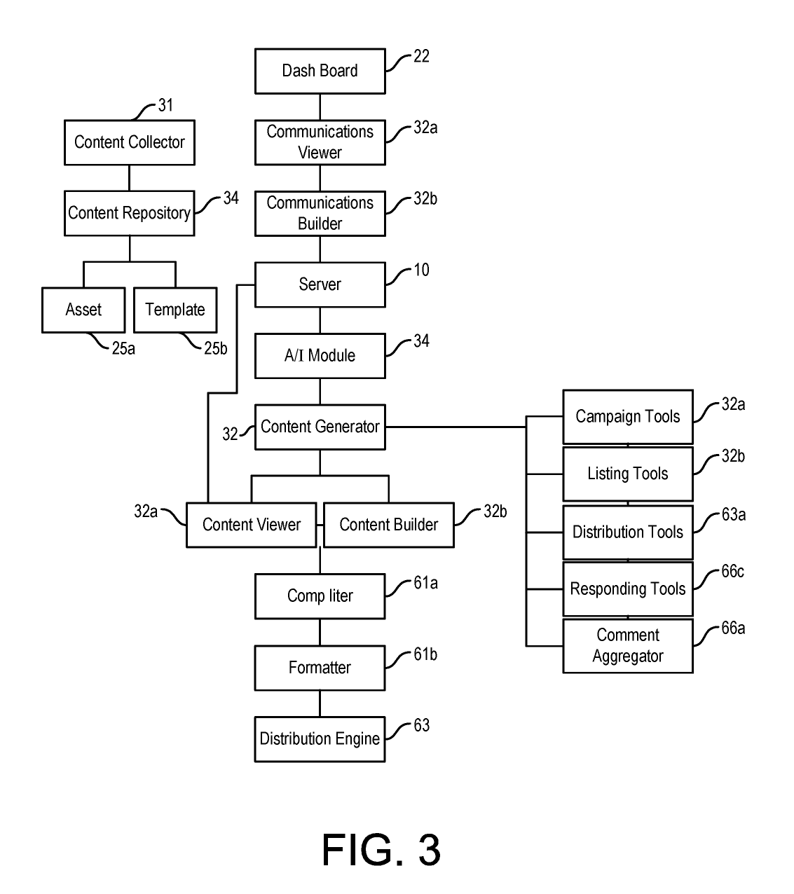

Accordingly, as can be seen with respect to FIG. 3, the system 1 herein disclosed provides a variety of tools, which may be configured to help the user generate and/or deliver messaging throughout the system 1, including message generation tools 32, campaigning tools 32a, listing tools 32b, distributing tools 63a, responding tools 66c, and the like. Particularly, in various implementations, the system 1 includes a server 10, such as a cloud based server, that serves as a centralized platform architecture for content collection 31, generation 32, and distribution 63 across multiple social media pipelines 23 and upwards and/or downwards along a multiplicity of locations, which may span across a city, multiple cities within a state, multiple states within a nation, and internationally, such as globally.

The system, therefore, may be configured for being accessed from a variety of different locations, and, thus, as explained below, the system may be configured for determining and accounting for the geographical region wherein the communications is being configured for distribution. Hence, the A/I module 54 may be configured for performing one or more analytical functions in a manner that weighs various different metrics based on various geographical data. For instance, a communication 250 crafted by the national headquarters, may be modified by the system 1, or a user using the system, so as to better fit the demographics of a local target population.

Accordingly, in various instances, the system 1 may be configured for allowing different users to gain access and to use the system with a variety of levels of control functionality, e.g., the ability to approve or disapprove the distribution of a communication. For instance, different people within a given organization 100 may be given different permissions with respect to the content capable of being generated, e.g., what templates, images, and texts that may be employed, and/or to whom it may be distributed. Hence, based on such permissions, different users may be able to enter into different environments of the dashboard 22, e.g. of the project viewer 32a and/or communications builder 32b, and may have the user roles that generally or specifically match their roles in the organization.

In such an instance, a local communications manager may have a more limited access to a local network of the system, while a regional manager may have greater permissions to use the system, and likewise a national or global manager may have global permissions to engage the system to generate and distribute information entirely throughout the system and its various networks and pipelines. Specifically, the system architecture is adaptable so as to mirror the very structure of the organization employing the communications platform. For example, in one use model, taking a single social media pipeline 23, like FACEBOOK® or TWITTER®, every second there are on average about 41,000 or more posts or tweets being uploaded and/or distributed by various FACEBOOK® and/or TWITTER® users, which amounts to about 2.6 million posts a minute, 156 million posts an hour, and about 3.7 billion posts a day, so on and so forth. Accordingly, on either of FACEBOOK® or TWITTER® alone there are billions upon billions of posts being created and distributed per week.

This amount of traffic makes it very difficult for a business 100 to keep track of and/or collect communications 66a that may concern it, and when sending out communications 66c it makes it difficult for the company and/or its communications 300 to standout, to reach consumers in a meaningful way, and to be effective in its messaging and advertising campaigns. Specifically, without a clear communications strategy catered to the medium 23 being used to communicate, in this instance, FACEBOOK® or TWITTER®, the messaging can easily get lost in the noise of the sheer volume of posts and/or tweets, etc. being put out there every day. Additionally, without a clear communications protocol, it can be easy for the messaging to be misinterpreted, and/or present messaging may be inconsistent with prior messaging.

The present platform helps solve this problem in part by helping a business owner 100, a communications director thereof, an advertiser, social media influencer, or other organization or individual to access the system 1, e.g., remotely, employ the various communications modules of the system and/or analytics functions thereof so as to craft communications 250, such as messages, advertisements, reports, and the like, which communications 250 may be delivered across one or more communication platforms and/or via one or more social media pipelines 23, and to distribute its messaging to its co-workers, employees, franchisees, consumers, customers, and/or followers, such as to those signed up to follow them on that medium. In various instances, a content builder 32b may be employed so as to help a user generate audience specific content 25a, which builder 32b may also offer suggestions to the user based on analytics run on the pertinent potential user demographics and/or content templates 25b, so as to more effectively engage consumers.

Particularly, in certain embodiments, the system 1 may include a data repository as well as content builder 32b and/or content viewer 32a, which builder 32b is configured for generating content 25a that is specific to the targets, e.g., consumers or followers of a particular business, organization, group, or individual 100. In such an instance, the builder 32b may initiate, e.g., via a suitably configured content collector 31, the automatic scouring of various online webpages 24 and/or databases, e.g., cloud based databases, to find content 25, e.g., online articles, technical manuals, blog posts, and/or other information available in the public domain, so as to generate a content database 34 for the user, which content 25 may be offered to the user as possible content 25a to be formatted and distributed to the various consumers associated with the user.

Particularly, a content specific media repository 34 may be provided, where the repository 34 stores information and/or other data 25a determined to be of potential relevance to the user and/or their consumers, co-workers, and/or followers. The media repository 34 may also include one or more media templates 25b. The media template 25b may be any type of framework within which messaging 25a may be incorporated so as to produce a communication 250 for delivery by a suitably configured distributing element 63 of the disclosure.

For instance, the communication template 25b may be configured as an e-mail message, a letter, a text, a SMS, an instant message, a sentiment, a post, a circular, an announcement, a report, an evaluation, a recommendation, a critical analysis, a table, a graph, a chart, a presentation, a power point, an advertisement, and the like. In various instances, the template 25b is configured for receiving the asset 25a, for being integrated therewith, so as to produce the communication 250 in the selected format.

In such an instance, the system may include one or more a communications builder 32b, a communications viewer 32a, a communications compiler 61a, a formatter 61b, and a distributor 63. For instance, the system 1 may be configured for allowing a user to engage an interface 22 of the system and thereby build their own communication 250, or the system 1 may be configured for automatically generating the communication 250 itself.

Particularly, in one embodiment, the system 1 may include a user interface 21, such as a graphical user interface, presented at a display. The graphical user interface 21 may be configured as a dashboard 22, which dashboard 22 will allow the user to engage the communications builder 32b of the system, such as via a suitably configured communications viewer 32a. In such a manner as this, a user can engage the communication viewer, 32a e.g., via the dashboard interface 22, and thereby access the communications repository 34, where they can select an appropriate communication template 22a, e.g., email, report, advertisement or other offer, and the like, and can further select a communication asset 22a for integration within the template 22b, e.g., via the compiler 61a.

The communication asset 25a may be any form of data packet that may be integrated within the template 25b so as to produce a coherent communication 250. For example, the communication asset 25a may be an image file, such as a GIF, JPEG, an animation, a text file, a graphic file, a report, a PDF, or any other form of data, such as data collected by the system 1. Such data may be searched and collected via a suitably configured API or web-crawler 12 that is adapted for searching for online content 25 having elements determined to be relevant to the user, which content and/or data may then be stored in the communications repository 34 of the system 1, thereby allowing a user to search, view, and if appropriate select the content 25a for incorporation into a communication 250 of the system 1.

With respect to the evaluating and collecting of content for incorporation into the content repository 34, the system 1 may employ several different criteria by which to determine whether any given content 25 is relevant to a particular user of the system 1. For instance, in one instance, as explained below, an artificial intelligence (A/I) module 54 of the system may be employed to weigh the various factors of the system, determine trends with respect thereto, and may configure the content collector 12, e.g., API or web crawler, so as to collect content 25 from across the web for inclusion into the repository 34.

It is to be noted that with respect to the above, in one implementation, the system 1 may be configured for allowing a user to engage the communications builder 32b so as to build the communication 250 of their choice, using user selectable parameters. In certain instances, in facilitating the user for the building of a communication 250, the system 1 may generate a number of questions or present a number of prompts that are directed at eliciting responses from the user so as to better define what the purpose of the communication 250 is, and just what content 25 the communication 250 should contain. However, in various instances, the system 1 may be configured for performing these functions automatically, such as without recourse to the specific inputs of a particular user. For instance, the system 1 may determine relevant content 25 based on user-identified preferences or system determined preferences of the user based on their engagement with the system, specifically, or their usage of the Internet more generally.

Particularly, in various embodiments, the A/I module 54 of the system 1, as described herein below, may be employed to determine a user's usage patterns, their engagement with the system 1, their connections via social media 23, their friends, the people they follow, their web of connections, such as via FACEBOOK®, LINKEDIN®, and other social media pipelines, the comments and votes they make online, and the like. Likewise, for a user is an organization 100, the A/I module may mine the corporate structure, the separate business units, list of employees, nation-wide franchisees, as well as their respective online engagements, so as to determine, weigh, and collect content produced and/or published by one or more of these entities, which may then be collected and stored for future use by the system or its other users.

In evaluating content 25 to be selected for inclusion into the repository 34, the data-collector 31 may focus on content 25, such as keywords, addresses, e.g., physical or online or IP or URL addresses, phrases, sentiments, characterizations, verbiage, usage, idioms, images, trademarks, copyrights, photos, and the like, such that content 25 containing these elements may be flagged and send for further evaluation by the system 1 and/or its users. Once one or more of the content template 25b and asset 25a has been selected, e.g., by a user and/or automatically by the system 1, such as via the communications builder 32b, the compiler 61a of the system 1 may then be engaged so as to integrate the selected communications asset 25a into the selected communications template 25b. In various embodiments, this integration may be performed by the compiler 61a automatically, real-time, and on the fly, such as by the system itself, or in response to user selected parameters.

Further, given how ubiquitous handheld computing devices are, and how their screen sizes differ greatly from one to another, a formatter 61b of the system is therefore useful for insuring the formatting of the communication in a format that is capable of being rendered in the appropriate size of the screen of the mobile device to which the communication is to be distributed. Accordingly, another useful component of the system is a distributor engine 63 configured for sending one or more communications 250 to one or more users or targets. For instance, the system may include a distributing element 63 that is configured for sending a generated communication 250 to one or more recipients, such as by one or more of unicasting, multi-casting, or broadcasting. In a manner such as this, a communication 250, such as an email, a report, or an advertisement, may be generated automatically, such as in response to a received trigger, such as a keyword, sentiment, review, etc. entered at a social media interface, where in reaction to the received trigger the communication is generated and sent to one or more users for whom the communication may be relevant.

Accordingly, the devices, systems, and methods herein disclosed are useful for allowing a business organization 100 to effectively monitor, assess, analyze, and control its messaging from a single platform horizontally across its entire organization, or a portion thereof, and vertically down through all the various social media pipelines selected for use in communicating with its customers and/or consumers. The automatable systems presented herein are flexible and scalable, such that a company's goals with respect to its effective communications can be implemented and assessed for effectiveness of their communications to meet their goals.

For instance, if a company's goals are to reach 5,000 new customers, such as by running a new ad campaign or launching a new promotion, the system 1 can at least partially automate the generation of the campaign communication, can launch its delivery across the nationwide or global reach of the organization, and down through the various selected social media pipelines 23, and can then evaluate whether that goal of reaching 5,000 new consumers was achieved or not. The system 1 may also then give recommendations as to how to better effectuate such campaigns 250 and communications in the future based on the analytics derived from the present campaign. Specifically, once the campaign communication 250 has been generated, the system 1 will then post, manage, and facilitate the organization's 100 response to consumer queries 66a regarding the campaign across all social media pipelines 23, such as at a single dashboard presentation 22, without having to manage any one single social media pipeline itself.

As can be seen with respect to FIG. 1-3, the present devices and systems as well as their methods of use may also be configured as a communications system servicer. For instance, the system 1 may be configured as a content generator 32 so as to produce one or more libraries 34 of approved and useable content 25. For this purpose, the content 25 may be derived by the system searching the web for content 25 specific data already created and present on the web, collecting that data, reformatting that data so as to be within company selectable parameters, and repopulating that data with company particulars, thereby creating a communication template 25b that a user may review, edit, and post to its customers down along one or more social media pipelines 23.

These libraries 34 may then be made accessible to all business segments, e.g., franchisees, throughout a given region, e.g., nationwide. The scheduler 40 may then perform one or more analytics module 62 to determine peak traffic time within each region and may schedule the delivery of the generated communications at peak traffic times throughout that region, such as where peak traffic times differ region to region. Such scheduling and delivery may be configured so as to be repeated periodically, such as daily, weekly, bi-weekly, monthly, semi-annually, annually, and the like. In certain instances, a conflict check module 26 may perform a conflict check, prior to the posting of any communication 250 so as to ensure against contrary messaging going out through the system 1, and/or may check local media listings to ensure there is nothing at conflict with a message being sent out by the company 100 and the general messaging being delivered to a specific community, so as to avoid potentially embarrassing miscommunications going out to a community for whom the messaging is simply not relevant and/or would be considered offensive. Such conflict checking may also be employed in a manner so as to keep franchisees or regional business segments located in proximity to one another from competing for the same customer base.

Additionally, the scheduler 40 in addition to the content generator 32 can be configured so as to continue to generate new content 25a on a regular, periodic bases, such as daily, weekly, monthly, and the like for as long as desired, and/or until a certain amount of useable content has been generated. In a manner such as this, a week, a month, or a year's worth of content can be generated, such as on a regular basis. Once generated, the scheduler 40 may then send a link to one or more users whereby clicking the link the user is able to review, edit, and/or deploy that content, easily such as via a suitably configured mobile application on their cell phone, computer, and the like.

Particularly, once a communication 250 has been reviewed and approved, it may then be selected to be posted and/or otherwise sent to consumers, via the distribution engine 64, such as immediately or periodically, such as by merely pushing a launch button. For example, the acceptance conditions can be any suitable form of acceptance and condition, such as the post will go unless declined, the post will not go out unless accepted, so on and so forth. Or a condition precedent may be set up whereby a certain condition needs to be met prior to the post going out, which condition precedent may be an event that needs to occur, like change a format, which such an event has occurred the post will then be launched automatically.

Prior to launch, system users may create a dialog whereby they can leave comments for others to review, discuss, and/or implement prior to posting, so as to allow for feedback to be received and accounted for throughout the organization prior to launch of the post. Additionally, the system may be configured such that if a post is rejected, for any or a specified reason, the system will automatically withdraw the post, and immediately retrieve the next post in the queue for presentation and review. Of course, if a mistake has been made, or for any reason whatsoever, the system may also be configured to cancel and/or withdraw or retrieve back any communication as desired by the user.

Accordingly, once all of the elements of the system 1 have been configured appropriately, the system 1 may be adapted for controlling communications across the organization 100 and down through the various social media pipelines 23 automatically, such as with as little or as much user control as desired. For instance, once the appropriate parameters have been set up, the system may be configured to run automatically, with little to no user input, or the system 1 can be set up such that prior to any action at any level of decision making to occur, an approval must be obtained. Likewise, once suitably configured, new messaging and new posts may be generated, evaluated, and maintained throughout the system 1, and in accordance with the structure of the business organization 100, automatically and/or with little need for organizational input and/or control, and this may continue until a certain event has been reached and/or for a given period of time, thereby creating an automated loop of service.

In a manner such as this, a communications account manager may be able to oversee hundreds, to thousands, or more accounts easily from a single desktop view. Further, the communications system itself may be layered with logins and/or permissions such that the overall system is capable of being architected in a manner so as to mirror the levels of authority and/or control within the organization itself. Additionally, in some embodiments, the system 1 may be configured to search a specified region, such as for keywords, which may be important to the organization, or one of its parts, such that when identified, the system may generate targeted communications relevant to the poster of the comments, such as for a specific communication with that poster, or for a general communication for any others within the area having the same concerns.

For example, if the organization 100 is a dentistry group, or other goods or service provider, and a potential consumer within a given region where the organization, e.g., a dentist office, is located, such as within a determined radius of influence, e.g., 2, 3, 4, 5, 10 miles, etc. post a comment about having a need, e.g., toothache, the system 1 for the local business may identify the poster, generate an advert or other communication targeted to the poster's concern, and post a response in a manner so as to win the poster's business by incentivizing them to come into the dentist office for a checkup and/or a remediation. This may be done with respect to any keywords related to a business serving a need demarcated by the use of those keywords, such as, for example, a restaurant responding to a post of someone being hungry, or an auto shop responding to a post of a car breaking down and the like. Hence, the system 1 has the ability to look at keywords being used throughout social media and/or review web-sites, within a given region, and for preparing a message to the user of those key words, and/or other potentially interested party, and posting in response thereto a communication designed to solicit the business of that poster, or other party similarly situated.

The system as a whole and/or any of its component parts can be monetized in a variety of different ways, such as by an at use paradigm, where the user pays per use; at a modular level, where the user only pays for the modules they use; a monthly fee for using the whole system or parts thereof; or a subscription and/or per user fee, where the fee is dependent on a number of users using the system; and a data transfer rate, where the user is being charged based on the data being exchanged on the system; an annual contract, or other period of contract being paid regularly throughout the year; fees based on the number of communications being sent, or number of data being stored on the cloud; combinations thereof, and in other like manners.

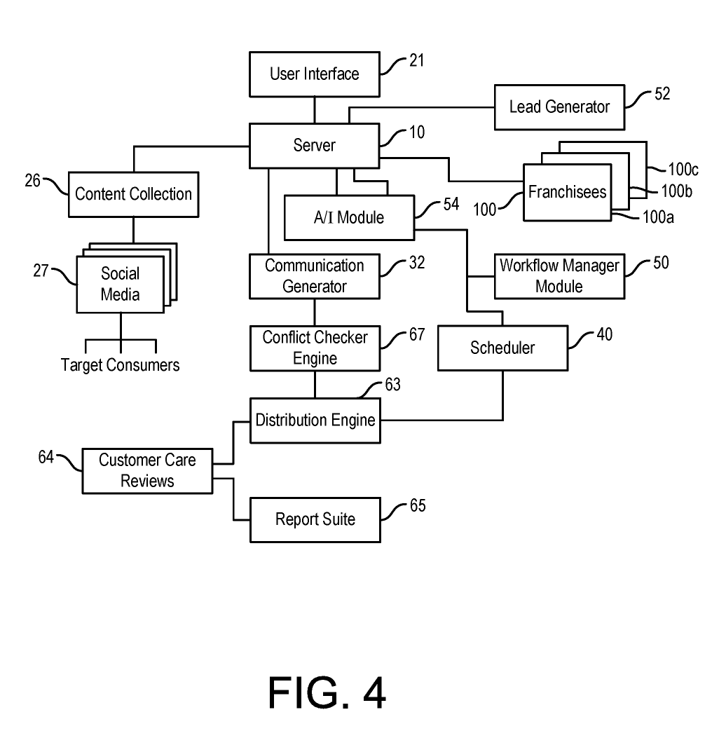

FIG. 4 presents another configuration of the system, devices of the system, as well as their methods of use, such as for controlling and managing content on social media and/or various web-pages. For one particular use model, the system 1 may be employed by a global, national brand 1 having tens to hundreds of thousands of franchisee locations 100a, 100b . . . 100c, all of which may be employing social media 23 to engage consumers. In such an instance, each one of these locations 100a, 100b, 100c may be addressing a local consuming market by use of one or more social media pipelines 23. As indicated above, this situation has been known to cause difficulty in keeping messaging throughout the organization and with its customers consistent. Accordingly, the present apparatuses, systems, and their methods of use have been developed to overcome these difficulties.

Accordingly, the present communications platform system 1 allows users thereof to employ a single user interface 21 to control all of the communications being published, e.g., made available online, throughout the organization and among all publishing pipelines serving all local markets. Given all the necessary system wide approvals, as set up within the system parameters, e.g., by the system administrators, communications may be distributed by the company everywhere, but at the appropriately scheduled time, as referenced above. However, as indicated above, even though a centralized communication 250 can be crafted for distribution, generally, in certain embodiments, the system, or a local user, can customize the communication, via a local user interface 21 of the system, so as to be catered to their local market. The system 1 is scalable such that these edits and/or modifications can happen substantially simultaneously throughout the system 1, e.g., for all local markets served.

Hence, the system 1 allows for the generation, editing, sharing of assets, receiving appropriate approvals, all substantially simultaneously and globally throughout the system, e.g., in all of the markets it serves. It is the approval process, as discussed herein, that allows for centralized and/or decentralized control of the messaging. For instance, as indicated, in a corporation there is a hierarchy of authority, and so, the communications within and throughout the system may be set so as to follow those approvals, which approvals may be set up as a series of user access control parameters. Thus, communications 250 may be set up so it must be approved by one or more levels of the architecture before the messaging is generated, configured, approved, and/or goes out.

As there are different roles and responsibilities within a company, different levels or approval may or may not need to be sought based on how the system use is set up. Such user access controls can be defined on the roles of the company, such as the CEO or Marketing Director could have full access, other marketing administrators could have a more somewhat limited access, and regional managers and/or franchises may have an access based on their regional and/or local authorities, and/or various work groups can have somewhat smaller authorities, and/or require more significant approvals when engaging with the system. Hence, with each of the roles defined, there will be a list of functions for which an operator at that role is approved to engage in, with respect to generating and/or distributing communications, however, for conducting communications above that role, will require a greater level of approval. The various roles and functions can be set forth by parameters that establish what modules the user can access, how much he can use of those modules and for what purposes, and what reach he or she has with respect thereto.

In various instances, the director of communications and/or admin user may have access to one or more components of the communications generator 32, the scheduler 40, the lead generator 52, the workflow modulator 50, the reporter suite 65, the reviews and customer care centers 64 and the like. In certain instances, the A/I module 54 of the system 1 may be configured for ensuring message generation and distribution is consistent and optimized, such as by catering message content to local environments, and determining high traffic times for message delivery, and/or directing which communication pipelines are employed for delivering the message. Further, as noted, such communications 250 may be subjected to a conflict check engine 67 so as to be sure various communications 250 serving localized communities within proximity of one another include different content and/or are structured using different templates 25b. In manners such as this, the organizational consistency in messaging may be assured, e.g., via system wide control and management from a centralized location or access point.

Another feature of the system 1 is the tracking and monitoring of conversations amongst consumers in local and global markets. Particularly, a useful benefit of social media is that it allows various consumers to share their experiences of the organizations with which they interact. In such instances, when service is good, communications amongst consumers is usually good. However, when service is bad, communications amongst consumers may not be good. In such instances, it is useful to have the system collect the various communications about the company, both locally and globally, to aggregate and evaluate that data, and to generate a report thereon, and/or to implement corrective measures, e.g., automatically or with corporate approval, in response thereto.

For instance, such consumer communications may be made directly to the company, such as via email or a recorded phone call or message, a response to a survey, or a posting on the company online page; or may be made indirectly to a review site, or a general conversation the consumer begins on a social media platform, such as a posting; or may be other commentary posted on an online medium. As such, the system may be configured for collecting and aggregating all of these communications instances, breaking them down into content types, which may then be evaluated by the system, as discussed above.

Accordingly, the system may be configured for identifying and collecting this data from a wide variety of such online resources, by a number of different manners. Such data may be identified by keywords, recordings, natural language identifiers, text recognition, facial recognition, image recognition, geographical location, associated metadata, and the like. Once identified the data can be flagged or otherwise tagged for collection and/or response. In various instances, portions of a communication can be tagged and collected, but stored in different folders in the library, such as based on type of communication to which they would refer, such as based on topics such as activities, foods, product characterizations, and the like. Additionally, communications can be identified, collected, aggregated, and/or responded to, even when they do not mention the company's name, but rather simply mention something pertaining to or of interest to the company. For example, where the company is a service provider within a given region, and a social media user post a need for the service within the identified region, the system can flag and/or tag the conversation and either automatically respond with an advertisement or an invitation from the service provider, or can suggest the service provider to personally respond in like manner.

The collection and response to this data, is therefore, another important feature of the system, so as to maintain and/or increase positive consumer sentiment, and thereby to enhance the reputation of the company. Specifically, as indicated, the system may include a search and review and/or reputation engine 66 that is configured for collecting, reviewing, and evaluating content, and either responding directly thereto, or generating a suggestion to a user as how best for them to respond so as to promote customer care 64 of the company 1. In certain instances, the content collection engine 26 may be configured for not only collecting data, but may also weight it, classify it, and then aggregate it by one or more metrics, such as by content, type, score, trend, function, sentiment, and the like.

Likewise, the content to be collected can be run through one or more filters, so as to assist in data content identification and collection. Such filtering may be performed in accordance with any dimension of interest, such as based on keywords, sentiment, positive or negative reviews, star count, pipeline, network, geographical region, and the like. In certain instances, this data may be date limited, such as by a number of days, weeks, months, e.g., 3, 6, 9, years, and like. For instance, when a company user of the system receives a star rating, e.g., 3 starts, etc., this may be flagged for review by the company, and the system may implement or suggest a corrective regime devised to raise the customer rating on the reviewing or other websites. In such an instance, the corrective measures may be a plan to elicit reviews from customers who have had positive experiences of the company, such elicitation may include the sending of a post, comment, email, or other communication requesting the completion of a review.

In various instances, the system may generate the review and may or may not send it to the user for their approval before posting on the review website. As indicated, these reviews may be aggregated and be posted en masse or one at a time, or as completed basis, e.g., the number of positive reviews needed to move the rating to a desired point may be determined by the system and/or generated by the system or requested to be generated by its customers. Other suggestions may include corrective actions that the company can take to improve consumer experience, such as based on suggestions made by consumers and/or collected, aggregated, evaluated, and/or ranked by the company.

Additionally, once collected, analyzed, and/or aggregated and stored in a suitably classified library folder, various tasks may be calendared for the communication and assigned, such as via the workflow manager. For example, a collected communication can be broken down by its content and/or subject matter, and issues with respect thereto can be identified, and tasks may be assigned to various working groups within the organization, such as a customer care group that is tasked with responding to positive or negative reviews, an advertising group tasked with sending out coupons, a communications group tasked with determining what is working well and what is not, and thereby creating new communications, a regulatory group, HR, research, sales group, and the like.

Particularly, the communication can be analyzed and/or be broken down into component parts, such as by generating a word cloud, and may be analyzed to determine why a given communication or phrase or word is or is not working, and what is causing positive or negative reviews. Word clouds can also be generated based on words consumers use across various social media pipelines. Of course, once a communication has been broken down and tasks assigned, a notification may be sent out to the working group members notifying them of a task that needs to be completed. A deadline may also be assigned, and if desired, a tasked user may re-assign the task to another user, such as one more apt to complete the task. A reminder or notification can be sent if a deadline is coming up or missed. In various instances, for example, the communication and/or one or more of its parts may be sent to a review and reputation module that can perform one or more of the above referenced tasks automatically.

The review and reputation module 64 may be configured for use in relation to a given social media pipeline and/or to a given review site, such as YELP®, TRIP ADVISOR®, CITYSEARCH®, other review sites, and the like. Likewise, upon review a list of responses to the communication may be generated and presented at the user interface 22, which list of responses can be scrolled through, such as by swiping left, right, up, or down, such as for rejecting and/or accepting which response to implement. These responses can be pre-generated, from an approved list, such as one already set out by a user, or may be a system suggested response, which may be generated on the fly with respect to the analyzed data.

Further, as indicated above, an iteration of the reputations and review module may include the generation of one or more user profiles, such as user profiles of company advocates or detractors, such as where a graph of all commenters with respect to a company, both good and bad are graphed, ranked, classified, and otherwise commented upon, such as with respect to their predicted actions and/or responses to proposed communications, such as in response to proposed advertising. Accordingly, a web of interrelations between multimedia users may be generated based on the collected data, and their expected response to advertising to the company or its competitors may be determined and ranked, and various of the multimedia users may be employed as test groups for receiving and responding to various promotional ads, surveys, reviews, and other communications, such as via one or more received emails, posts, replies, or other such communications, e.g., via an automatic communications and/or email generator. In a manner such as this, web-users can be identified and ranked, e.g., based on who is, or can be, or who is not an advocate of a system company, and those who give positive responses to the survey can be thanked and receive discounts or coupons, and likewise with those who respond negatively.

For instance, a reputation enhancement campaign can be engaged in, such as to improve the reputation of a user company of the system, and/or to degrade the reputation of a non-user competitor. Such a campaign can be across all media pipelines, or just a select sub-group thereof, and if problems are identified, e.g., by those responding, the system can be improved with response there to and the respondent can then be emailed a follow up communication. Advocates and detractors can be identified, e.g., via the user graph, and each can be sent correspondence to improve the experience of the detractors, and give adulation to the advocates, and/or to reward them with discounts, codes, and/or coupons.

If the reviewer is commenting on a social media pipeline to which the system has access, direct response may be made through that medium, if the review site does not allow such access, the reviewer communication address data may be collected via a suitably configured crawler or previously generated mind-map, and the review can be sent a communication from the system, e.g., regarding an offer from a competing company within the system. For example, commenters, such as reviewers on social media or review sites may be identified by their user name, handle, other identifying data, their online interactions, actions, and/or patterns of behavior, published email address, phone number, address, and the like. Users may also be further identified based on their determined geographical location.

Accordingly, an aspect of the system, as described above, is both the collecting of a large amount of data, but as well as the aggregating of that data, with respect to one or more categories, as well as analyzing that data in accordance with one or more determined metrics. Hence, the system may be configured for receiving data, analyzing it, and categorizing it in a manner that presents the most relevant data for display, such as at the dashboard user interface, or for inclusion in one or more system reports. Specifically, given the use for the content, such as in generating a communication or report, that highlights the most significant factors for consideration by the system and its administrators.

A useful feature of this functionality is that it allows for a very large amount of consumer communications to be collected, flagged for subject matter content, may be separated into categories, and analyzed with respect to content in a spectrum from good to bad in terms of its ability to be used in future communications. This data may also be used to generate reports regarding the same. Such flagged data may then be ranked, and a response regime may then be implemented with respect to who and how to respond to these consumer communicators, such as in a hierarchy of response times and content being determined and going out first to those determined to be high positive consumer advocates, e.g., those who post often and positively; high negative consumer activists; and those who form core demographics for the company may be sent communications more quickly and more often, while those who tend to post less good or less often can be scheduled to receive different messaging that may be scheduled for less delivery frequency.

Along these lines, the system may be configured to determine when positive and negative trends are occurring and can take counter measures to either boost messaging content in delivery during a positive trend, as well as to boost corrective messaging so as to counteract a negative trend. Particularly, where a given communications is trending well or up with a lot of positive sentiment, that communication and/or its component parts may then be boosted with respect to delivering increased content within that market. Likewise, when messaging is down trending, the reason for the downtrend can be identified, the messaging modified, and new messaging sent out into that market, such as in boost mode. This boost mode may be automatically implemented, or only upon administrator approval.

In various instances, the system may be configured for purchasing advertising space and/or timing, wherein the amount of advertising to be conducted is in accordance with a predefined budget. In particular instances, the timing of the advertising spend may be set to coincide with one or more emergent trends that is occurring on an online platform, such as to take advantage of advertising or other messaging that consumers seem to be connecting with. Particularly, when certain messaging is being liked, up-voted, re-posted, re-tweeted, receives 3, or 4, or 5 stars, or an 80%, 85%, Or 90%, or 95% successful rating, and the like, the system may then deploy the budgeted funds to purchase the distribution of more advertising opportunity. In various instances, in response to such an uptrend, the system may authorize going over budget, if it determines the benefits outweigh the cost.

Hence, in a manner such as this, any time the communications of one location of an organization sends out messaging that is determined to be particularly effective, the messaging therefrom may be boosted for that location, and/or that messaging may then be deployed at other locations, such as by being boosted thereby as well. In various embodiments, the central corporate office may determine the budget, and/or the local locations can also set a budget or otherwise participate in, e.g., match, the corporate office's budget. In this manner, those communications that are determined to be particularly effective may be the ones receiving the greater percentage of advertising spend.

Likewise, the system can determine which locations are performing the best, and can then divide the advertising budget so as to spend more on advertising in those locations doing well, and less in those locations not doing as well. The system, therefore, can run analytics, determine costs, and allocate budget spending based on determined rank and effectiveness, e.g., location by location, region by region, so as to get the most benefit per dollar spent. For instance, a cost per advertising distribution can also be made to determine which social media pipeline should be used for the sending of communications, such as with respect to receiving the best return on investment, e.g., the social media platforms themselves may be analyzed and ranked by the system per location so as to see which medium is best for which location and/or for which communication. The cost of the advertising can be paid for by a central corporate account, a separate franchisee account, or other account, or may be split amongst them.

Further, as explained herein, the system can monitor competitor activity such that as a competitor is receiving communications signaling an uptrend or downtrend, the system can then flag this and initiate measures so as to take advantage of these trends. For instance, when a company is failing to serve its customers well, the system can flag these negative comments, and can then initiate an advertising campaign for a system user so as to address this inefficiency in the market place. The system may be configured to do this whenever there is a negative review of a competitor's product or service.

As indicated above, the system may be configured to perform one or more analytics, and based on the results thereof may make one or more suggestions with respect thereto. For instance, the system may determine, e.g., automatically via the A/I module, which communications in which markets are working and as such, may automatically take measures to monopolize on those opportunities, or may make suggestions as to how to do so for approval by system users, e.g., administrators, such as in a generated report setting forth all of the evaluated metrics and the effects thereof with respect to suggested responses, e.g., generated by the system, and/or suggested response times. The generated suggestions may take into account the operating communications budget of the person or organization running the communication system, and as such the suggestions may be made to maximize benefits of communications, e.g., for content and region, versus the cost and/or time for generating and distributing that content, such as when tracking and taking advantage of trends, such as by increasing advertising and/or other messaging during such trends, and thereby maximizing communication velocity during those identified periods.

The system may, therefore, be configured for generating a ranked, itemized list of activities or tasks, e.g., via the task management module, which would need to be performed in order to optimize messaging. Once a task list of suggested action items is generated, it may be delivered within the system for action item approval, which may be performed electronically by user interaction, or it may happen automatically, if the system is set up without approval being required. For example, an administrator may receive a report on analytics of system functioning, such as in an organization by organization, unit by unit, region by region bases, with a bullet point list of suggested action items to be enacted for each business organization, as well as a determined score of their predicted effectiveness, for each unit, for each region, and with respect to each product and the communications pertaining thereto. In a manner such as this, the system or module administrator may be presented a user interface as a dashboard on a graphical user interface of mobile computing device, whereby they can review and click a checkbox of the list of activities that should be implemented, pull up the analytics behind the suggestions, and then approve or disprove the suggested action items, e.g., via the dashboard interface. The suggested timing for approval and enactment of the action items may be taken into account when structuring the priority and/or order of the action item list.

Additionally, the system may be implemented to review and rank sub-units or local organizations within a larger, e.g., global, organization. For instance, the communications of a sub-organization may be analyzed and cross referenced with its performance, e.g., sales performance, so as to determine if their communications are a problem or a benefit to them in their conducting of their business. In various instances, the various sub-units of the global organization may be compared one against another, in this and other manners, and may be ranked, such as to determine if messaging is making one more effective than another, and/or determining how to model other groups after those groups whose communications are positively affecting their sales. Particularly, as discussed herein above, one of the modules of the system may include a review and reputation module, which functions to review content coming in to the system, as well as content being exchanged within a business organization, communications going out from the system, and the reviews of consumers who are the targets of those communications.

Another aspect of the system is a competitive analysis engine. For instance, as indicated, the system may be configured for collecting information via one or more online websites, to which websites the system may have a pipeline connection, e.g., via an API, or may be screened, monitored, and information collecting therefrom, such as by a skimmer, crawler, and the like, which information can give the system data as to competing companies, their products, their messaging, receptions and reviews within the market, the number of good, bad, positive or negative sentiments, e.g., including the volume thereof, as well as the competitor's response thereto, can be collected, aggregated, analyzed, ranked, and reported on, all by the system, automatically or via user intervention. In various instances, one or more suggested responses to the competitor, to the competitor's consumers, to the market generally, to the systems user's constituents, and the like.

The system can also be configured to identify the respective competitors, and the amount and type of conversations being conducted concerning them, and then can rank all companies in the segment to determine who is dominating the online conversation, how, and why. In such an instance, the company user of the system can then formulate a strategy, such as via the system, so as to respond to the generated business intelligence to take advantage of identified opportunities. The suggested responses can include taking advantage of a business opportunity, such as generating a responsive advertising or marketing campaign, direct communications to the competitor's users, reviewers, commenters, eliciting negative reviews regarding the competitor, generating negative reviews or comments, and the like. In response to such suggestions, the system may automatically, or upon approval, may implement the suggested course of action.

In a manner such as this a competitive brief or report may be generated by the system, e.g., automatically, which brief may set forth number and type of sales, number and type of advertising, conversion rates, success rates, positive or negative user reviews, comments, or sentiments, competitor trending, velocity, messaging time, content, and the like, and in view of this competitive analysis, a competitive response by a user of the system may then be performed so as to determine the best way for the user to compete with the identified competitor(s). In particular instances, one or more competitors may be ranked based on their ability to effectively address the marketplace, their activities and the effectiveness thereof can be analyzed, and things that are working can then be implemented by the system, and those things that are not working may be exploited by the system, if desired. This information may be presented to the user, e.g., via the dashboard of the user interface, such as in the form of one or more of graphs, tables, charts, reports, animations, and can include information about competitor competitiveness, strength or weakness in messaging, effectiveness and/or trends in messaging, and suggested responses thereto so as to be more competitive and/or proactive to market conditions or other business trending, which can be presented to the users via one or more check boxes on the user interface.

A further aspect of the system is an advertisement generator. Particularly, as discussed above, the system is configured for collecting and analyzing a lot of data, such as data about consumers, their preferences, habits, and their actions. This data, therefore, can be used by the system so as to generate specific communications, such as advertisements, that are specifically configured to the preferences of their identified consumers, or are catered to generate new consumers, e.g., generate new consumer leads, thereby eliciting growth of the company consumer base.

Accordingly, the apparatuses, systems, and their methods of use, as described herein are useful by small and large corporations to control their communications, ensure positive customer engagement, grow their consumer base, and specifically target their customers that are specifically designed for them or their demographics. In particular instances, the present system can do away with the need for a separate advertising agency. Specifically, today, advertising agencies are typically employed so as to control the communications of a company. However, to do this often requires the employment of several different employees performing several different functions, such as for collecting, reviewing, and analyzing content, generating new content, and responding to customer conversations online, so as to protect the reputation of the company, e.g., brand, as well as a set of different employees generating advertising for the brand. The present system is configured for performing all of these functions, and more, in an automatic and consistent manner, such as based on the determined analytics of the system.

Hence, where a national company has a 10M advertising budget to spend on all of its locations, but further has 5,000 locations, that means that each location gets $2000/yr or $160/mo. Accordingly, although the entire amount appears high, when taken in context of the company as a whole, spending $160 a month per location is simply not enough. However, often times spending more is cost prohibitive. The present devices, systems, and their methods of use, as disclosed herein, overcomes these and other such deficiencies in the market. Specifically, as set forth herein above, the system provides a distributed, cloud based server for generating advertisements. As indicated above, the server is associated with a media repository, e.g., a library, for storing communication templates as well as communication assets, such as for incorporation within the templates, such as for the automatic generation of an advertisement. More specifically, the system may include a communication builder that builds an advertisement, such as in response to a triggering event, such as those described herein, and/or may include a project viewer so as to allow a user of the system to self-generate an advertisement.

In various embodiments, the advertising module may include a compiler for integrating a selected communication asset for integration into a selected communication template so as to produce the advertisement. A formatter for formatting the advertisement in a manner so as to be displayable in a format that matches the display screen on the unit to which the advertisement has been sent. Likewise, a distribution engine is included for the broadcasting or otherwise transmitting or sending of the advertisement.

Hence, the system may be configured for allowing a user to or automatically generate and distribute an advertisement. In certain embodiments, the advertisement may already be generated, and instead, the system is configured for determining traffic and trends and at the right time selecting an appropriate advertisement, such as from the library to transmit, such as in a boost mode, so as to take advantage of the velocity behind a trend and to drive traffic to the businesses of the system. In a manner such as this, the reach of the company and/or a communication, such as an advertisement, e.g., its penetration into the public forum may be enhanced or otherwise increased. In other instances, the advertisement can be generated on the fly, such as by capturing data from one or more webpages, such as a person's social media page, and incorporating the data, such as text, images, graphics, colors, animations, video clips, and the like, into the advertisement being generated, such as in a manner so that it does not look like an advertisement but rather a posting from a usual respondent using the social media pipeline, in essence, so it looks like any other typical piece of content being posted on the media page. Configuring advertisements to mimic content is useful for passing filters and increasing reach such as by promoting engagement and/or generating new customer leads.

In various instances, the system may be configured to generate positive or negative reviews, to elicit others to review and accept and send, or be sent to other 3^{rd} parties to generate. The reviews may be positive or negative, may be for or against the company, may be user or system generated, and posted or otherwise distributed. These communications may be made to build or degrade a user company's or competitor's reputation.

For instance, positive or negative reviews about a competitor may be collected, aggregated, and analyzed to see what is and what is not working so as to mimic, e.g., define rules to implement, what is working, and to avoid what is not working, such as with respect to system user communications and/or activities, such as with respect to auto-generated communications. In various instances, a regional analysis can be determined to determine from where messaging is being communicated, and based on its location of origination, and various other metrics analyzed, as set forth herein, the messaging can be flagged as being suspect or false, such as where the location of origin is India, China, Taiwan, Mexico, the Philippines, Russia, the Ukraine, or other known or unknown origins of false reporting. Likewise, the system may be configured, as described herein, to review communications across pipelines, to parse them into phrases and words, and based on the commonality of their usage, idioms, cadence, frequency, sentiments, and the like, may identify and flag and/or call out fake reviews, and may then report on the same to the system or to an associated social media page/administrator.

As described above, a unique feature of the system is the graphical user interface that is presented as a dashboard at a client computer that allows a user, such as a system administrator with all the appropriate approvals to access, monitor, configure, instruct, and/or otherwise control the communications platform system. For instance, all of the running of the backend processing for the implementations of the various analytics protocols so as to determine the particular results useful for organizing and implementing the various functionalities of the system may all be presented at a control module, which control module may be presented in graphical representation on the dashboard interface. In this manner, a user can logon or otherwise engage with the control module of the dashboard interface to select what data is to be collected, what analytics are to be run on the collected data, and may decide how and in what order that data is to be presented to the user, such as for use in generating new communications for delivery throughout the system. Once the user has entered their preferences so as to determine the look and feel of the dashboard, e.g., what data is to be relevant, and where it is to be presented, as well as what data containers will be used to present which results, in a manner so as to reflect the users desires as to what they desire to see first, then the system can constantly be updating the information in these data fields, such as automatically, e.g., periodically or at real time.

Particularly, with respect to generating a look and a feel for a communication or an advertisement, the system can scour social media pages, can collect images and texts, and other data, which can then be integrated into a communication so as to resemble the look and feel of the social media page(s) from which the data was collected, such as for the building of communications as discussed herein. In such instances, the headline, descriptive text, and images can all be configured to model the look and feel of a webpage or its contents. At this time, the dashboard can also present the user a selection of options, such as via one or more system generated interview questions, or drop down menus, or presented text boxes, which user selected options may elicit from the user how they want the various data to be considered, aggregated, compiled, analyzed, results presented, and content ranked, and/or organized into a communication, and when and how to be sent.

In various instances, the system may be configured, e.g., via the A/I module, so as to adapt the dashboard based on the users usage and can then automatically configure itself to their determined preferences. Or the system may configure the dashboard in accordance with one or more pre-set criteria, such as what has been determined to be the most statistically relevant to the user and/or their identified function, e.g., within the organization. Further, in certain embodiments, the dashboard can be fully customizable, such as where the dashboard may include a template having a series of containers, which containers can be configured by a user to be in the size and shape desired and placed within the overall template as desired, thereby allowing a maximum in flexibly as to how the containers of the template are to be configured therein.

Likewise, once the containers of the template have been configured, then the user may select which content and/or which analytics of the system are to be run and results presented by which container elements of the template. In a manner such as this the user is capable of creating a user interface that includes a graphical user interface, e.g., dashboard, that is configured for presenting them that data and analytics that is most pertinent to performing their functions, e.g., for performing their job within the company. In certain embodiments, the generation of such individualized dashboard interfaces may be performed by simply dragging and dropping the selected data/analytic elements, e.g., processing or viewing modules, into the containers of the dashboard template, which may then get integrated therein so as to build a cohesive interface adapted to the specific needs of the user. Hence, once the user activates the system, e.g., by logging into the dashboard interface, they will immediately be presented with the data they deem to be the most pertinent to fulfilling their function.

Although, these procedures have been described with respect to the generation of a customized dashboard interface, it is to be noted that these procedures and/steps may also be employed in many other instances within the system, such as with respect to generating a communication, generating an advertisement, generating an evaluation, generating a report, and the like, such as where the dashboard allows a user to select a template, e.g., for messaging or reporting, etc., where the template includes containers that may be organized with respect thereto, and may then be filled in with the user selected data elements, which data elements are derived from one or more of the modules of the system, such that each container within the template can present the results of the functions, e.g., analytics, performed by the operations of the selected modules can be presented at the designated container space at the designated position of the template, e.g., for viewing at the dashboard. In a manner such as this the dashboard may not only be set up, but all of its content fields can be populated, communications can be crafted, edited and sent, such as by dragging and dropping, drop down menu, and the like, and reports as to the effectiveness thereof may be generated and sent, all via the user configured dashboard graphical interface.

Another unique feature of the system, generally, and of the dashboard, specifically, is a user interface that puts all of the powerful analytics of the system at the fingertips of the user thereby allowing them instant access to the entire system modules, their functioning, as well as their generated results. As such the user may engage the dashboard to set up and review the functionings of on ongoing or past communications campaign. For instance, the user can access the scheduler to determine what events are past, what events are upcoming, and to schedule new events and/or activities. The results thereof may also be analyzed, reviewed, and/or modified, such as in view of suggestions made by the system. Particularly, the dashboard may allow the user, e.g., an advertising administrator of a large organization, to pull up and review the activities and the results thereof for each location of the organization, such as with respect to the communications and/or other activities, e.g., sales activities, of the local business unit.

The system is scalable, and as such, can effectuate its activities with respect to 1, or 10, or 100, or 1,000, or 10,000 or 50,000, or even 100,000 locations or more, where all of the recorded activities of the location(s) can be reviewed, e.g., via the scheduler, directed, modified, and/or otherwise configured and controlled, e.g., via the user interface controls of the dashboard. Additionally, the system may compare one or more of the locations with one another, can analyze and score the locations, such as with respect to their communications, their effectiveness, and the results of their commercial activities. In a manner such as this, the communications of each location can be analyzed, scored, and compared one to the other so as to determine which communications are and which are not working, e.g., in terms of effectiveness, clicks, conversion, sentiments, reviews, and the like.

Further, when a given communication is determined to be doing particularly well, the communication can be modified as need be, so as to be employed by other locations to boost their communications and/or business effectiveness. Such boosting can be implemented, such as on approval of the company, or it may be automatic, such as where a given communication receives a high review or rating, such as on a review site, or gets liked or reposted a sufficient number of times, then it can be repopulated throughout the system to be distributed in all or a portion of the local markets. In various instances, where a cost is associated with a given messaging, e.g., a boost, then the system can effectuate the paying of the required cost to pay for the boost activity, e.g., when determined parameters are met, such as three of four star reviews, a certain number or velocity of positive sentiments or reviews are received, such as greater than 70%, 80%, 85%, 95%, 98%, and the like. This can be set for and continue for a certain number of days, a certain dollar amount spent, in accordance with a predefined budget, when a certain fan base or demographic response is received, a certain number of persons reached, a certain number of clicks or conversions received, and the like, and can be limited based on geographic location, and/or can continue until a given number of targets have been reached and/or converted. Hence, in a manner such as this, the system can be fully automated to analyze effective communications, identify targets, and deploy the effective communications to increase the reach of the company, such as to reach potential new customers and/or to improve engagement.

As indicated above, the system is useful for generating and distributing communications, such as consumer communications and advertisements, but the system is also useful in collecting data and performing analytics thereon so as to determine the effectiveness of the communications, and then generating a report on the same. Accordingly, a useful feature of the system is the analytics, review, and reporting engines. Specifically, the dashboard interface will allow a user to review all of the collected and analyzed data, such as by regional view, organizational hierarchy view, level of importance view, level of open action item view, effectiveness view, return on investment view, and other such analytical results views, which can then be organized by the user based on importance, and one or more of which may be selected to be included in one or more reports or suggested actions to be taken in view of the same.

Hence, a report may be generated out of any or all of the metrics determined by the system, and may, therefore, summarize any of the selected functions, progress achieved with respect to a given goal, effectiveness or efficiency of any of the modules, response times analyzed, e.g., detailing how quickly an administrator responds to a post, and the like. Such reports may be generated and sent automatically, or may require user selection and/or approval for one or more of generation and distribution, to all or a subset of employees within an organization or a portion thereof, or to all consumers or only a portion thereof.

As indicated above, once the communication and/or report has been prepared for distribution, the scheduling unit and/or conflict checker can then determine when to send out the messaging and/or report thereof at the optimal time. When a conflict has been determined, such as with respect to conflicting messaging and/or conflicting geographical regions to which the messaging is set to be delivered, then the conflict checker may either flag for user review and resolution, or it may take the appropriate actions for resolving the conflict. For instance, as indicated above, the conflict checker may be implemented to flag communications, e.g., advertisements, posts, and/or reports, that are too similar to another communication being sent, e.g., to the same or similarly located geographical region, and thus, the system may take the necessary steps to slightly modify one of the communications so as to not have the exact same template and/or content of the other, thereby resolving the conflict. Other such conflicts can be resolved in a similar fashion.

Accordingly, once a given report has been generated, and/or a particular suggestion as to how a communications, e.g., marketing, campaign can be initiated and/or improved, then an administrator with the appropriate approvals may then chose to implement the communications campaign so as to effectuate the distribution, e.g., broadcasting of the communications. For instance, in various instances, when a message or other communication is ready for distribution, it may be formatted and broadcast in a number of different manners. It may be emailed, published, posted, uploaded, presented, and the like. For example, in one instance, as indicated the system may include a platform that has one or more connections to one or more social media pipelines.

Particularly, the server system may be associated with a number of social media pipelines via one or more suitably configured APIs, for the collecting of data therefrom, as well as for the posting of data thereto, e.g., on the company's behalf, across all social media pipelines, for all units of the organization. Hence, in this configuration, data may be pulled from and posted to the various online communities to which the server is associated, continuously throughout the day and night, or a portion thereof, such as at times of high traffic. Likewise, data may be pulled or pushed all at the same time, across all pipelines, or at determined times, and on a subset of social media pipelines.

As indicated the data that can be pulled, e.g., via one or more APIs, include published data posted onto the social media medium, or it can be metadata, which together these data may be measured to assess engagement, sentiment, trending, velocity, and the like, which data may then be analyzed and used to change one or more communications to later be pushed across the medium, such as where the A/I module defines the relationship between the same in accordance with one or more metrics. In a manner such as this the effectiveness of communications of a company can be evaluated and/or normalized pipeline to pipeline, between companies and/or between business units of the same company, such as franchisees within an organization. This normalization is useful in that it corrects for or otherwise normalizes for business size and/or number or velocity of measuring, when determining the effectiveness of the messaging content regardless of the conditions under which that messaging is sent. Hence, a raw score can be determined, the score can be normalized, e.g., out of a scale between 1 and 10, and then communication content from one messaging can be accurately compared to that of another. In this manner, the size of the organization, big and small, as well as the number of messaging, high or low, may be accounted for and normalized.

The company's reach when sending out communications can also be accounted for in like manner. The various different characteristics of user response and/or sentiment can also be given different weights when being evaluated, such as where communication recipient comments or reviews are given more weight than simple likes or shares, or upvotes (in that order), but re-tweets may also be given more weight, but not as much as an actual comment. Specifically, those user engagements that require more attentive activity from the recipient, and/or that have greater reach with respect to their social network, will be given greater weight when evaluating the effectiveness of a communication.

This organization is useful also when displaying the results of an analysis, thereby allowing a user to see the best performing content placed higher up on the dashboard interface, but the organization can be switched based on user action, such as by clicking on the column or row headers to switch organization, and/or by clicking on a given result to pull up analytic details pertinent to that result. This will allow the user, e.g., communications administrator, to see the most relevant information, e.g., of what is performing best, on top or vice-versa.

Of course, the organization of this weighting may change based on the way the communications platform is configured, such as by action of the A/I module based on its analysis, or by user selection. Hence, not only the content of a message, but the delivery of the messaging may be scheduled differently with respect to time, mode, pipelines, and targets of delivery, and as indicated earlier the messaging form, content, and formatting may also be different. In a manner such as this the messaging and its contents as well as its delivery may be in a layered organization, such that given communication is configured differently dependent on different levels of messaging criteria. Hence, whether a given user, e.g., company, has 1, 2, or 3 locations or over 30,000 locations, the system is adaptable to accommodate the size of the organization it serves, and regardless of the number of locations and amount of messaging being managed, the A/I module is scalable so as to control the messaging, business analytics, distribution, and reporting for the entire system, either automatically, or with the assistance of one or more account managers. The A/I module, therefore, is a fundamental aspect of various configurations of the system.

Accordingly, as indicated above, the various devices and systems, as well as their methods of use, as disclosed herein, may be employed so as to collect and evaluate content, such as online content that can be stored and used to generate a communication, such as an advertisement, which advertisement once generated can then be transmitted, such as over the internet, to one or more target recipients, e.g., consumers. In particular instances, the content to be collected may be from one or more online or social media platforms, which content has been evaluated, using various metrics set forth herein, and determined, by the system, to be useful for inclusion in the development of communications that may be generated anew and distributed to various potential online consumer and/or other market influencers (“Targeted Users”). The communication, therefore, may be formulated and/or specially crafted in a manner to include one or more parameters determined to be of specific use to a target or a target group, such as a target demographic, and/or may be specifically crafted for the purpose of keeping the communication provider, e.g., an organization or a business, relevant with respect to one or more parameters of interest to the distribution target.

Particularly, a user of the communications system may be a communications director, a marketing admin, or the like, who is responsible for controlling the communications within and outside of an organization, such as where the organization may be a national or global business organization. Accordingly, in such instances, it may be useful for the overall system to evaluate web-content and data, such as online data. The data may be online content or meta-data or other useful data, all of which may be beneficial in the building of a communication, such as an advertisement, for distribution to one or more consumers of the business communicator.

Specifically, prior to collection, or once content has been collected, the content and its associated data may be scored, as set forth above, with respect to its predicted usability as content for use in the generation of a communication. Once retrieved the content may be stored in one or more libraries of a repository of the system, such as with respect to how a user and/or a target recipient might engage with the system so as to review, evaluate the stored content, and then use it to generate a communication. The data to be stored in the system, may include content, such as communication content, as well as potential 3^{rd} party data, such as data related to how one or more target users is engaging with social media and/or the various communications of the system being distributed to the public. In various instances, the system and its contents may focus on or may be made accessible for review by and comment form 3^{rd} parties of influence, such as social influencers, so as to provide comments or suggestions to the content and communications being employed by the system.

Particularly, in a manner such as this, various 3^{rd} party factors may be identified by the system, evaluated, and the data pertaining thereto may be taken into account when configuring the operations of the system, such as when evaluating and/or generating content. A third-party factor may be a 3^{rd} party that may or may not be using the world wide web or other online community for participating in communications and/or to engage in commerce, but whom the system has determined is relevant to how one or more other consumers of online content is or is likely to engage or otherwise use social media to engage in commerce thereby. More particularly, the system may be configured for viewing and/or tracking the online activities of the system, those using the system, those engaging with the system and/or its communications, as well as 3^{rd} party online influencers who may be commenting on the communications and/or commercial transactions of one or more businesses, e.g., users, of the system.

Particularly, in certain instances, the system is configured for evaluating online communications, user engagement with those communications, and based on those engagements determining connections and patterns in the behaviors of the target users of various social media platforms in response to those communications thereon. These connections and patterns may be directed to how communications and content are being consumed by online and/or social media users, on how it is being commented or otherwise acted on, and what types of actions are being evoked via user online engagement with the community, the communications thereon, and/or the system as a whole, specifically with respect to how given messaging, e.g., from a business, is being received and/or acted upon, such as by the sentiments it receives and/or whether or not it trends upwards or downwards or not at all.

The system, therefore, may determine and analyze this data, discern various patterns thereby, and develop one or more rules or metrics therefrom, which rules may then be used to either collect new more pertinent content and/or to craft new more useful communications. Other rules, developed from identified patterns of various relationships between online information consumers and online information providers, such as with respect to goods and services being provided may also be determined and implemented, such as in evaluating and generating new content and communications. Hence, one or more patterns have been determined by the system, specifically via a suitably configured A/I module thereof, the pattern can be used to derive rules by which the communications platform system can be configured to generate new content and communications that can be more tailored to a target demographic and/or distributed to them in a more engaging manner. Consequently, one or more actions may be taken by the system in view of the identified relationships and/or determined patterns so as to make the system more effective and efficient at reaching its determined objectives.

For instance, once a relationship between the various agents acting online and/or upon the system as well as the factors relating thereto have been identified, such as with respect to how certain content is being received by the online community and/or is trending online, and a pattern with respect to how the content is behaving with respect to evoking user engagement based on that content, the system may take one or more actions, e.g., boosting or corrective measures, to generate new content that either boosts successful messaging, or corrects unsuccessful messaging for use in generating and distributing new communications. Once a pattern or a trend has been established a correlation between the communication and its achieved objective, e.g., the maintenance or generation of interest, engagement, and/or sales, factors affecting the attainment of that objective can be isolated, and may then be used as a metric by which other communications can be formulated, composed, and/or otherwise structured. High performing data and content can then be scored and stored for later use by the system in generating new communications, as disclosed herein. The system may store the content based on the scoring of the identified patterns, based on data derived from how online users are engaging with the communication and/or system as a whole, and/or other information that may be of use and/or applied to the later activities of the company, e.g., or other user, such as when weighting their future scores or other actions they take in generating new communications, interacting online with consumers, and/or with configuring the system.

Accordingly, in various instances, the communication target's, e.g., consumer's, engagement with online content and/or the system as a whole may form regular interactions and/or patterns that may be recorded and tracked within the system. These patterns may be recognized and identified by the A/I module of the system, e.g., certain keywords or phrases, or sales dialogue within given contexts can lead to the positive result of generating more sales, which can be determined statistically, and in certain instances may form a pattern. In particular instances, the A/I module may include a pattern recognition or machine learning platform, as well as a predictions platform, together which A/I module may be configured to recognize patterns, analyze them, and determine rules by which to re-orientate the system and/or adjudge or predict potential future outcomes, with a degree of certainty.

From these patterns, the machine learning and/or predictions platforms of the system may be employed to evaluate content, e.g., online content, and one or more online or social media user's particular pattern(s) of behavior with respect to that content and determine a pattern in relationship between the messaging content and its affect on the user so as to determine usefulness of the online content as marketing. This is useful when by online users patterns of engagement with content and/or the system appears to coincide or conflict with the patterns of usage of other online users being followed and evaluated by the system. More specifically, the system may be configured for determining the presence of various factors influencing online or social media behavior, e.g., consumer behavior, such as factors pertaining to the ability of a communication to influence a consumer in making a purchase, as well as for determining which factors may be leading to that influencing, and to what degree.

Further, once determined, the system, e.g., via the suitably configured learning platform, may then be adapted to produce rules or metrics that may be employed in generating a communication that capitalizes on such influences, such as by the predictive intelligence platform increasing or decreasing a weighting scale used to weight both content and the connections between that content and its effect on the actions of communication recipients. The system can also account for various influencing factors and other user actions that influence the outcomes of those actions that result. For instance, in such instances, when various patterns are formed, the system may learn these patterns, breakdown and learn the factors leading to the pattern, thereby determine the existence of and the reason for the presence of a trend, e.g., in communications, and/or predict a likely manner in which the communication recipients will behave, and a level of confidence may be given to the predicted outcome, such as from 0.0, not very likely to 1.0 almost completely certain.

Accordingly, when the system makes a correct prediction, such that a given communication will result in a certain percentage increase in sales, the connection between the initiating action (e.g., the identification of a target demographic and the generation and distribution of a communication, where the communication includes elements known to positively influence consumer behavior, e.g., factors affecting sales), and between the final action (e.g., a communication recipient receiving and acting on that communication to actually make a purchase), that connection may be strengthened. In such an instance, when these same or similar conditions occur again, because of the increased weight between the connections, the system will be quicker to form and distribute a communication using these same or similar content types, with a higher prediction of their effectiveness. If the expected outcome, e.g., sales percentage, is reached, the connection is strengthened again, and given increased weight again. If the expected outcome does not occur, e.g., is not reached or beaten, the system will then access the factors to determine why the model did not work, and corrections and/or recalibrations to the system, its weightings, and/or its component parts will be made.

Hence, in a manner such as this, factors identified as having a positive predictive correlation to one another are deemed to be correlated and can be connected, and the strength of that connection may be increased the more the two items occur in connection together, such as where a given communication results in an increased number of sales for a given demographic. Where the predictive model does not or ceases to work, the system will analyze the various factors, draw new connections, and re-weight the various connections so as to come up with a new predictive model, which model will then be used to generate new communications, with the expectation of increasing the objective outcome, e.g., increased user sentiment, increased likes, increased engagement, increased consumer retention, increased sales, and the like.

Therefore, when a pattern is observed, and the predicted result occurs, the weight between the various elements in the predictive chain may be increased, making it more likely for this pattern to be propagated again and again. However, when a pattern is observed, and the predicted results do not occur, the weight between the various elements in the predictive chain may be decreased and/or reorganized until a new pattern is performed. Accordingly, the connection between the action and a predicted outcome of that action, may be strengthened, such as by giving an estimation of successful conversion and/or a predicted outcome in the future, for the same or substantially similar circumstances, more weight. Likewise, when a pattern is broken, less weight may be given to the various connections between the initiating action, e.g., the sending of a communication and various factors leading to the non-predicted outcome, and a new weighting and organization of the elements of the communication may take place until a new positive pattern is re-established. Changes in patterns can also be aggregated along various dimensions to group a plurality of communication content, communications, and target demographics together, and/or in the contrary, to group a number of social media users interacting online together, such as in a coalition, which groupings may be used to more precisely define and weight patterns of engagement based on their collective actions and/or interactions.

In a manner such as this, the system may be configured to keep track of the various content, communications, organization communication producers, and/or social media users, communication consumers, identified by the system as well as their individual and/or group patterns of behavior, so that the various identified factors that may be influencing the emergence and/or maintenance of such patterns may be identified, predicted, and employed for a plurality of different uses, such as for determining the best content and form for generating communications geared towards achieving a pre-defined, desired result, such as the increase in consumer sentiment and/or an increase in product or service sales. In various instances, the desired objective may be the increase in target engagement with the communications and/or businesses of the system, and/or for taking corrective actions, such as to correct for communications and content that is not meeting its objectives.

Specifically, the system may generate and employ one or more data structures that may be queried so as to predict the answer to one or more questions, such as which communication content and/or form is among the best to be used given the various contextual factors of a given situation. For instance, as described in detail herein, the system may be configured for receiving information with regard to the actions of one or more, e.g., a plurality of social media users, which information may include website interest information, content interest information, target consumer identifying information, consumer social circle information, as well as social media engagement information, and the like, such as with respect to one or more target demographics. In various embodiments, to identify factors of particular interest to an online retailer and/or a consumer thereof, the system may present one or more users to a series of questions, such as via an automated interview process, the responses to which may be used to characterize and/or rank content that may be useful to a user of the system, such as for generating communications and/or for making purchases.

Additionally, the system may track how various identified targets, consumers, engage with the content and/or the system itself, as well as the attendant, e.g., contextual, data pertaining thereto, such as time, place, number of times per day the user is online and/or engages with key content, length of time engaged, who he or she messages or otherwise interacts with through an online and/or social medium platform, who they follow, what events they engage in, what they purchase, what they post online, what they like or dislike, the sentiments they express, and the like. All of this information may form data points that characterize any given content, message, communication, and/or any given social media user. These data points may then be employed as nodes within a data structure, which data structure may take any suitable form, such as a data tree and/or a knowledge graph. From these various data points relationships between communication content, users of the system, e.g., business, communication recipients, e.g., consumers, and their actions may be identified, and the connections between them may be weighted based on the number and form of the interactions between them, and their various actions taken in response to the communications they have sent and received.

Hence, the more users interact with one another and one or more communications of the system in a positive manner, the greater the weighting will be between the various nodes that may be employed to define their relationships and interactions. Likewise, the more negatively the users interact with one another and the communications of the system, the less (or more negative) weight will be given to define their interactions. In similar manner, the more the user's interactions with the communications of the system are positive and comport with one or more other groups of the system, the more weight those various connections will be given, and the more the user's interactions with the communications of the system do not comport with one or more other groups of the system, the less weight those connections will be given. Likewise, in various instances, a user or the system may make a prediction as to an outcome that actually occurs, and in other instances, the predicted outcome does not occur, in such instances, more or less weight will be given to the system/user when predicting outcomes for future events, based on the successful prediction of outcomes of past events.

Data points between the various nodes of the system may be used to generate correlations between the nodes and to weight those correlations so as to build a data structure thereby, such as a knowledge graph or tree, which may then be queried to determine other relationships not previously known and/or to predict the influence of external factors affecting the usage of the system in generating communications, and/or to predict and weight potential outcomes of a conversational campaign based on a collective of usage patterns of how consumers are engaging with the various communications system. For instance, a data structure, such as a knowledge graph, may be generated by the system receiving known data about the various online social media users and/or business organizations of the system, e.g., a company, its franchises, and/or its employees and consultants, communications directors or advertisement agencies, and the like, and may further receive data about various other online users, who may be in some way related to or interested in the company, such as in a commercial way, e.g., they may be consumers, market influencers, or reviewers, or commenters on the company. Each of these entities may form nodes in the knowledge graph, and their interactions one with the other may be mapped and scored, such as where the interaction is positive, a positive score may be given for that interaction, and the opposite for the negative.

Further, the various interactions may include the sending and receiving of communications, responses to communications, and actions taken in response thereto, all of which may define lines of interconnectivity between these entities in the knowledge graph. This data may be received by the system such as via a suitably configured API connecting to one or more social media pipelines, and/or may be by web or other data collector or crawler. In a manner such as this, the system may be configured for building stars of data points that together form a constellation of relations, which relations are defined by a multiplicity of interactions that form webs between known business entities as well as their current and potential customers. Together all of these data points and their respective connections, one with the other, form a milieu of social media interrelatedness that can then be leveraged in forming as well as managing the social interactions of a company, especially with respect to successfully managing their communications within and outside of the organization, e.g., their consumer facing communications.

As indicated above, this data may be collected in a variety of ways, such as by system generated interviews of the various communication generators and/or communication recipients, system instigated accessing and review of social media usage by various identified targets of interest, as well as the usage by others of the internet, such as through postings of texts, photos, blogs, comments, searches performed, time spent in web-pages, web-page content, and other associated metadata through which a social media user produces a presence on the global internet, all of which data may then form various nodes of the knowledge graph. Such a procedure may be performed for a number of different user businesses and/or target consumers. Once the system engagers, e.g., business, consumers, and other interested parties (collectively “Users”), have been defined and entered into the system, the users may be grouped in accordance with one or more system usage parameters, and known relationships may be determined between the various users in a pre-defined grouping.

The number of relationships between the various users as well as the strength of those correlations may then be determined and used to weight the known or fact based relationships. Likewise, from these known fact based relationships, previously unknown, inferred relationships may be determined, and weighted, e.g., which target demographic will respond the best to what messaging content. In a manner such as this, the knowledge graph, or other data structure may be generated so as to include both known and unknown, inferred, relationships, which may then be leveraged to identify content that might be useful in enhancing engagement and/or sales between the various businesses of the system with their perspective target consumers. Accordingly, once generated, the knowledge graph, or other data structure, may then be queried along a number of lines so as to make one or more determinations with respect to the various relationships between the various nodes of the graph, as well as to leverage those connections so as to predict what actions may be taken to strengthen those relationships. Essentially, in one implementation, the system can be configured to determine how a relationship between a business owner and its consumer may be strengthened, such as by engagement in a successful communications campaign that is directed to increasing consumer engagement and/or sales.

For instance, the system may be configured to automatically be queried to determine if there is a pattern by which one or more users are interacting online with respect to one another, that may be identified and used to strengthen or weaken their relationships, such as by the messaging being sent from one to the other. For example, if one or more unrelated consumers appear to be engaging with the internet in the same or opposite manners, e.g., they are both making negative or positive comments about the same company or product, the system may flag their behavior for further analysis, a deeper dive into any possible relationship between the two users, their actions, and why those actions are similar or different, may be initiated, and a source of their possible correlation or di s-correlation, may be determined, and from the strength of that relationship between the two users and based on the online sentiments they are expressing, a score may be given so as to weight the possibility the users may be evidencing a common theme, such as an objective or purely subjective experience of a business or product they are both commenting about. Such an interaction could evidence engagement, which may then be identified by the system, flagged for review by a system administrator, and/or the system can initiate corrective measures by which the consumers engagement may be strengthened, such as by receiving positive communications from the subject company of interest, or they may receive corrective communications meant to correct their negative experience, e.g., sending the consumer a new, revised product, a new service, or a coupon for the same. In various instances, the system may perform such activities automatically based on its own programming and/or in some instances may be initiated by an administrator of the system, e.g., a system operator, communications director, franchisee, or the like, may initiate such queries, and/or a deeper dive as to how various users are using the system and/or engaging online.

Accordingly, in various embodiments, the system may be configured so as to be queried along a number of different parameters to determine and weight a number of different answers, and thereby make a variety of different predictions, such as with respect to determining which communication content will be the most effective given various situational contexts. These predictions may then be given a weighted score, such as to the probability of being correct, and based on that score, the system can generate communications and/or self-correct so as to properly account and/or correct for the predicted behavior of its users and/or targets, such as with respect to their engagement with generated and distributed communications.

In a typical architecture for performing such functions, such as for performing a search query such as for identifying useable content, for instance, the system may include a database of relevant content features, e.g., keywords, consumers evidencing interests in a given subject business, characteristic data pertaining to the consumers themselves, relational data pertaining to one or more identified consumers in relation to other online users, e.g., with respect to the messages they post online, and characteristic data pertaining to how the consumers have interacted with the communications of the system in that past, e.g., including any pattern data, as well as predictive outcome data of the past, present, and/or future, and may include other characteristic data the system determines is relevant to the particular question being queried. In such an instance, the relevant data points may be identified and pulled from a general repository or dedicated database, and a localized data structure may be built.

Any data structure may be employed for performing the search in question, in various instances, however, the data structure may be a relational data structure, such as a Structured Query Language (SQL) database, which may be implemented via a relational database management system. For instance, in one implementation, the SQL database may be a table based data structure, such as where one or more tables form the base structure wherein data, such as media content, may be stored, searched, relations determined, and queries answered in a structured manner. Particularly, in various embodiments, a table-based database may be presented, searched, and used to determine relationships from which answers to one or more queries may be determined.

Typically, in such a data structure, identifiers, such as keys, are used to relate data in one table to that in another table. For example, typically, SQL databases have a relational architecture. These constructions may be represented by a table structure. A series of tables or the word graph, explained above, for instance, may then be employed by which correlations may be made in an iterative fashion to identify keywords that may be of particular use in building a communication of the system.

Specifically, with respect to whether a certain online user is positively or negatively engaging with a selected communication and/or company of the system, such as with respect to a particular messaging campaign in a positive or negative manner, a first correlation may be made with respect to the subject's normal interactions online, such as with respect to their engagement with that or other companies and their messaging, e.g., in the past. This may be reviewed for a period of past engagement or non-engagement, and may be determined over a series of days or events, such as to determine a baseline for how well the consumer's interactions are consistent over time, and then the results thereof may be compared to others treated in like manner to compare this subject against the mean or average of other consumer interactions overall (or with respect to their past interactions). This data may then be broken down and a first table may be formed to record this data as a first use model sample set. Then, a second table may be built whereby the subject consumer or a consumer group's current online use, with respect to a current communications campaign presently being performed, may be tracked and compared against the collective of current online users engaging with or otherwise responding to that campaign, and the two tables can be compared with one another so as to determine if the subject consumer's present interactions comport with their past interactions, and/or how their present use comports against the collective, and then the different messaging involved with the two campaigns may be compared one to the other.

Where it is determined that a user's present use is outside of what would be their historical or predicted usage average, the system could flag the interaction as worthy of a deeper dive, and if necessary can begin to look for other correlations between this user and this campaign so as to determine possible explanations as to why this user's present interactions are outside of their predicted behavior. Specifically, where the data structure is a series of tables, the user's identifier may be searched and compared through a number of tables for a wide variety of correlations that may be determinative in explaining their present, aberrant experience with a given company's communications. Where a source of positive or negative interaction is determined to be present, the system can implement a boost of engagement to expand on the positive trend, or engage in corrective regime to enhance or correct for that experience.

Accordingly, a key may be used to correlate the tables, which key may be accessed in response to a question, prompt, or command, such as why the user's present use does not comport with their past use of the system. The key may be any common identifier, such as a name, a number, e.g., a RFID number, cellular identification number, a phone number, a drivers license or social security number, and the like, by which one or more of the tables may be accessed, correlated, and/or a question answered. Accordingly, without the key it becomes more difficult to build correlations between the information in one table with that of another. In certain instances, the table may be a hash table and a hash function may be employed in search the table for correlations with other data structures. As indicated, a further architecture that may be used to structure a database is a data tree, e.g., a suffix or prefix tree, where various data elements may be stored in a compressed, but in correlated fashion, where the various roots and branches form divergent data points with respect to potential correlations.

In other instances, a graph-based architecture may be structured and used to determine the results for one or more queries. Particularly, a knowledge graph architecture may be employed to structure the media repository, so as to enhance the performance of computational analyses executed using that database. Such analyses may be employed so as to determine whether a given online user's present activities comports with their past use and/or comports with how other users in general have or are presently interacting online, such as with respect to the various communications campaigns being implemented by the company users of the system. Accordingly, the sophisticated algorithms employed herein, are adapted for structuring the infrastructure of a relational database so as to enable more efficient and accurate searching, such as for identifying and evaluating and scoring successful online content, which content can then be collected, graphed, and predictions may be derived therefrom, such as via performing graph based analyses, as well as for performing table or tree based analyses.

Consequently, in one aspect, a device, system, and method of using the same to build a searchable, relational data structure, such as described herein, is provided. Particularly, in one instance, the devices, systems, and methods disclosed herein may be employed so as to generate and/or otherwise collect data, such as data pertaining to various online users and how they respond to various communications, e.g., advertisements or engagements, they receive from other online users, such as companies, over a variety of platforms, such as social media platforms. This data may then be used in developing communication content that may more effectively reach a company's target demographic in a more meaningful manner.

Accordingly, in one embodiment, methods for building and structuring a searchable database are provided. For instance, in a first step, data, e.g., online content, may be identified, scored, collected, scored again, cleaned, edited, and then be prepared for analysis. In various embodiments, the data may be labeled and/or categorized, and may then be structured into a searchable data architecture, such as a knowledge graph, table, or tree-like structure. And once the database is structured, it may then be populated with data, e.g., generated content, in accordance with the determined or inferred relationships. Such relationships may be notional, fact, or effect based. More particularly, in certain instances, a machine learning protocol, as disclosed herein, may be employed so as to determine relationships between data points, e.g., related to communication content as well as those who liked and did not like the content, entered into the database. Such relationships may be determined based on known facts, and as such the learning may be supervised learning, e.g., such as where known factors may be used to label, categorize, and store data, such as location, interaction, social engagement, sentiment, relationship, and/or usage, sales, and other related data.

In other instances, the learning may be inferred, such as in an unsupervised learning. For instance, in certain instances, the data to be stored may not be known, relationships between the data may not have been pre-determined, and the query to be answered may also not have been otherwise identified. In such instances, the data to be stored is unsupervised, and as such, patterns in data to be stored and their relationships, such as commonalities between data points, may be determined notionally, and once determined such patterns may then be used in forming the architecture that structures the searchable data architecture. For example, where a user's interactions with the system, e.g., posting a review or sentiment about a communication, breaks a pattern, the system may explore relational characteristics of the consumer and/or his or her online use so as to determine what pattern was broken and/or to correct for its effects, or to simply determine a new pattern of behavior is emerging, in which instance, a deeper exploration may not be warranted. For instance, a known sequence of patterns may be used to infer that if events A and B in a known sequence may be followed by event C such that if event C does not happen as predicted, a flag is set off for initiating a deeper exploration of the nature of the causes of the flagged event. However, where upon a first round of exploration, it is discovered a new pattern of behavior is being established, the flag may be removed and a deeper exploration as to the causes of the new pattern formation can be but need not be explored.

As described above, in certain instances, at the heart of the platform, therefore, may be a generated data structure, e.g., a graph based database architecture, which may be generated on the fly by the APIs and/or skimmers of the system retrieving data points from a plurality of sources, and populating those data points into a suitable data structure from which relationships and/or correlations between the data points may be made. This is particularly useful when determining consumer response individually or en masse to an advertising campaign of one or more companies. First, when populating the data structure known facts may be populated, then known relationships may be determined, and from these known facts and known relationships, otherwise unknown facts and/or relationships may then be determined. Such data points may include any user pertinent information, such as: user entered information, user determined information, such as with respect to how the user interacts with the internet, in particular, or how they interact with online companies generally, information derived from the user's social media, user posted information, such as texts they send, commentary they post, photos they upload, comments they respond to about the company, web-pages they visit and for how long, likes they make, up or down votes they make, purchases they make, video's or blogs they view, searches they perform, who they follow or are friends with on social media, and the like.

Additionally, user location data may be determined and used to determine how close or far the user is from a given company running an advertising campaign the consumer is interested in, viewing, or otherwise engaging with. The user may be tracked by their online ID, name, handle, avatar, phone number, computer ID, user ID, their cellular ID, RFID, GPS, Cellular tower triangulation, their Internet Protocol ID, etc. In various embodiments, the system may track the user's online interactions, travel, locations visited, whether engaging with a company and/or its competitors, and the like.

Further, friends, associates, and acquaintances of the user may be identified and their online use of the internet may be determined and tracked, such as with respect to one or more companies of the system, and this information may be used as data points in determining one or more consumer's pattern of usage, trends, and sources of possible correlations, relationships, preferences, and the like towards one or more companies of the system may be determined and/or predictions therefrom may be made. Such persons may be identified directly by the user, by the user's online interaction with them, via the application or social media, via tagging, and/or via facial recognition based on being in a posted image in association of the user.

In such a manner as this, a consumer's internet presence and/or social network may be leveraged and used as data points in the construction of a data structure, such as a knowledge graph, from which correlations and relationships may be determined, for instance, between various users of the system, and/or third parties, for example, by determining how these various entities interact with one another, with respect to one or more companies of the system and/or their communications. The type, quality, and/or quantity of these relationships may then be determined by the system, likes and dislikes in terms of products, companies, and their messaging content, may also be determined, and the results of which may be employed so as to determine a predicted outcome, such as in response to a given query, such as for determining the potential presence of bias of one user of the system with respect to another.

Once the data structure is built, and the known and inferred facts and relationships determined and/or weighted, the data structure may then be queried, such as with respect to identifying content that is useful for building one or more communications of one or more companies of the system. Specifically, the system may be directed, such as by a system administrator or communications director, as to what the query is or should be, such as from a list of known query types, so as to perform a supervised search query, or the system itself may generate a query automatically when it identifies certain patterns that are worthy of greater explanation, and as such an unsupervised query may also be instigated. More specifically, the various data points entered into the data structure may be labeled and categorized, e.g., based on known patterns, identified metrics, one or more filters, and a given search query may be performed with respect to the identified labels and categories, that have previously been determined to be important to the performance of one or more objectives of a user of the system. This is useful when the system has been primed in such a manner that it knows what it is looking for.

In other instances, the predictive A/I module may itself identify patterns, commonalities, and/or other elements that form a relationship from which one or more labels and/or categories may be generated automatically by the system itself, and a query can be performed based on system generated prompting with respect to these unsupervised factors. This is useful when it is not necessarily known what is being looked for. In particular, in various instances, the machine learning module, as described herein, may be adapted to recognize how an output was achieved based on the type and characteristics of the inputs received. Specifically, in various instances, the present system may be configured to learn from the inputs it receives, the relationships it determines, and the results it outputs, so as to learn to draw correlations more rapidly and accurately based on the initial input of data received and/or the types, quality, and quantitates of the relationships it is able to correlate.

Likewise, once the A/I machine learns the behavior, e.g., of one or more users of the system, or one or more third parties with respect thereto, the learned behavior may then be applied to a second type of data, such as an inference or predictive engine, that is used to infer other various relationships and/or to predict the answer to one or more unknown variables, or heretofore unknown relationships. There are several different types of relationships that can be determined.

For instance, relationships may be determined based on what is known, e.g., they are fact based, and/or they may be determined based on the known effects of those facts, e.g., they are effect based, e.g., logic based; or they may be determined based on inferences, e.g., relationships that are unknown but determinable. Specifically, a relationship between two subjects, locations, interactions, and/or other relevant conditions of one or more users of the system, or third parties with respect thereto, may be inferred based on various common facts and/or effects observed between them. As described in great detail herein above, these previously unknown but inferred facts and/or relationships may be determined and/or used in predictive models by generating a data structure as disclosed herein. Other known, e.g., fact, effect based, or inferred data points may also be generated, or otherwise entered into the system, and may be used to generate one or more nodes, e.g. a constellation of nodes, which may then be used in the determination and/or weighting of relationships.

Particularly, the various data points of a data structure may be characterized in a plurality of different manners, such as with respect to being a subject, a predicate, and an object. More particularly, each node and the relationship between the various nodes will have properties by which they can be placed into one of these three categories based on a given query to be answered. Hence, as the nodes are populated, they are also populated with one or more characteristic properties that more fully define and/or classify that node. Known facts, as well as their known properties, are first employed by the machine learning module (ML) to determine known outcomes, during which process the ML module thereby learns the patterns of behavior between the nodes and their relationships to one another, such as in a training process.

This training may take place over a wide range of sample sets, until an acceptable accuracy has been established. Once appropriately trained, e.g., via a deep learning protocol, then the ML module, may be given data points from which unknown relationships need to be determined, and unknown outcomes predicted. Specifically, once the ML module has learned the expected patterns of relationships, e.g., behaviors, with respect to known data points and relationships, it may then develop “inferred” rules by which it may classify and label new or unknown data points so as to determine and account for otherwise unknown relationships, so as to thereby classify and label and/or otherwise define the heretofore unknown data points, their properties, and relationships, which may then be classified and labeled. In such an instance, when the expected results are achieved, predicted engagement or sales increase, such as with respect to the user engagement with the system, the system status quo may be maintained, but when these new data points evoke a breakdown in patterns of relationships and/or expected outcomes, e.g., a user acts in an unexpected way or an unexpected result occurs, then a system alert may be triggered and a deeper exploration may be initiated.

Additionally, once the knowledge graph architecture has been constructed, the A/I module may employ that knowledge graph to answer one or more queries of the system, and/or to make one or more predictions with respect thereto, such as with regard to determining which informational content will be the most likely to increase engagement and/or sales with which demographic. For instance, the A/I module may configure the data structure, and implement one or more functions with respect thereto, such as via one or more known or previously unknown facts, e.g., via the machine learning protocols disclosed herein, and thereby predict various consequences with respect thereto. Further, once the data structure is generated, e.g., by a suitably configured API or skimmer, it can continually be updated and grown by adding more and more pertinent data into the knowledge structure, such as data received from any relevant source of information provider pertaining to the subject(s) under examination, and building more and more potential nodes and/or relationships.

In various embodiments, the system may be configured for being accessible by system administrators, corporate executives, communication directors, advertising agencies, and/or other third parties having the appropriate access permissions. In such an instance, the user may access the A/I prediction module, e.g., via a suitably configured user interface, upload pertinent information into the system and/or determine the relevant nodes by which to answer an inquiry, with respect to how a given user is engaging with the system and/or does their behavior with respect thereto fit within an established and/or otherwise expected pattern of behavior. For instance, an exemplary query may be such as which demographic is more likely to identify with what terminology so as to increase their interest in a product or service.

The ML and AI inference/predictive modules of the system have many potential uses. In certain embodiments, the system may be configured for collecting online content that can be evaluated and stored within the system and used to generate a communication that may then be distributed to one or more target recipients. As such, the system may be configured for providing a platform by which a business or market influencer or other user of the system, such as a national sales brand, service provider, manufacturer, and/or the like, may be enabled to more closely monitor and more effectively engage in promoting its products, services and offerings through a multi-tiered nationwide communications campaign that can be controlled from a single user interface, such as at their desktop or mobile computing device.

Specifically, in one embodiment, a downloadable application is provided, such as for download on a handheld mobile devices, such as a mobile telephone, tablet computer, or other computing device, which downloadable application when engaged provides a graphical user interface (GUI) through which interface the user of the system, e.g., communications director, may more intimately involve themselves in producing and managing an online advertising or other communications campaign. More specifically, the GUI may be configured to present a dashboard to the display of the computing device, through which display the user may be enabled to interact in the event environment in a more meaningful way.

For instance, in one instance, the dashboard may present a display of the communication elements that can be crafted, real-time, into a communication that can immediately be sent out to any number of target recipients. The real-time generation and display of the communications contents may be for already crafted and approved communications, or may be generated on the fly using approved communication elements, which once generated can be distribute easily, such as by the touch of a button. Such media content may be collected and transmitted to a server of the system, from one or more of various sources, the content may be cleaned, edited, and inserted into a template from which an advertisement may be generated and broadcast, streamed, downloaded, or otherwise provided back to the various targeted consumers for substantially real-time for their viewing. In various instances, the user may select from which content source they wish to view acceptable content for a communication, such as by toggling back and forth between viewing options on a display, such as via the downloadable application or “app”.

The dashboard may also provide a platform through which users may message other users of the system, such as within the organizational hierarchy, such as for approval of communications, such as through substantially instant messaging, SMS, text messaging, i-messaging, sending of sounds, photos, videos, and/or may allow for the user to instantly send messages, texts, sounds, videos, etc. to one or more, e.g., all of their social media platforms, such as review and approval of the generated communication and/or posting thereof. Such messaging may be sent system wide or to one or more subgroups of the system, such as where the user has selected and formed a sub-group of system users with whom to share messaging and/or media content back and forth with each other, such as for the crafting of communications. Likewise, the dashboard may allow users to interact with or otherwise respond to the messaging of others, e.g., consumer response to company communications, using the system, such as through likes or dislikes, up or down voting, or otherwise replying to messages posted across one or more social media platforms.

In another aspect of the disclosure, the downloadable application may be employed so as to generate an advertisement, such as an advertisement relevant to the a company user of the system and/or based on consumer engagement with the company or the system itself and/or their location. For instance, as described above, the machine learning module may be employed so as to generate a profile of a company and/or a follower or consumer or potential consumer of the company. The profile may be a list of properties, qualities, and/or characteristics that describe the company or a target demographic, e.g., consumer, thereof, their products or services, and/or their engagement with online media and/or the system. As such the profile may be generated by a plurality of different methods, such as by providing an interview to the consumer and saving their responses, further characteristics may be determined based on their engagement with the company, specifically, or social media generally, such as by what they post, how and when they comment, the images they upload, and/or the activities surrounding the images they post, and the like.

Further characteristics may be determined based on how the user interacts with previous messaging from the company, and/or how they use the internet generally, such as by what searches they perform, who they follow, what pages they visit, the time spent on such pages, purchases they make and the like. Additional characteristics may be defined by where the consumer is located, the places they visit, such as on a routine basis, and/or the places they or their friends have visited. All of this data may then be collected for the consumers and potential consumers of a company and a knowledge graph may be generated with respect thereto so as to compare the company with its consumers and potential consumer. In various instances, once these characteristics have been determined, the AI module may determine various correlations between these characteristics, such as between the things or products the company and its consumers likes, the location where the company and the consumer is located, so as to generate a real-time advertisement that is generated in a manner to be specifically pertinent to the consumer, while at the same time generating interest and engagement amongst the friends and associates of the consumers. Once the communication has been generated, it may then be distributed, as described herein, to the identified consumer and/or their friends and associates, such as by merely engaging the dashboard displayed on the handheld computing device.

In various embodiments, the devices, systems, and methods of using the same as herein described may be implemented as computer program products that are related to facilitating one or more of a content generator, content manager, scheduler, scalable set of permissions, traffic monitor and/or modulator, data aggregator and evaluator, tasks management controller, analytics and report generator, review module, a comments aggregator and response dashboard, and other like tool sets. In various embodiments, the implemented tool set may include a scoring functionality, such as for providing the top scoring content to users for reference in generating their own original successful content. In some implementations, the facilitating and/or scoring is provided by empirical algorithms that accurately generates and/or measures content and the performance of web content collection and/or generation in terms of a specific set of metrics relating to the web content collection.

In an interrelated aspect, non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems.

Such computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

Computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems.

Such computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

One or more aspects or features of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device (e.g., mouse, touch screen, etc.), and at least one output device.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” (sometimes referred to as a computer program product) refers to physically embodied apparatus and/or device, such as for example magnetic discs, optical disks, memory, and Programmable Logic Devices (PLDs), used to provide machine instructions and/or data to a programmable data processor, including a machine-readable medium that receives machine instructions as a machine-readable signal. The term “machine-readable signal” refers to any signal used to provide machine instructions and/or data to a programmable data processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), WiFi, and the Internet.

The computing system may include clients and servers. A client and server are generally remote from each other and typically interact through a communication network. The relationship of client and server arises by virtue of computer programs running on the respective computers and having a client-server relationship to each other.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flow(s) depicted in the accompanying figures and/or described herein do not necessarily require the particular order shown, or sequential order, to achieve desirable results. Other implementations may be within the scope of the following claims.

What is claimed is:

1. A communication system for generating an online communication for distribution to a target user of a social media platform over an Internet based on target identifiable engagement parameters, the system comprising:
a communications server having a network internet connection to communicate with the target user via a computing device having a graphical user interface for displaying online communications, the server comprising:
an evaluation engine coupled to the communications server, the evaluation engine for receiving and evaluating information about the target user to thereby evaluate one or more target identifiable engagement parameters characterizing the target user;
a communications repository associated with one or more of the server and the evaluation engine, the communications repository for storing a plurality of communications, the communications being ranked based on a number of the identifiable engagement parameters;
a communications generator coupled to the communications repository, the communications generator for accessing the communications repository and for matching the target user with a communication, based on the generated one or more target identifiable engagement parameters characterizing the target user, so as to select a communication for distribution to the target user;
a formatter, associated with the communications generator, the formatter for formatting the selected communication in a distribution format based on the generated one or more target identifiable engagement parameters;
a scheduler, coupled to the server, the scheduler for evaluating the social media platform and determining a high traffic time for the distribution of the communication so as to produce a scheduled time for distribution; and
a distribution engine, associated with the scheduler, for performing the targeted distribution of the communication over the Internet via the social media platform to the target user at the scheduled time.

2. The communication system in accordance with claim 1, wherein the communications repository includes a communication asset and a communication template from which the communication is built.

3. The communication system in accordance with claim 2, wherein the communications generator comprises a communication builder for selecting a communication asset and a communication template, the selecting being based upon the one or more target identifiable engagement parameters

4. The communication system in accordance with claim 3, further comprising a communications compiler associated with the project builder, the communications compiler for integrating the communication asset with the communication template so as to generate the communication.

5. The communication system in accordance with claim 4, further comprising a content collector, the content collector being associated with one or more of the communication server and the communication repository, the content collector being configured for searching the social media platform and collecting data pertaining to the target user, and further being configured for transmitting that data to one or more databases associated with the server and/or evaluation engine.

6. The communication system in accordance with claim 5, further comprising an artificial intelligence (A/I) module, the A/I module associated with one or more of the communications server and the evaluations engine, and configured for retrieving the data pertaining to the target user, evaluating the data, and generating the one or more target identifiable engagement parameters characterizing the target user.

7. The communication system in accordance with claim 6, further comprising a conflict checking engine coupled to the distribution engine, the conflict check engine configured for preforming a conflict check on the communication to be distributed so as to determine whether there is a potential or actual conflict that may arise should the communication be distributed.

8. A communication apparatus for generating an online communication for distribution to a target user of a social media platform over an Internet based on target identifiable engagement parameters, the apparatus comprising:
a communications server having a network internet connection to communicate with a target user of a client computer via a graphical user interface of the client computer, the communications server comprising an evaluation engine for receiving and evaluating information about the target user to thereby evaluate one or more target identifiable engagement parameters characterizing the target user;
the server further comprising a communications generator for matching the target user with a communication, based on the generated one or more target identifiable engagement parameters characterizing the target user, so as to select a communication for distribution to the target user;
the server further comprising a formatter for formatting the selected communication in a distribution format based on the generated one or more target identifiable engagement parameters;
the server further comprising a scheduler for evaluating the social media platform and determining a high traffic time for the distribution of the communication so as to produce a scheduled time for distribution; and
the server further comprising a distribution engine, associated with the scheduler, for performing the targeted distribution of the communication over the Internet via the social media platform to the target user at the scheduled time.

9. The communication apparatus in accordance with claim 8, further comprising a communications repository associated with the communications server, the communications repository for storing a plurality of communications, the communications being ranked based on a number of the identifiable engagement parameters.

10. The communication apparatus in accordance with claim 9, wherein the communications repository includes a communication asset and a communication template from which the communication is built.

11. The communication apparatus in accordance with claim 10, wherein the communications generator comprises a communication builder for selecting a communication asset and a communication template, the selecting being based upon the one or more target identifiable engagement parameters

12. The communication apparatus in accordance with claim 11, wherein the server further comprises a communications compiler for integrating the communication asset with the communication template so as to generate the communication.

13. The communication apparatus in accordance with claim 12, wherein the server further comprises an artificial intelligence (A/I) engine, the A/I module configured for receiving data pertaining to the target user, evaluating the data, and generating the one or more target identifiable engagement parameters characterizing the target user.

14. The communication apparatus in accordance with claim 13, wherein the apparatus further comprises a content collector, the content collector being associated with the communication server and being configured for searching the social media platform and collecting data pertaining to the target user, and further being configured for transmitting that data to one or more databases associated with the server and/or A/I engine.

15. A method for generating an online communication for distribution to a target user via a social media platform, the method comprising:
retrieving, by at least one data processor executing a content collector, a web content collection comprising: data associated with the target user;
evaluating, by at least one data processor executing an evaluation protocol, the data associated with the target user so as to identify target identifiable engagement parameters characterizing the target user;
retrieving, from a communications repository storing communications ranked based on a number of identifiable engagement parameters characterizing the communication, by at least one data processor, a communication for distribution to the target user, based on a correspondence between the target identifiable engagement parameters;
formatting, by at least one data processor, the communication in a distribution format based on the generated one or more target identifiable engagement parameters;
scheduling, by at least one data processor, the communication for distribution, the scheduling being based on a determined high traffic time for the social media platform; and
distributing, by at least one data processor, the communication over the Internet via the social media platform to the target user at the scheduled time.

16. The method in accordance with claim 15, further comprising selecting, by at least one data processor, at least one communication template and at least one communication asset from a communications repository for generation into a communication.

17. The method in accordance with claim 16, further comprising integrating, by at least one data processor, the at least one communication template with the at least one communication asset to generate the communication, and storing the communication within the communication repository.

18. The method in accordance with claim 17, further comprising ranking, by at least one data processor, the communication with regard to a number of target identifiable engagement parameters characterizing the communication.

19. The method in accordance with claim 18, further comprising evaluating, by at least one data processor, the target identifiable engagement parameters characterizing the communication with the target identifiable engagement parameters characterizing the target user so as to match a communication for distribution with a target for receipt of that distribution.

20. The method in accordance with claim 19, further comprising performing a conflict check, by at least one data processor, on the communication to be distributed so as to determine whether there is a potential or actual conflict that may arise should the communication be distributed.
